(19) United States
(12) Patent Application Publication
(10) Pub. No.: US 2014/0159587 A1
(43) Pub. Date: Jun. 12, 2014

(54) DYNAMIC ADAPTIVE ILLUMINATION CONTROL FOR FIELD SEQUENTIAL COLOR MODE TRANSITIONS

(71) Applicant: QUALCOMM MEMS TECHNOLOGIES, INC., San Diego, CA (US)

(72) Inventors: Muhammed Ibrahim Sezan, Los Gatos, CA (US); Hae-Jong Seo, San Jose, CA (US); Zhanpeng Feng, Fremont, CA (US); Behnam Bastani, San Jose, CA (US)

(73) Assignee: QUALCOMM MEMS TECHNOLOGIES, INC., San Diego, CA (US)

(21) Appl. No.: 13/766,045

(22) Filed: Feb. 13, 2013

Related U.S. Application Data
(63) Continuation-in-part of application No. 13/712,716, filed on Dec. 12, 2012.
(60) Provisional application No. 61/736,419, filed on Dec. 12, 2012.

(51) Int. Cl. H05B 37/02

(52) U.S. Cl. CPC H05B 37/02
USPC 315/152

(57) ABSTRACT

This disclosure provides systems, methods and apparatus, including computer programs encoded on computer storage media, for selecting an operational mode of a display device from a plurality of operational modes. The operational modes may include at least one field-sequential color mode in which a display is illuminated with white light while data are written to the display. The operational mode may be selected based, at least in part, on ambient light data. The ambient light data may include ambient light intensity data, ambient light spectrum data and/or ambient light direction data. The operational mode may be selected based, at least in part, on other criteria, such as color gamut data, display application type and/or battery state data.

### PRIORITY CLAIM

This application claims priority to U.S. Provisional Patent Application No. 61/736,419 (attorney docket number QUALP084P/130049P1), filed on Dec. 12, 2012 and entitled “DYNAMIC ADAPTIVE ILLUMINATION CONTROL FOR FIELD SEQUENTIAL COLOR MODE TRANSITIONS,” which is hereby incorporated by reference. This application is a continuation-in-part of U.S. patent application Ser. No. 13/712,716 (attorney docket number QUALP165/122763), filed on Dec. 12, 2012 and entitled “FIELD-SEQUENTIAL COLOR MODE TRANSITIONS,” which is hereby incorporated by reference.

### TECHNICAL FIELD

This disclosure relates to display devices, including but not limited to display devices that incorporate electromechanical systems.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities. Although current IMOD displays and other reflective displays are generally satisfactory, improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in a reflective display device that includes a front light system, a reflective display including a plurality of reflective pixels, a sensor system that includes an ambient light sensor and a control system. The front light system may be configured for producing light of a first color, light of a second color, light of a third color and substantially white light. The control system may be configured to receive ambient light data from the ambient light sensor and to determine, based at least in part on the ambient light data, a current operational mode from a plurality of operational modes.

The plurality of operational modes may include a field sequential color (FSC) mode in which the front light system illuminates the reflective display with white light while data are written to the plurality of reflective pixels. The control system may be configured to select, based at least in part on the ambient light data, a white light intensity level. The control system may be further configured to control the front light system and the reflective display according to the current operational mode and the white light intensity level.

In some implementations, the control system may be configured to determine a ratio of white light intensity to overall display illumination intensity. The overall display illumination intensity may include front light illumination intensity and ambient light illumination intensity.

The ambient light data may include ambient light intensity data. The control system may be configured to select the FSC operational mode if the ambient light data indicates a first ambient light intensity level that is below a first threshold. The control system may be configured to select a non-FSC operational mode if the ambient light data indicates a second ambient light intensity level that is at or above the first threshold. The control system may be configured to select an operational mode of substantially continuous front light operation if the second ambient light intensity level is below a second threshold. The control system may be configured to select an operational mode in which the front light is off if the second ambient light intensity level is at or above the second threshold.

In some implementations, the control system may be configured to determine an image content type and to select the current operational mode based, at least in part, on the image content type. The control system may be configured to select the white light intensity level based at least in part on a desired color gamut. The control system may be further configured to compute an objective measure of color breakup and to select the current operational mode based, at least in part, on the objective measure. In some implementations, the control system may be configured to vary the white light intensity level while maintaining a substantially constant brightness from the front light system.

According to some implementations, the sensor system may include a battery state sensor. The control system may be configured to receive battery state data from the battery state sensor and to select the current operational mode or the white light intensity level based, at least in part, on the battery state data.

The control system may be configured to process image data. In some implementations, the control system may include a driver circuit configured to send at least one signal to the reflective display. The control system may include a controller configured to send at least a portion of the image data to the driver circuit. The control system may include an image source module configured to send the image data to the processor. In some implementations, the image source module may include a receiver, a transceiver and/or a transmitter. The reflective display device may include an input device configured to receive input data and to communicate the input data to the control system.

Another innovative aspect of the subject matter described in this disclosure can be implemented in a method of operating a display device. The method may involve receiving ambient light data from an ambient light sensor and determining, based at least in part on the ambient light data, a current operational mode for the display from a plurality of operational modes. The plurality of operational modes may include an FSC mode in which a lighting system illuminates the display with white light while data are written to the display.

The method may involve selecting, based at least in part on the ambient light data, a white light intensity level. The method may involve controlling the lighting system and the display according to the current operational mode and the white light intensity level.

In some implementations, the method may involve selecting the FSC operational mode if the ambient light data indicates a first ambient light intensity level that is below a first threshold. The method may further involve selecting a non-FSC operational mode if the ambient light data indicates a second ambient light intensity level that is at or above the first threshold. The method may involve determining an image content type and selecting the current operational mode based, at least in part, on the image content type. The method may involve selecting the white light intensity level based at least in part on a desired color gamut.

According to some implementations, the method may involve computing an objective measure of color breakup. The method may further involve selecting the current operational mode based, at least in part, on the objective measure of color breakup. In some implementations, the method may involve varying the white light intensity level while maintaining a substantially constant brightness from the lighting system.

Another innovative aspect of the subject matter described in this disclosure can be implemented in a non-transitory medium having software stored thereon. The software may include instructions for controlling an apparatus to receive ambient light data from an ambient light sensor and to determine, based at least in part on the ambient light data, a current operational mode for a display from a plurality of operational modes. The plurality of operational modes may include an FSC mode in which a lighting system illuminates the display with white light while data are written to the display. The software may include instructions for controlling the apparatus to select, based at least in part on the ambient light data, a white light intensity level and to control the lighting system and the display according to the current operational mode and the white light intensity level.

The software further may include instructions for controlling the apparatus to select the FSC operational mode if the ambient light data indicates a first ambient light intensity level that is below a first threshold. The software further may include instructions for controlling the apparatus to select a non-FSC operational mode if the ambient light data indicates a second ambient light intensity level that is at or above the first threshold. In some implementations, the software further may include instructions for controlling the apparatus to determine an image content type and to select the current operational mode based, at least in part, on the image content type.

According to some implementations, the software further may include instructions for controlling the apparatus to select the white light intensity level based at least in part on a desired color gamut. The software further may include instructions for controlling the apparatus to compute an objective measure of color breakup and to select the current operational mode based, at least in part, on the objective measure. The software further may include instructions for controlling the apparatus to vary the white light intensity level while maintaining a substantially constant brightness from the lighting system.

Details of one or more implementations of the subject matter described in this specification are set forth in the accompanying drawings and the description below. Although the examples provided in this summary are primarily described in terms of MEMS-based displays, the concepts provided herein may apply to other types of displays, such as cholesteric LCD displays, transflective LCD displays, electrofluidic displays, electrophoretic displays and displays based on electro-wetting technology. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A-6E are cross-sectional illustrations of varying implementations of IMOD display elements.

FIG. 7 is a flow diagram illustrating a manufacturing process for an IMOD display or display element.

FIGS. 8A-8E are cross-sectional illustrations of various stages in a process of making an IMOD display or display element.

FIGS. 8F and 8G are schematic exploded partial perspective views of a portion of an electromechanical systems (EMS) package including an array of EMS elements and a backplate.

FIG. 9 shows an example of a flow diagram outlining processes of some methods described herein.

FIG. 10A shows an example of a diagram that depicts how components of a reflective display may be controlled according to a method outlined in FIG. 9.

FIG. 10B shows an example of a diagram that depicts how components of a reflective display may be controlled according to an alternative method outlined in FIG. 9.

FIG. 11 shows an example of a flow diagram outlining processes of alternative methods described herein.

FIG. 12 shows an example of a diagram that depicts how components of a reflective display may be controlled according to a method outlined in FIG. 11.

FIG. 13 shows an example of a graph of the spectral response of three interferometric modulation subpixels, each of which corresponds to a different color.

FIG. 14 shows an example of a flow diagram outlining processes for alternating between driving odd and even rows of interferometric modulators in a display.

FIG. 15A shows an example of rows of interferometric modulators in a display.

FIG. 15B shows an example of a diagram that depicts how to alternate between driving odd and even rows of interferometric modulators in a display without driving rows to black.

FIG. 16 shows an example of a flow diagram outlining processes for simultaneously writing more than one color to rows of interferometric modulators in a display.

FIG. 17 shows an example of a flow diagram outlining processes for sequentially writing data for a single color to all interferometric modulators in a display.

FIG. 18 shows an example of a graph of color gamut versus brightness of ambient light for different types of displays.

FIG. 19 shows an example of a flow diagram outlining processes for controlling a display according to the brightness of ambient light.

FIG. 20 shows an example of a graph of data that may be referenced in a process such as that outlined in FIG. 19.

FIG. 21 shows an example of a graph of the spectral response of a green interferometric subpixel being illuminated by a magenta light.

FIG. 22 shows an example of a graph of the spectral response of three reflective subpixels, each of which has an intensity peak that corresponds to a different color.

FIG. 23 shows an example of reflective subpixel configurations corresponding to three bits and eight grayscale levels.

FIG. 24 shows an example of a flow diagram outlining a process for controlling a reflective display according to a grayscale method for field-sequential color.

FIG. 25 shows an example of controlling subpixels of a reflective display according to the process of FIG. 24.

FIG. 26 shows an example of reflective subpixel configurations corresponding to two bits and four grayscale levels.

FIG. 27 shows an example of a flow diagram outlining an alternative process for controlling a reflective display according to a grayscale method for field-sequential color.

FIG. 28 is a graph illustrating changes in color gamut according to ambient light intensity for various black and white FSC implementations.

FIG. 29 is a graph illustrating changes in color gamut according to ambient light intensity for various lup2down FSC implementations.

FIG. 30 is a graph illustrating changes in color gamut and brightness for various according to ambient light intensity for various operational modes of a reflective display device.

FIG. 31 is a flow diagram illustrating a method of selecting an operational mode for a reflective display device.

FIG. 32 is a system block diagram illustrating components of a reflective display device.

FIGS. 33A-33E show examples of how a single-mirror IMOD (SM-IMOD) may be configured to produce different colors.

FIG. 34 is a system block diagram illustrating a display device including an IMOD array, a front light and a logic system.

FIG. 35 is a flow diagram illustrating a process for operating an IMOD display element and a front light.

FIG. 36A shows an example of how an SM-IMOD could be controlled to produce a particular shade of yellow when operated in an FSC mode.

FIG. 36B shows examples of SM-IMOD gaps for producing substantially the same shade of yellow as described above with reference to FIG. 36A, but with reduced brightness.

FIG. 36C shows examples of SM-IMOD gaps for producing substantially the same shade of yellow as described with reference to FIG. 36A, but a yellow that is about ⅓ as bright.

FIG. 37 shows an example of a spectral response of an SM-IMOD with mirror/absorber gaps in the range of zero to about 700 nm.

FIG. 38 is a flow diagram that outlines one example of a method for alleviating color breakup.

FIG. 39 is a flow diagram that shows an example of an FSC operational mode in which a lighting system illuminates a display with white light while data are written to the display.

FIG. 40 is a diagram that indicates how data may be written to a display and how a front light may be controlled according to one example of the FSC operational mode outlined in FIG. 39.

FIG. 41 is a graph that provides an example of the effects of illuminating a display with white light.

FIG. 42 is a graph that provides examples of switching between operational modes according to ambient light intensity.

FIG. 43 is a system block diagram illustrating additional components of a reflective display device.

FIG. 44 is a system block diagram illustrating components of a color break-up detection module.

FIGS. 45A and 45B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Field-sequential color (FSC) techniques can be applied to reflective displays, including but not limited to IMOD displays, using field-sequential front lights that may include light sources for various colors. FSC methods can provide enhanced brightness and/or color gamut for reflective displays in conditions of dim ambient light. However, FSC methods may cause noticeable color breakup (“CBU”) under certain conditions. CBU is a perceptual phenomenon that is caused by relative motion between a viewer's eye and a reflective display being operated in an FSC mode. Due to CBU, a viewer may see colored fringes around a displayed object. Therefore, various implementations described herein provide FSC modes in which the front light system illuminates a display with white light while data are written to the display. The intensity of white light may be controlled to optimize color gamut and CBU effects.

Particular implementations of the subject matter described in this disclosure can be implemented to realize one or more of the following potential advantages. In some implementations, illuminating a display with white light while data are written to the display during an FSC operational mode can mitigate the effects of CBU. In some implementations, the intensity of white light may be controlled to shape the color gamut produced by a display device. Illuminating the display with white light while data are written to the display during an FSC operational mode may increase overall display brightness.

Although most of the description herein pertains to IMOD displays, many such implementations could be used to advantage in other types of reflective displays, including but not limited to cholesteric LCD displays, transflective LCD displays, electrofluidic displays, electrophoretic displays and displays based on electro-wetting technology. Moreover, while the interferometric modulator displays described herein generally include red, blue and green subpixels, many implementations described herein could be used in reflective displays having other colors of subpixels, e.g., having violet, yellow-orange and yellow-green subpixels. In addition, many implementations described herein could be used in reflective displays having more colors of subpixels, e.g., having subpixels corresponding to 4, 5 or more colors. Some such implementations may include subpixels corresponding to red, blue, green and yellow. Alternative implementations may include subpixels corresponding to red, blue, green, yellow and cyan. Moreover, some implementations described below involve FSC methods for single-mirror IMODs (SM-IMODs).

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

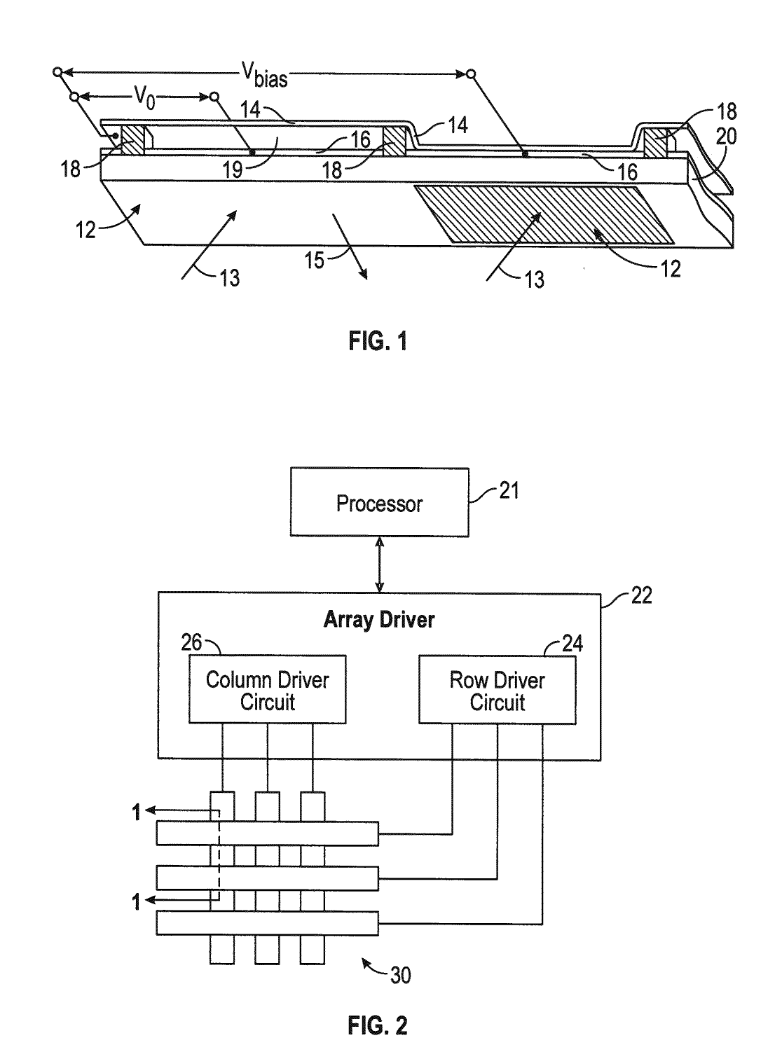

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

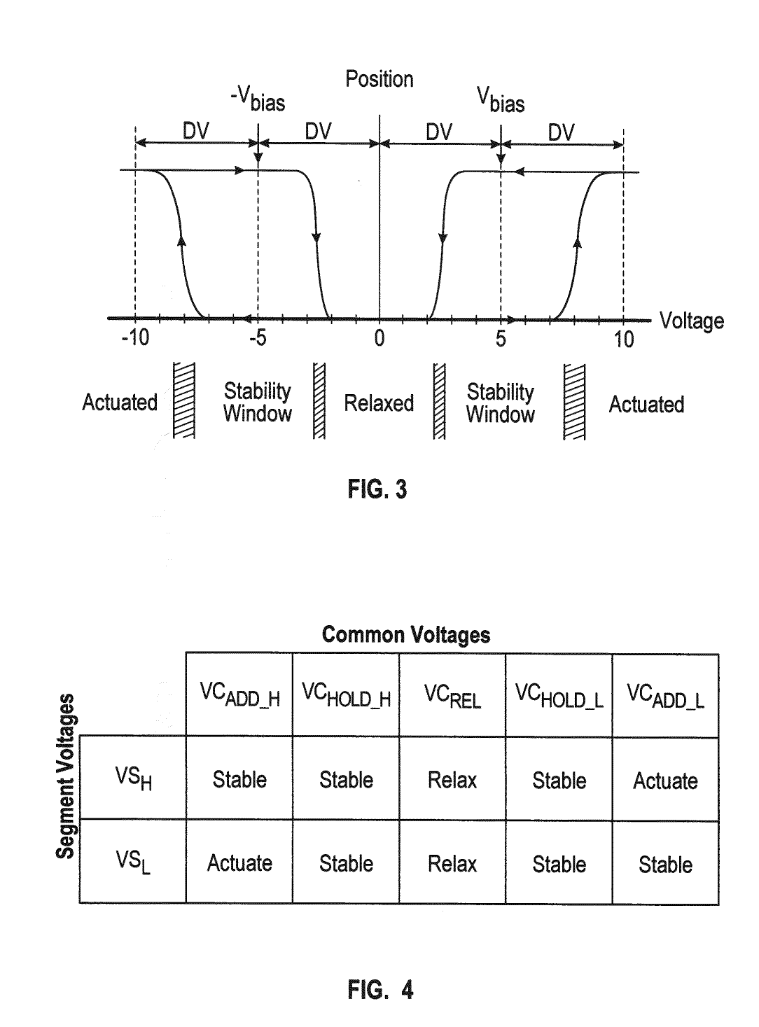

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

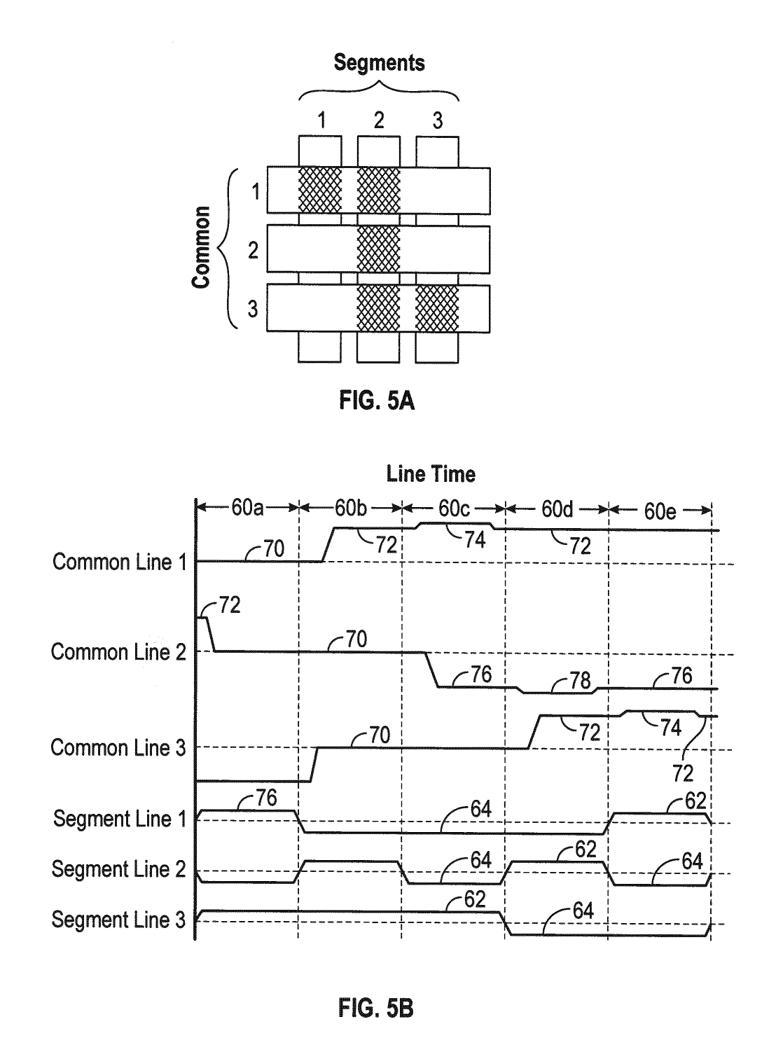

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

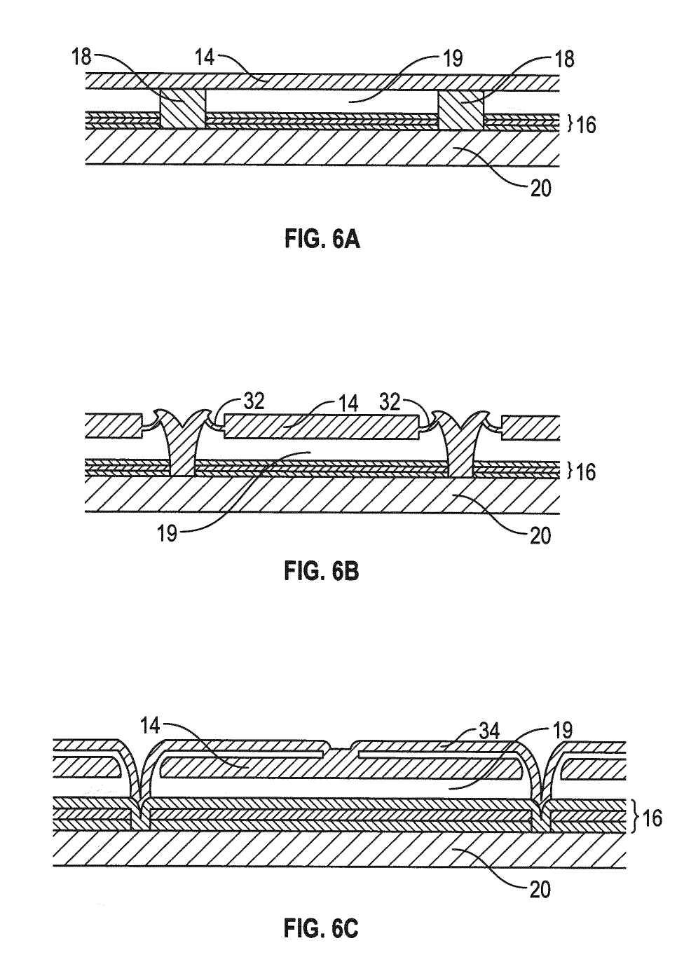

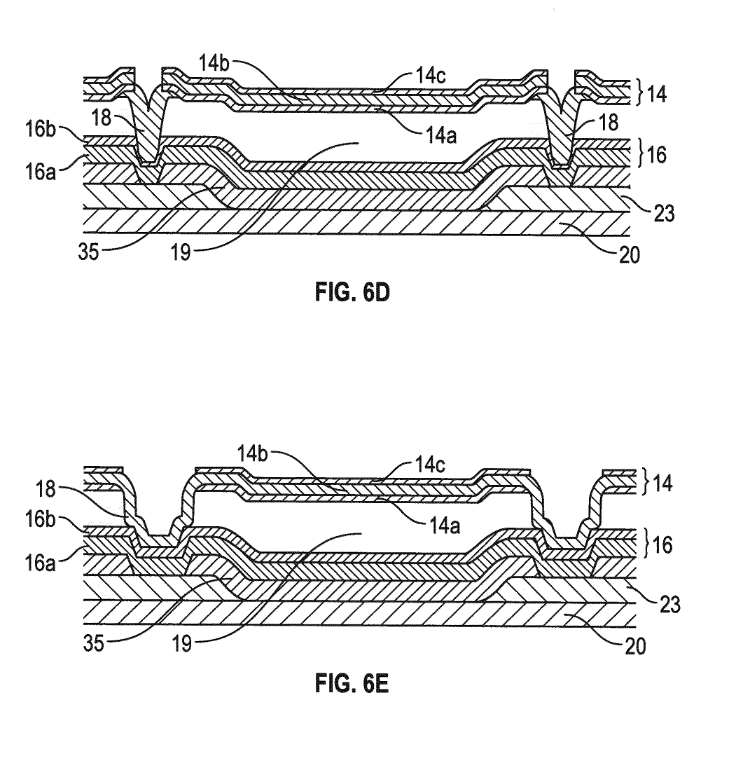

The details of the structure of IMOD displays and display elements may vary widely. FIGS. 6A-6E are cross-sectional illustrations of varying implementations of IMOD display elements. FIG. 6A is a cross-sectional illustration of an IMOD display element, where a strip of metal material is deposited on supports 18 extending generally orthogonally from the substrate 20 forming the movable reflective layer 14. In FIG. 6B, the movable reflective layer 14 of each IMOD display element is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 6C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 6D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23, or dark film layers. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 6E is another cross-sectional illustration of an IMOD display element, where the movable reflective layer 14 is self-supporting. While FIG. 6D illustrates support posts 18 that are structurally and/or materially distinct from the movable reflective layer 14, the implementation of FIG. 6E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 6A-6E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

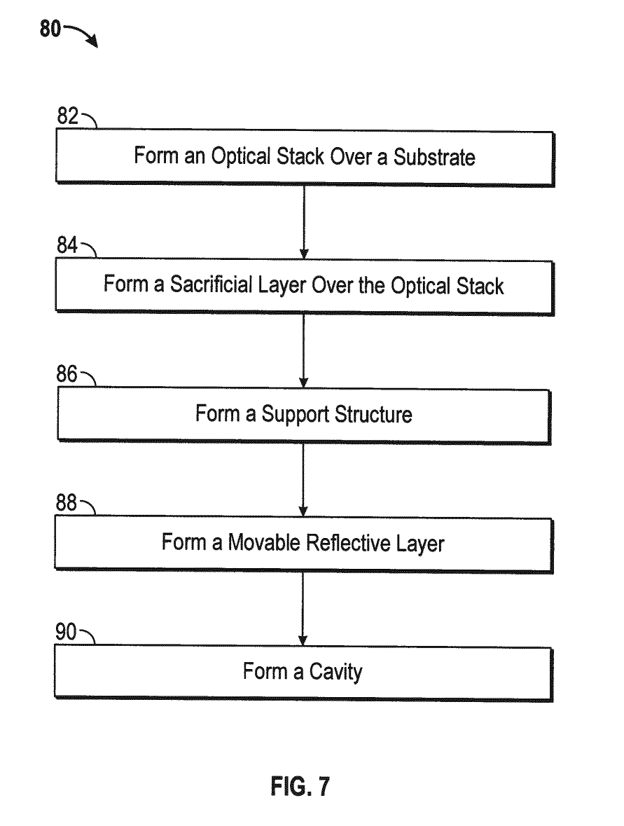

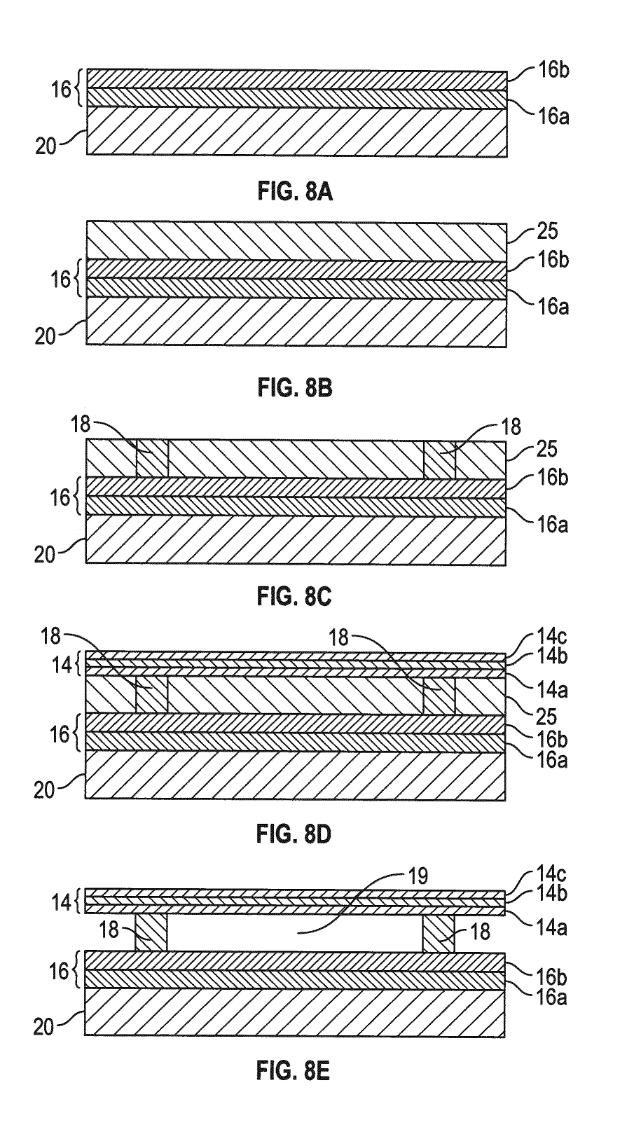

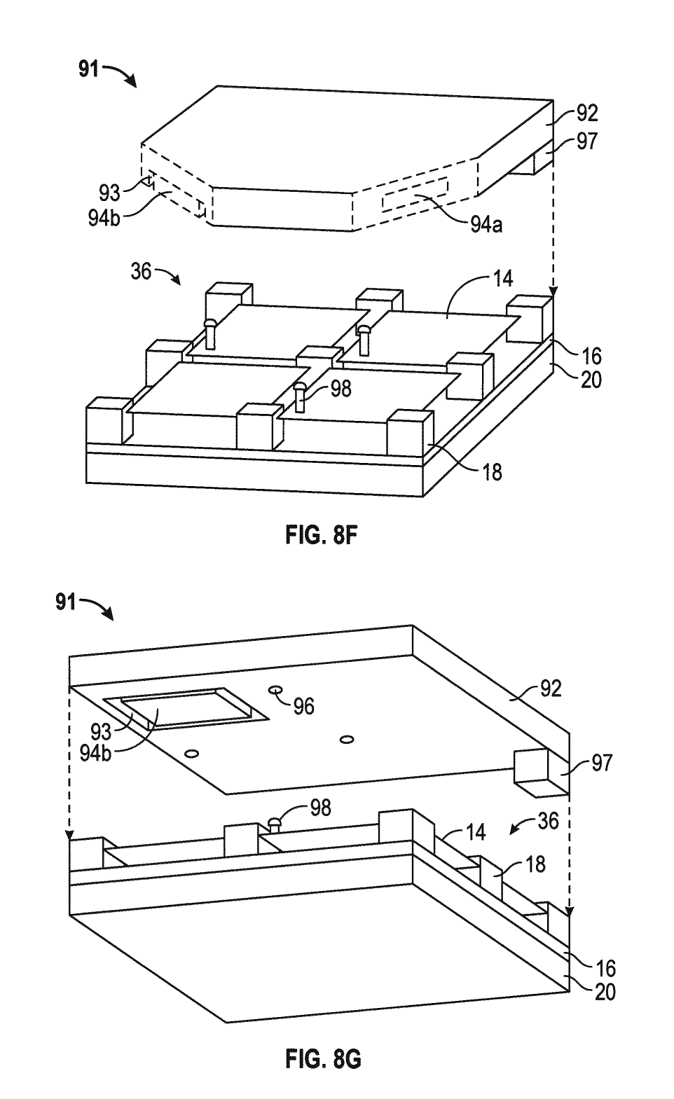

FIG. 7 is a flow diagram illustrating a manufacturing process 80 for an IMOD display or display element. FIGS. 8A-8E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 7. The process 80 begins at block 82 with the formation of the optical stack 16 over the substrate 20. FIG. 8A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 8A-8E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 8B illustrates a partially fabricated device including a sacrificial layer 25 formed over the optical stack 16. The formation of the sacrificial layer 25 over the optical stack 16 may include deposition of a xenon difluoride (XeF₂)— etchable material such as molybdenum (Mo) or amorphous silicon (Si), in a thickness selected to provide, after subsequent removal, a gap or cavity 19 (see also FIG. 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in Figure [#H4]. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 8D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

FIGS. 8F and 8G are schematic exploded partial perspective views of a portion of an EMS package 91 including an array 36 of EMS elements and a backplate 92. FIG. 8F is shown with two corners of the backplate 92 cut away to better illustrate certain portions of the backplate 92, while FIG. 8G is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 8F and 8G, the backplate 92 can include one or more backplate components 94a and 94b, which can be partially or wholly embedded in the backplate 92. As can be seen in FIG. 8F, backplate component 94a is embedded in the backplate 92. As can be seen in FIGS. 8F and 8G, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 8G includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 8F and 8G, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 8F and 8G, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

In some implementations, rows of an IMOD display can be scanned and written with different colors (e.g., red, green, and blue) sequentially, and then the corresponding colored light from a front light of the display may be flashed onto the display for a certain time after the rows are scanned. While writing data of a primary color of interest in subpixels of rows in the display, corresponding subpixels of the remaining primary colors may be written to black, or driven according to data for the color of interest, simultaneously.

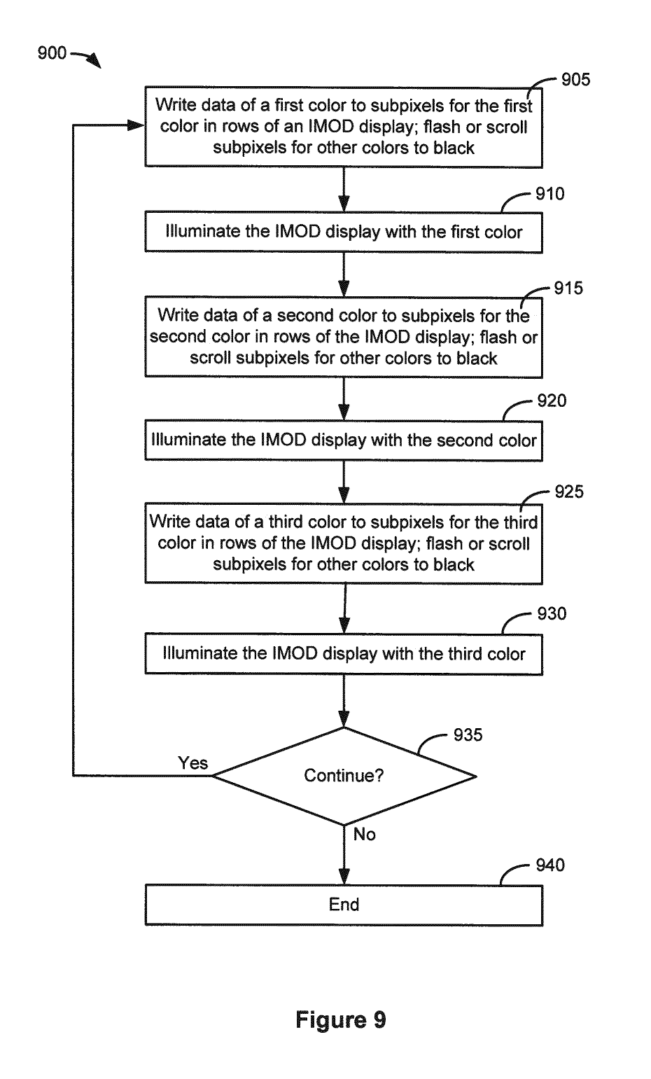

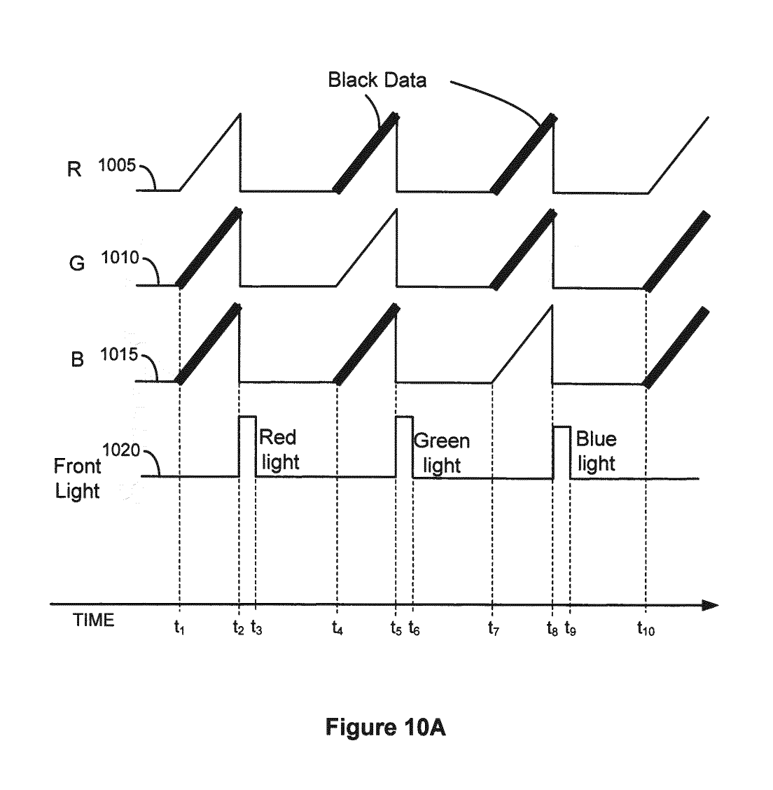

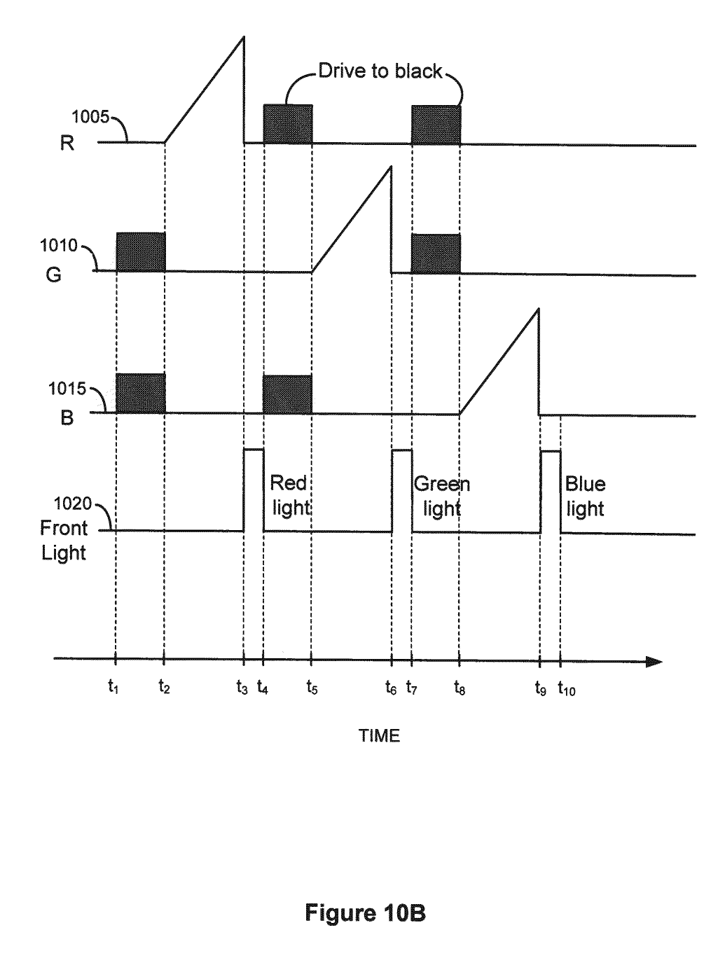

FIG. 9 shows an example of a flow diagram outlining processes of some methods described herein. FIG. 10A shows an example of a diagram that depicts how components of a reflective display may be controlled according to a method outlined in FIG. 9. FIG. 10B shows an example of a diagram that depicts how components of a reflective display may be controlled according to an alternative method outlined in FIG. 9. Such methods, as well as other methods described herein, may be performed by one or more processors, controllers, etc., such as those described with reference to FIGS. 2 through 5B and 28B.

Referring first to FIG. 9, method 900 begins with block 905, in which data corresponding to a first color are written to subpixels for the first color in rows of an IMOD display. Subpixels for all other colors are driven to black. In some implementations, subpixels for all other colors may be “flashed” to black at substantially the same time. One such implementation is described below with reference to FIG. 10B. The method 900 may sometimes be referenced herein as “lup2down FSC,” because it is a field-sequential color method wherein subpixels corresponding to only one spectral range are “up” (being driven to a position in which the subpixels will reflect light in that spectral range) when the method 900 is being implemented.

However, in the implementation depicted in FIG. 10A, subpixels for all other colors are “scrolled” to black row by row, as the data for the first color are written. In FIG. 10A, trace 1005 indicates how rows of red subpixels are driven, trace 1010 indicates how rows of green subpixels are driven, trace 1015 indicates how rows of blue subpixels are driven and trace 1020 indicates how a light source is controlled to illuminate the array of subpixels. In this example, the light source is a front light that includes red, green and blue light-emitting diodes (LEDs). Other types of light source may be used in other implementations. Beginning at time t₁, red data of a frame of image data are written to rows of red subpixels. At substantially the same time, the rows of green and blue subpixels are scrolled to black. The “drive” time for addressing the subpixel rows, from time t₁ until time t₂, may be on the order of a few milliseconds (ms), e.g., between 1 and 10 ms. In some implementations, this time may be on the order of 3 to 6 ms.

After all subpixels in the array have been addressed, the array of subpixels is illuminated with red light, from time t₂ until time t₃. (See block 910 of FIG. 9.) The illumination time may, for example, be on the order of 1 or more ms. In some implementations, there may be a short time (e.g., a few microseconds) between the time at which the last row of subpixels is addressed and the time at which the array of subpixels is illuminated. However, in alternative implementations, the array of subpixels may be illuminated before the last row of subpixels is addressed. For example, the array of subpixels may be illuminated after most, but not all, of the subpixels have been addressed (e.g., after approximately 70%, 75%, 80%, 85%, 90% or 95% of the subpixels have been addressed). The time interval between t₃ and t₄ (as well as the time interval between t₆ and t₇) may be made small, e.g., a few microseconds. In some implementations these time intervals are made as close to zero as is practicable, such that data for the next color are written immediately (or almost immediately) after the light source is turned off.

The time interval between t₁ and t₄ may be referred to herein as a “field,” which corresponds to a sub-unit of a frame during which data for a particular color are written and within which the display is illuminated with light of that color. In this example, the time interval between t₁ and t₄ may be referred to as a “red field,” because this first field corresponds to a time during which red data of a frame of image data are written to subpixels of the display and during which the subpixels are illuminated with red light. The entire frame of data extends from t₁ to t₁₀, after which time the next frame of data is written.

From time t₄ to time t₅, data of a second color are written to subpixels for the second color in rows of the array of subpixels, while subpixels for other colors are scrolled to black. (See block 915 of FIG. 9.) In the example shown in FIG. 10A, green data are written to the green subpixels while the red and blue subpixels are scrolled to black. Subsequently, the array of subpixels is illuminated with green light from time t₅ (or from a time just after time t₅) to time t₆. (See block 920 of FIG. 9.) In alternative implementations, the array of subpixels may be illuminated before the last row of subpixels is addressed. The time interval between t₄ and t₇ may be referred to herein as a “green field,” because this field corresponds to a time during which green data of a frame of image data are written to subpixels of the display and during which the subpixels are illuminated with green light.

Next, data of a third color are written to subpixels for the third color in rows of the array of subpixels, while subpixels for other colors are scrolled to black. (See block 925 of FIG. 9.) In the example shown in FIG. 10A, from time t₇ to time t₈ blue data are written to the blue subpixels while the red and green subpixels are scrolled to black. Subsequently, the array of subpixels is illuminated with blue light from time t₈ (or from a time just after time t₈) to time t₉. (See block 930 of FIG. 9.) In alternative implementations, the array of subpixels may be illuminated before the last row of subpixels is addressed. The time interval between t₇ and t₁₀ may be referred to herein as a “blue field,” because this field corresponds to a time during which blue data of a frame of image data are written to subpixels of the display and during which the subpixels are illuminated with blue light.

At this point, an entire frame of image data has been written to the subpixel array. The next frame of image data may be written to the subpixel array by returning to block 905 and repeating the above-described process for the next frame. Although in the above example (and other examples described herein) the sequence of colors is red/green/blue, the order in which the color data are written and the corresponding colored light is flashed does not matter and may differ in other implementations.

Referring now to FIG. 10B, a “flash to black” implementation will be described. In FIG. 10B, trace 1005 indicates how rows of red subpixels are driven, trace 1010 indicates how rows of green subpixels are driven, trace 1015 indicates how rows of blue subpixels are driven and trace 1020 indicates how a light source is controlled to illuminate the array of subpixels. In this example, the light source is a front light that includes red, green and blue light-emitting diodes (LEDs). Other types of light source may be used in other implementations. Beginning at time t₁, all of the rows of green and blue subpixels are flashed to black at substantially the same time. In some implementations, all of the rows of green and blue subpixels are flashed to black in a single line time by setting all common lines to a voltage higher than V_{actuate}. (See FIGS. 4 through 5B and the corresponding discussion above.) The time interval between t₁ and t₂ (as well as the time interval between t₄ and t₅ and between t₇ and t₈) may be made small, e.g., less than 1 ms.

Beginning at time t₂, red data of a frame of image data are written to rows of red subpixels. The “drive” time for writing data to the subpixel rows, from time t₂ until time t₃, may be on the order of a few milliseconds (ms), e.g., between 1 and 10 ms. In some implementations, this time may be on the order of 3 to 6 ms. In this example, all of the rows of green and blue subpixels kept in a black state from time t₂ until after the subpixel array is illuminated with red light. In alternative implementations, all of the rows of green and blue subpixels may be flashed to black during the time that red data are being written.

After all subpixels in the array have been addressed, the array of subpixels is illuminated with red light, in this example from time t₃ until time t₄. The time interval between t₁ and t₄ is another example of a red field. The illumination time may, for example, be on the order of 1 or more ms. In some implementations, there may be a short time (e.g., a few microseconds) between the time at which the last row of subpixels is addressed and the time at which the array of subpixels is illuminated. However, in alternative implementations, the array of subpixels may be illuminated before last row of subpixels is addressed. For example, the array of subpixels may be illuminated after most, but not all, of the subpixels have been addressed (e.g., after approximately 70%, 75%, 80%, 85%, 90% or 95% of the subpixels have been addressed).

Beginning at time t₄, all of the rows of red subpixels are flashed to black at substantially the same time. In alternative implementations, all of the rows of red subpixels may be flashed to black during the time that green data are being written. In this example, all of the rows of blue subpixels are also flashed to black. However, in alternative implementations, all of the rows of blue subpixels may be maintained in a black state from the time that they were previously flashed to black until after the subpixel array is illuminated with green light.

From time t₅ to time t₆, data of a second color are written to subpixels for the second color in rows of the array of subpixels, while subpixels for other colors are kept in a black state. In the example shown in FIG. 10B, green data are written to the green subpixels while the red and blue subpixels are kept in a black state. Subsequently, the array of subpixels is illuminated with green light from time t₆ (or from a time just after time t₆) to time t₇. In alternative implementations, the array of subpixels may be illuminated before the last row of subpixels is addressed.

Next, all of the rows of green subpixels are flashed to black at substantially the same time, starting at time t₇ in this example. The time interval between t₄ and t₇ is another example of a green field. In alternative implementations, all of the rows of green subpixels may be flashed to black during the time that blue data are being written. In this example, all of the rows of red subpixels are also flashed to black. However, in alternative implementations, all of the rows of red subpixels may be maintained in a black state from the time that they were previously flashed to black until after the subpixel array has been illuminated with blue light.

Data of a third color are written to subpixels for the third color in rows of the array of subpixels, while subpixels for other colors are kept in a black state. In the example shown in FIG. 10B, from time t₈ to time t₉ blue data are written to the blue subpixels while the red and green subpixels are kept in a black state. Subsequently, the array of subpixels is illuminated with blue light from time t₉ (or from a time just after time t₉) through time t₁₀. The time interval between t₇ and t₁₀ is another example of a blue field. In alternative implementations, the array of subpixels may be illuminated before the last row of subpixels is addressed.

At this point, an entire frame of image data has been written to the subpixel array. The next frame of image data may be written to the subpixel array by repeating the above-described process for the next frame. Although in the above example (and other examples described herein) the sequence of colors is red/green/blue, the order in which the color data are written and the corresponding colored light is flashed does not matter and may differ in other implementations.

Scrolling black and flash to black implementations have the advantage of increased color saturation, as compared to IMODs driven according to some conventional schemes, when the front light of a display is being used. When used in a relatively dark environment, the appearance is dominated by the light provided to the display by the front light. If the ambient light becomes bright enough, however, the reflective color will be dimmer than during typical IMOD display operation in reflective mode (about ⅓ as bright), because only 1 type of subpixel is “on” (not driven to black) at a time. Accordingly, in some instances it will be determined in block 935 that the scrolling black method will end. For example, it may be determined in block 935 that the operational mode of the display will be altered because of a change in ambient light conditions, because of an indication received from a user input device, etc. In some implementations, the display may be configured to provide vivid colors even under bright ambient light.

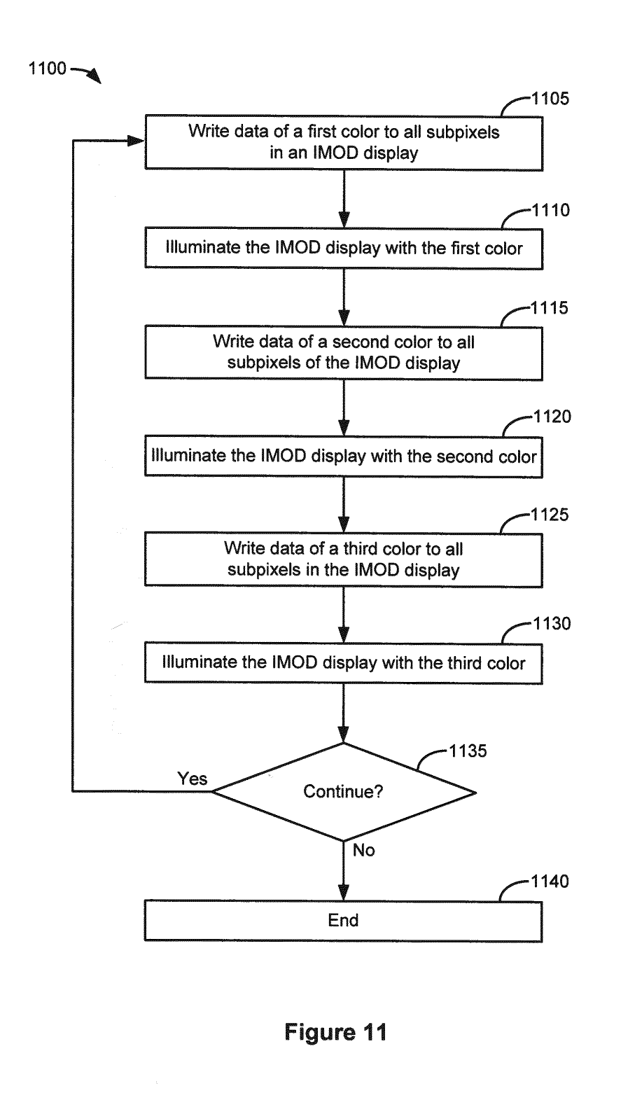

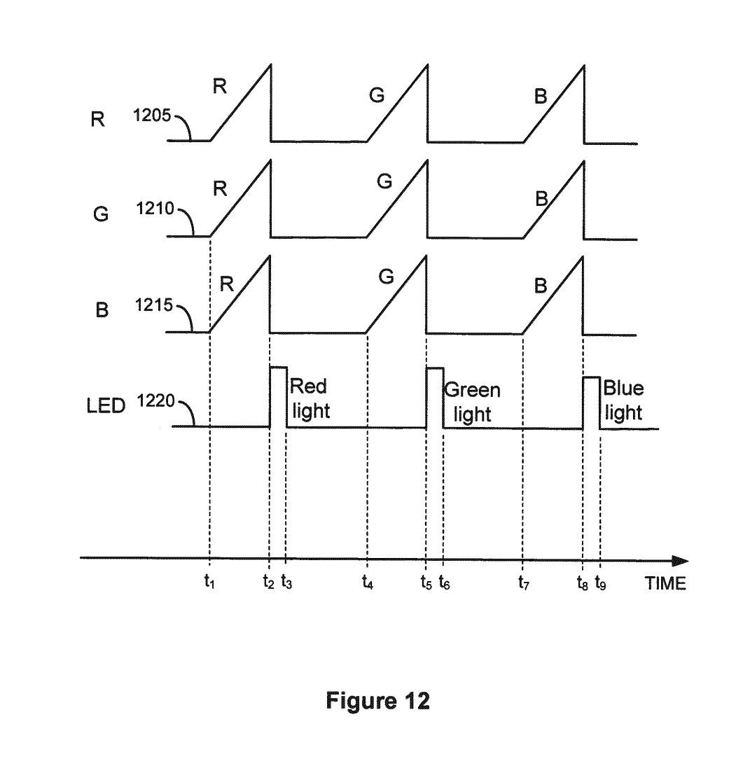

FIG. 11 shows an example of a flow diagram outlining processes of alternative methods described herein. FIG. 12 shows an example of a diagram that depicts how components of a reflective display may be controlled according to a method outlined in FIG. 11. In this example, the reflective display is an IMOD display. Referring first to FIG. 11, in block 1105 data of a first color are written to all subpixels in the IMOD display. In other words, data that would normally be written only to subpixels corresponding to a first color are written to all subpixels, regardless of to which color the subpixels correspond. The method 1200 may sometimes be referenced herein as “KW FSC.”

One example is shown in FIG. 12. In FIG. 12, trace 1205 indicates how rows of red subpixels are driven, trace 1210 indicates how rows of green subpixels are driven, trace 1215 indicates how rows of blue subpixels are driven and trace 1220 indicates how a light source is controlled to illuminate the array of subpixels. In this example, the light source is a front light that includes red, green and blue LEDs. Other types of light source may be used in other implementations. Beginning at time t₁, red data of a frame of image data are written to the rows of red subpixels, to the rows of green subpixels and to the rows of blue subpixels in a display. The time for addressing the subpixel rows, from time t₁ until time t₂, may be on the order of a few milliseconds (ms), e.g., between 1 and 10 ms.

In this example, the array of subpixels is illuminated with red light after all subpixels in the array have been addressed and written with red data of the frame of image data, from time t₂ (or from a time just after time t₂) until time t₃. (See block 1110 of FIG. 11.) However, in alternative implementations, the array of subpixels may be illuminated before the last row of subpixels is addressed. For example, the array of subpixels may be illuminated after most, but not all, of the subpixels have been addressed (e.g., after approximately 70%, 75%, 80%, 85%, 90% or 95% of the subpixels have been addressed). The illumination time may, for example, be on the order of 1 or more ms. The time interval between t₃ and t₄ (as well as the time interval between t₆ and t₇) may be made small, e.g., a few microseconds. In some implementations these time intervals are made as close to zero as is practicable, such that data for the next color are written immediately (or almost immediately) after the light source is turned off.

From time t₄ to time t₅, data of a second color are written to subpixels for the first, second and third colors in rows of the array of subpixels. (See block 1115 of FIG. 11.) In the example shown in FIG. 12, green data are written to the red subpixels, to the green subpixels and to the blue subpixels. Subsequently, the array of subpixels is illuminated with green light from time t₅ (or from a time just after time t₅) to time t₆. (See block 1120 of FIG. 11.) In alternative implementations, the array of subpixels may be illuminated before the last row of subpixels is addressed.

Next, data of a third color are written to all subpixels in the array of subpixels. (See block 1125 of FIG. 11.) In the example shown in FIG. 12, from time t₇ to time t₈ blue data are written to all subpixels in the array, including the red and green subpixels. Subsequently, the array of subpixels is illuminated with blue light from time t₈ (or from a time just after time t₈) to time t₉. (See block 1130 of FIG. 11.) In alternative implementations, the array of subpixels may be illuminated before the last row of subpixels is addressed.

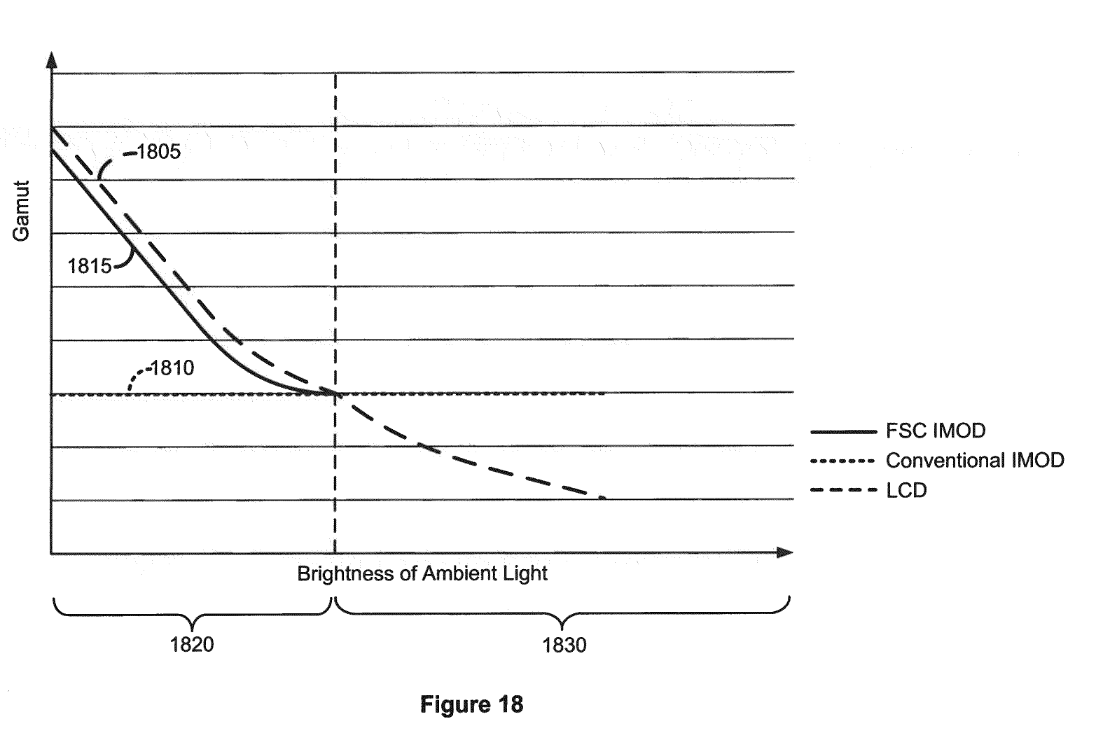

At this time, a frame of image data has been written to the subpixel array. It may then be determined whether to change the operational mode of the display or whether to continue controlling the display in accordance with method 1100. The next frame of image data may be written to the subpixel array in accordance with method 1100 by returning to block 1105 and repeating the above-described processes for the next frame. The determination in block 1135 of whether to change the operational mode of the display may be made, for example, in response to a change in ambient light conditions and/or in response to user input. If the ambient light is sufficiently bright while controlling a display in accordance with method 1100, the ambient light may make the display appear to be a black and white display instead of a color display. Therefore, it can be advantageous to change the operational mode of the display according to the brightness of ambient light. Some relevant methods of are described below with reference to FIGS. 18 through 20.

However, when used in conditions of low ambient light, method 1100 may result in greater brightness and color saturation than some conventional interferometric modulation subpixel illumination methods. Method 1100 may even result in greater brightness and color saturation than the “flash to black” and “scrolling black” implementations described above with reference to FIGS. 9 and 10A-B. However, this may depend on the spectral responses of the subpixels in the array.

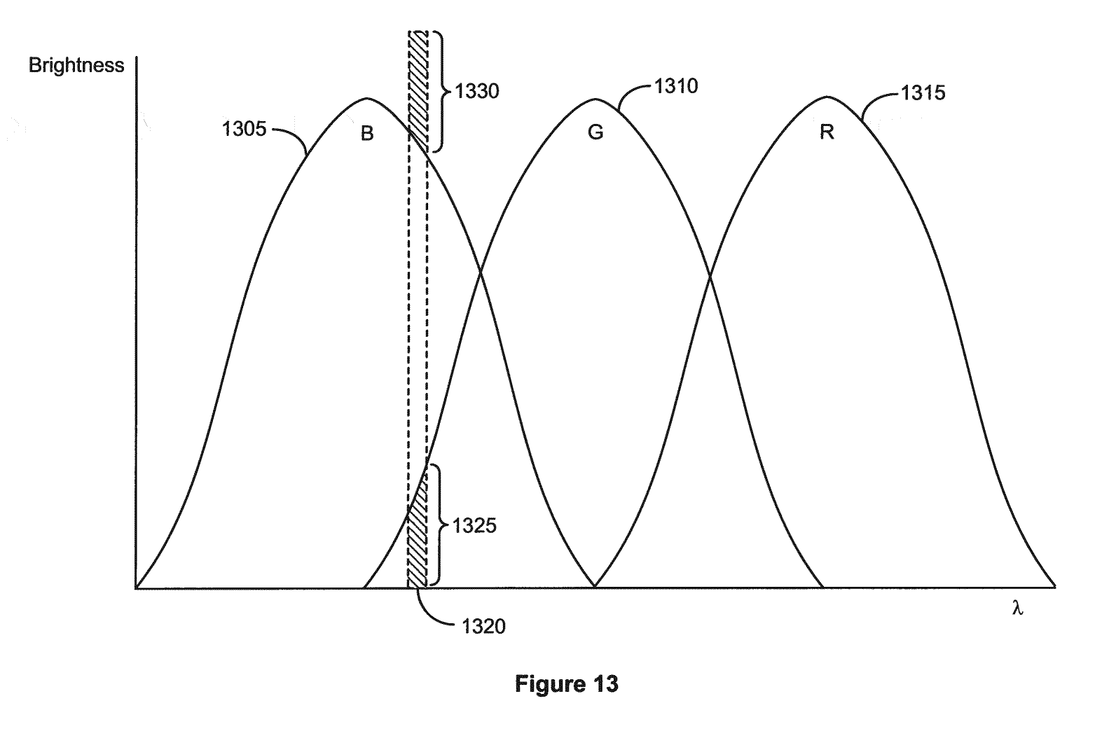

FIG. 13 shows an example of a graph of the spectral responses of three interferometric modulation subpixels, each of which corresponds to a different color. In this example, curve 1305 corresponds to the spectral response of blue subpixels, curve 1310 corresponds to the spectral response of green subpixels and curve 1315 corresponds to the spectral response of red subpixels in the subpixel array. In this example, the spectral response of the green subpixels substantially overlaps with the spectral response of the blue subpixels and the spectral response of the red subpixels.

Accordingly, when the green subpixels are illuminated with some wavelengths of light in the blue range or the red range, the response of the green subpixels may provide additional blue or red color. For example, when the subpixel array is illuminated with light in wavelength range 1320, the green subpixels contribute an amount of brightness in the blue wavelength range that is indicated by area 1325. The combined contribution of the blue and green subpixels is indicated by the additional area 1330, the area of which is the same as that of the area 1325.

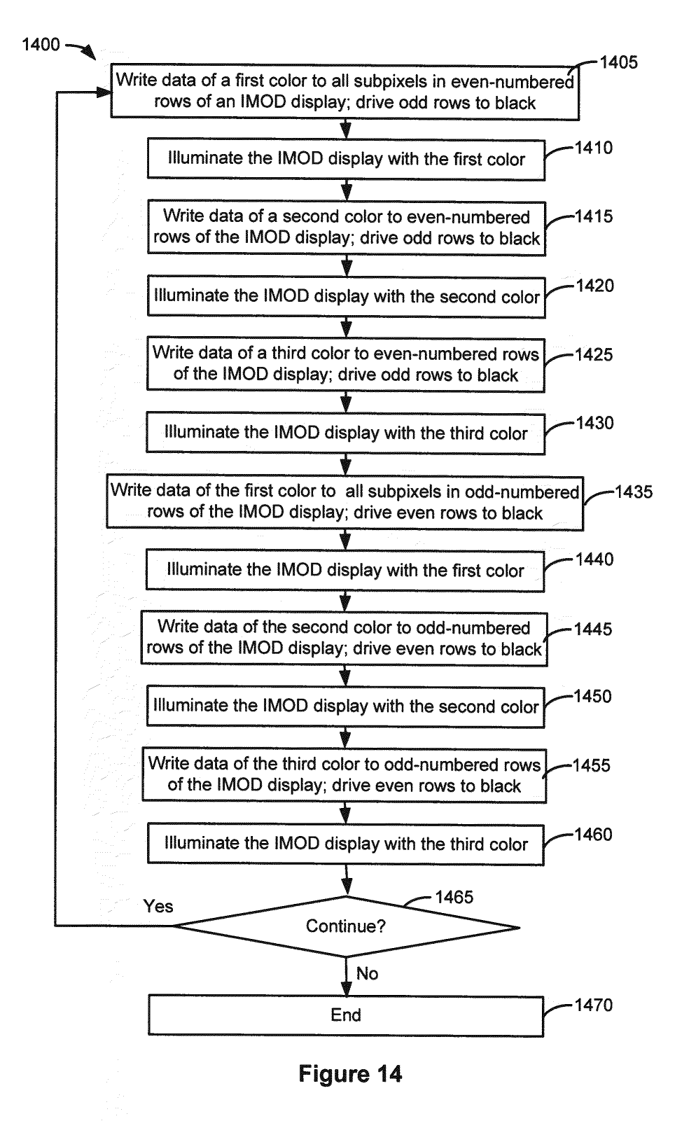

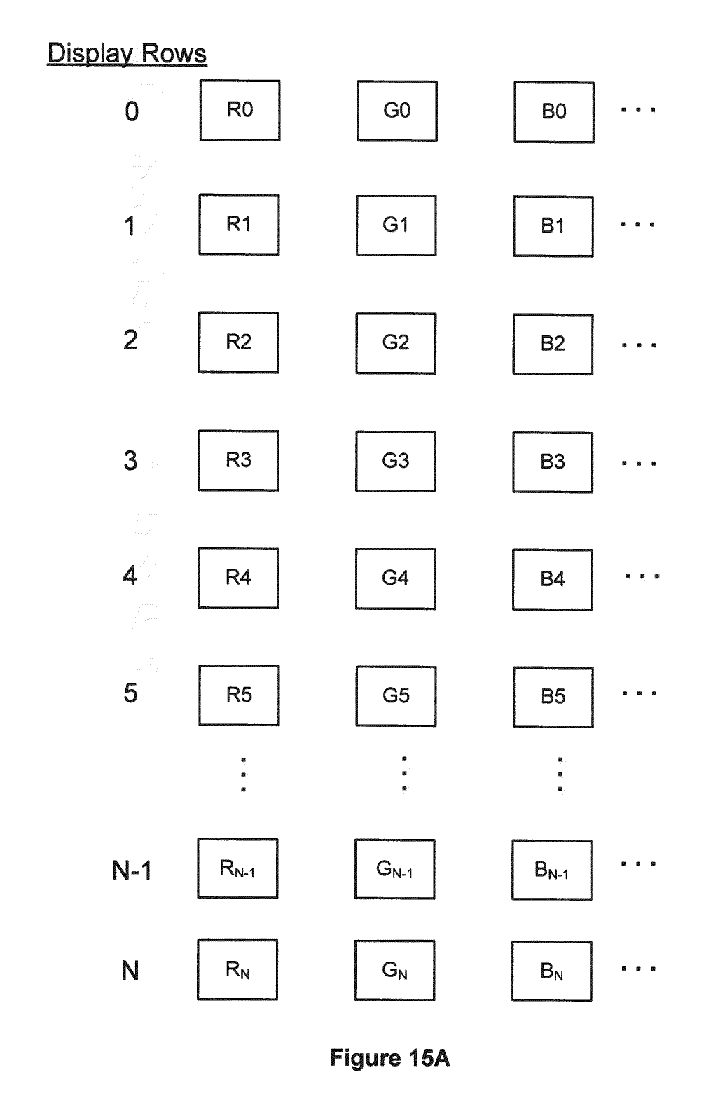

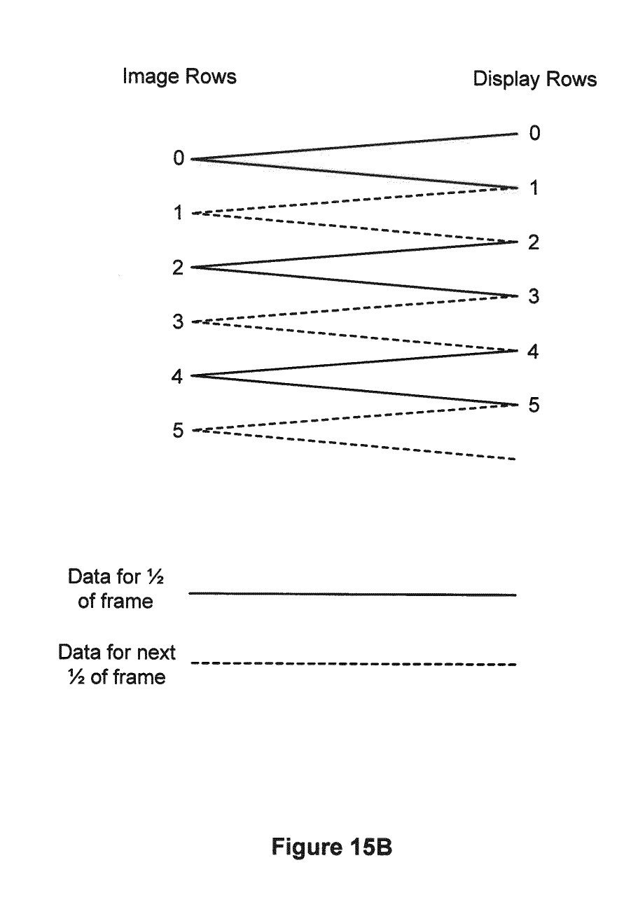

In some implementations, some but not all of the rows may be scanned and written with data of a certain color of a frame, followed by flashing a corresponding colored light, and the remaining rows can be scanned and written with data of the particular color of the frame later. Some examples will now be described with reference to FIGS. 14 through 15B. FIG. 14 shows an example of a flow diagram outlining processes for alternating between driving odd and even rows of interferometric modulators in a display. FIG. 15A shows an example of rows of interferometric modulators in a display.

In the example of FIG. 14, data for a first color is written to all subpixels in even-numbered rows of an array of interferometric modulation subpixels. (See block 1405 of FIG. 14.) In this example, rows to which color data are not being written (in this instance, the odd-numbered rows) are driven to black. Referring to FIG. 15A, for example, alternating rows 0, 2, 4 through N−1 are even-numbered rows and alternating rows 1, 3, 5 through N are odd-numbered rows. In this example, each “row” includes red, green and blue subpixels. However, the orientation of FIG. 15A is only an example. In other examples, a drawing of a subpixel array may be oriented such that each row includes a single subpixel color. Only a portion of the subpixels in the array is shown: as indicated by the ellipses, there are additional rows and columns of subpixels in the array that are not depicted in FIG. 15A. In block 1405 of FIG. 14, red data are written to all subpixels in alternating rows 0, 2, 4 through N−1, while all subpixels in alternating rows 1, 3, 5 through N are driven to black. The entire subpixel array is then illuminated with red light. (See block 1410.)

In block 1415, data for a second color (which is green in this example) are written to all subpixels in alternating rows 0, 2, 4 through N−1, while all subpixels in alternating rows 1, 3, 5 through N are driven to black. The entire subpixel array is then illuminated with green light. (See block 1420.) Then, data for a third color, which is blue in this example, are written to all subpixels in alternating rows 0, 2, 4 through N−1, while all subpixels in alternating rows 1, 3, 5 through N are driven to black. (See block 1425.) The entire subpixel array is then illuminated with blue light. (See block 1430.)

After the operation of block 1430, only half a frame of image data has been written to the subpixel array. Therefore, in block 1435, red data are written to all subpixels in odd-numbered rows (alternating rows 1, 3, 5 through N in this example), while all subpixels in even-numbered rows (alternating rows 0, 2, 4 through N−1 in this example) are driven to black. The entire subpixel array is then illuminated with red light. (See block 1440.)

In block 1445, data for a second color, which is green in this example, are written to all subpixels in alternating rows 1, 3, 5 through N, while all subpixels in alternating rows 0, 2, 4 through N−1 are driven to black. The entire subpixel array is then illuminated with green light. (See block 1450.) Then, data for a third color, which is blue in this example, are written to all subpixels in alternating rows 1, 3, 5 through N, while all subpixels in alternating rows 0, 2, 4 through N−1 are driven to black. (See block 1455.) The entire subpixel array is then illuminated with blue light. (See block 1460.) In block 1465, it is determined whether to continue controlling the display according to method 1400.

FIG. 15B shows an example of a diagram that depicts how to alternate between driving odd and even rows of interferometric modulators in a display without driving rows to black. In this implementation, when the first half of a frame of image data is being written, data from a single row of image data are written to two adjacent rows of the subpixel array. In this example, the data from even-numbered image rows are written first, but in other examples the data from odd-numbered image rows may be written first.

Here, data for a first color (e.g., red data) from row 0 of the image data may first be written to all subpixels in rows 0 and 1 of the display. At the same time, red data from row 2 of the image data may be written to all subpixels in rows 2 and 3 of the display, while red data from row 4 of the image data may be written to all subpixels in rows 4 and 5 of the display, etc., until all subpixel rows have been addressed. None of the subpixel rows are driven to black in this example. The display may then be illuminated by red light.

Data for a second color (e.g., green data) from even-numbered rows of the image data may then be written to all subpixels of the display. Green data from row 0 of the image may be written to all subpixels in rows 0 and 1 of the display, while green data from row 2 of the image data may be written to all subpixels in rows 2 and 3 of the display, and so on. None of the subpixel rows are driven to black in this example. The display may then be illuminated by green light.

In the same manner, data for a third color (e.g., blue data) from even-numbered rows of the image data may then be written to all subpixels of the display. The display may then be illuminated by blue light.

At this stage, half a frame of image data has been written to the display. To write the next half of the frame, red data from row 1 of the image may first be written to all subpixels in rows 1 and 2 of the display, while red data from row 3 of the image may be written to all subpixels in rows 3 and 4 of the display, etc., until all subpixel rows have been addressed. None of the subpixel rows are driven to black in this example. The display may then be illuminated by red light. In the same manner, green data from odd-numbered rows of the image may then be written to all subpixels of the display. The display may then be illuminated by green light. Blue data from odd-numbered rows of the image may then be written to adjacent subpixel rows of the display. The display may then be illuminated by blue light. At this time, an entire data frame will have been written.

Some such odd/even implementations have the advantage of being able to increase the overall time frame for writing a frame without causing noticeable flicker. In general, the shorter the overall frame time, the less chance of noticeable flicker. The time for writing an image data frame and illuminating the display should be kept below the flicker threshold T_{flicker}, beyond which a typical observer will detect flicker. T_{flicker} is a function of various factors, such as display resolution, subpixel size, the distance between an observer and the display, etc. There is also a subjective aspect to flicker perception.

For example, suppose that a “scrolling black” implementation (e.g., an implementation described above with reference to FIGS. 9 and 10A-B) had a frame time of 25 ms. An odd/even implementation might have a frame time of 40 ms (20 ms for the even rows and 20 ms for the odd rows), yet may have even less noticeable flicker than the scrolling black implementation. For a 40 ms frame time with the odd/even implementation, an observer's flicker perception may be similar to that for a frame having a 20 ms frame time. This is made possible by high display resolution: the spatial resolution of a high-resolution display can suppress flicker. The odd and even lines can dither each other in, so that odd/even methods implemented in a high-resolution display may have the same flicker perception as much shorter frames.

The subpixel size and spacing of the display affects T_{flicker}. For a given display size, having smaller subpixels means there are more rows of subpixels. Having more rows of subpixels will generally mean a relatively longer time for addressing all of the rows. A longer addressing time tends to make the frame time longer and having longer frame times tends to cause flicker. However, having relatively smaller subpixels can help to avoid artifacts due to spatial dithering. Accordingly, having higher resolution results in relatively fewer spatial artifacts, but more temporal artifacts (flicker). If a display is viewed at a distance of approximately 1.5 feet to 2 feet, a display line spacing on the order of 40 to 60 microns should provide sufficiently high resolution for the 40 ms frame time with the odd/even implementation in the foregoing example. A display line spacing in the low tens of microns, e.g., less than 50 microns, would further reduce the chance of perceptible flicker for this example.

Having a longer frame time allows for the possibility of increasing the overall time of flashing the colored light, which increases the brightness of the display. The available time to address a display is T_{address}=Nₗᵢₙₑₛ*line time, where line time is the time to write data to a single row and Nₗᵢₙₑₛ is the number of lines to which data will be written in the display. In some implementations, the front light flashing time can be computed by: T_{flashing}_{_{—}}ₜᵢₘₑ=T_{flicker}−T_{address}. If there are 3 colored lights to flash sequentially, the flashing time of each colored light can be computed by dividing T_{flashing}_{_{—}}ₜᵢₘₑ by 3.

For example, suppose that a “scrolling black” implementation had a frame time of 21 ms, with 18 ms for writing color data (6 ms per color) and 3 ms for flashing colored light from the front light (1 ms per color). An odd/even implementation might have a frame time of 42 ms (21 ms for the even rows and 21 ms for the odd rows). If the odd/even implementation took 18 ms for writing color data, the remaining 24 ms could be used for flashing colored light from the front light (4 ms for each color during both the odd phase and the even phase). However, a display being operated according to an odd/even implementation would generally still be dimmer in bright ambient light conditions than the display when being operated in a full reflective mode, such as the one described above with reference to FIGS. 11 and 12.

Alternatively, one can take advantage of the longer frame time to lower power consumption. Power usage is proportional to the flash time: if the flash time is not increased when the frame time is increased, less power will be consumed. The settings for specific implementations may seek to optimize power consumption and color saturation/gamut.

Other variations to the odd/even implementations may involve writing data to every third row, every fourth row, etc., and then flashing a corresponding colored light. Still other variations may involve adjusting the flashing time of colored lights after different sets of rows are scanned. For example, in some implementations, even rows may be illuminated for a first time whereas odd rows may be illuminated for a second time. The first time may be longer or shorter than the second time.

In alternative implementations, data of two colors (e.g., red and blue because their spectral responses are sufficiently separated) can be written first and then the corresponding colored lights (e.g., red light and blue light) may be flashed together. Referring again to FIG. 13, it may be observed that there is very little overlap between curve 1305 (the spectral response for blue subpixels in this example) and curve 1315 (the spectral response for red subpixels in this example). Because of the lack of overlap between the spectral responses for red and blue subpixels, the red light will not substantially affect the blue subpixels and vice versa.

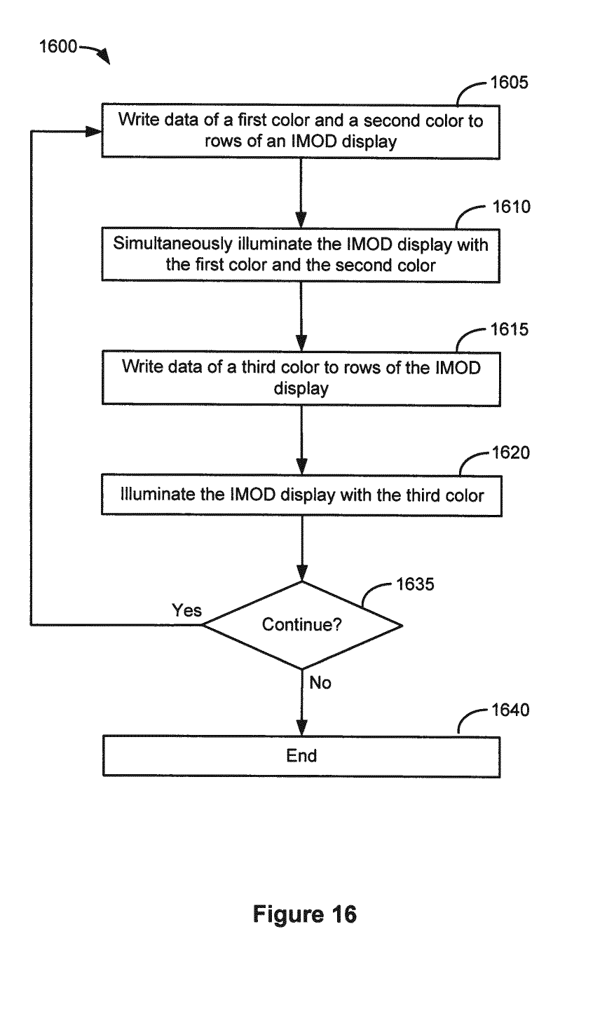

FIG. 16 shows an example of a flow diagram outlining processes for simultaneously writing more than one color to rows of subpixels in a display. In the current example, the display is an IMOD display. In block 1605, data for a first color and a second color are written to corresponding subpixels in the display. For example, red subpixels may be driven with red data only. Blue subpixels may be driven with blue data only. Green subpixels may be driven to black. Then, the display may be simultaneously illuminated with red and blue light. (See block 1610.)

Green data may then be written to green subpixels of the display, while red and blue subpixels are driven to black. (See block 1615.) The display may then be illuminated with green light. (See block 1620.) At this time, a frame of data has been written. In block 1635, it is determined whether to write another frame or to change the operational mode.

Such methods may be used in various ways. If so desired, these methods could be used to reduce the field time and therefore the frame time. By writing data and illuminating the display twice within a frame, instead of writing data and illuminating the display three times as in some of the above-described methods, the frame length could be reduced by approximately ⅓ if the writing time and flashing time are held substantially constant. For example, if a “scroll to black” implementation had a frame length of 18 ms, method 1600 could reduce the frame length to 12 ms. Alternatively, or additionally, these methods may be used to increase the overall amount of time available for illuminating the display. If the same frame length is used (e.g., 18 ms), an additional ⅓ of the frame (6 ms) becomes available for illumination. For example, if the overall “flash time” available in a “scroll to black” implementation is 3 ms per frame, which may be divided equally between the three colors (i.e., 1 ms per color), the illumination time of method 1600 could be increased to 9 ms if so desired. The red and blue lights could be flashed for 4.5 ms and the green light could be flashed for 4.5 ms in one example. Note that the available “flash time” may not be divided equally between the colors. Different lengths of time could be used for the different colors, e.g., 5 ms for red and blue and 4 ms for green.

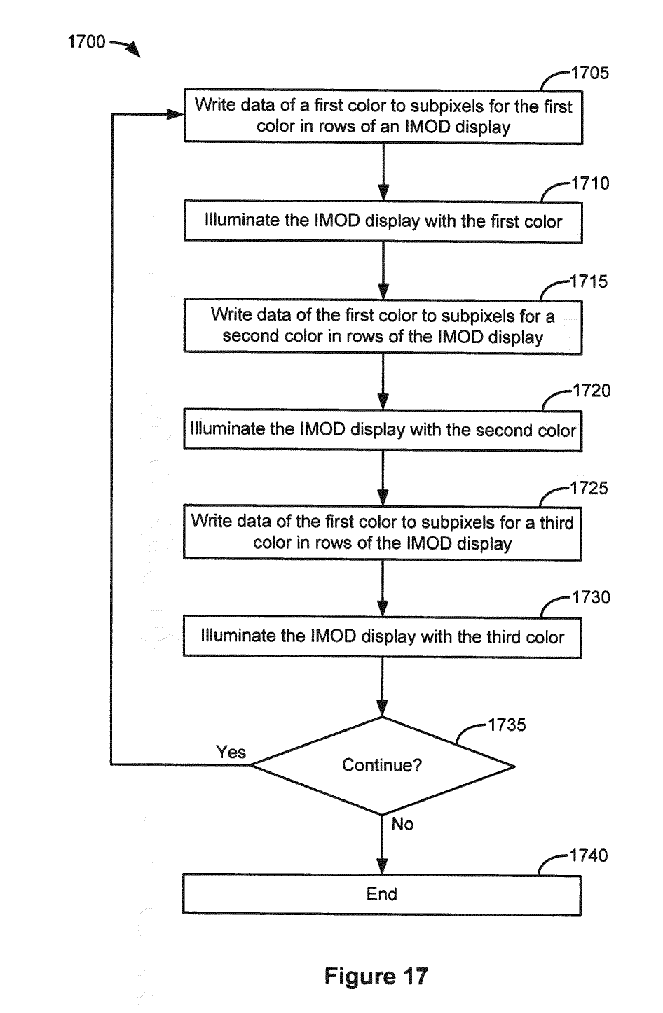

FIG. 17 shows an example of a flow diagram outlining processes for sequentially writing data for a single color to all interferometric modulators in a display. In this example, green data are written to subpixels associated with each color sequentially, each followed by flashing of a corresponding colored light. In block 1705, the green subpixels are written with green data, followed by flashing of a green light (block 1710). Then, the red subpixels are written with green data (block 1715), followed by flashing of a red light (block 1720). Subsequently, the blue pixels can be scanned and written with green data (block 1725), followed by flashing of a blue light (block 1730). This process can cause the display to generate a pale green color.

At this time, a frame of image data has been written to the display. It may then be determined (block 1735) whether to revert to block 1705 and write another frame or to change the operational mode of the display.

FIG. 18 shows an example of a graph of color gamut versus brightness of ambient light for different types of displays. The brightness of ambient light is indicated on the horizontal axis and color gamut is indicated on the vertical axis. Curve 1805 indicates the response of a typical LCD display. Curve 1810 indicates the response of a conventional IMOD display, whereas curve 1815 shows the response of an IMOD display being operated according to some methods described herein. Region 1820 indicates levels of ambient light brightness for which use of a front light is appropriate for an IMOD display, whereas region 1830 indicates levels of ambient light brightness for which a front light would generally be powered off.

It may be observed from FIG. 18 that under conditions of low ambient light, the color gamut provided by a conventional IMOD display is substantially lower than that of a typical LCD display. However, the color gamut provided by an IMOD display being operated according to some methods described herein approaches that of a typical LCD display. Under bright ambient light conditions, either type of IMOD display provides much better color gamut than a typical LCD display.

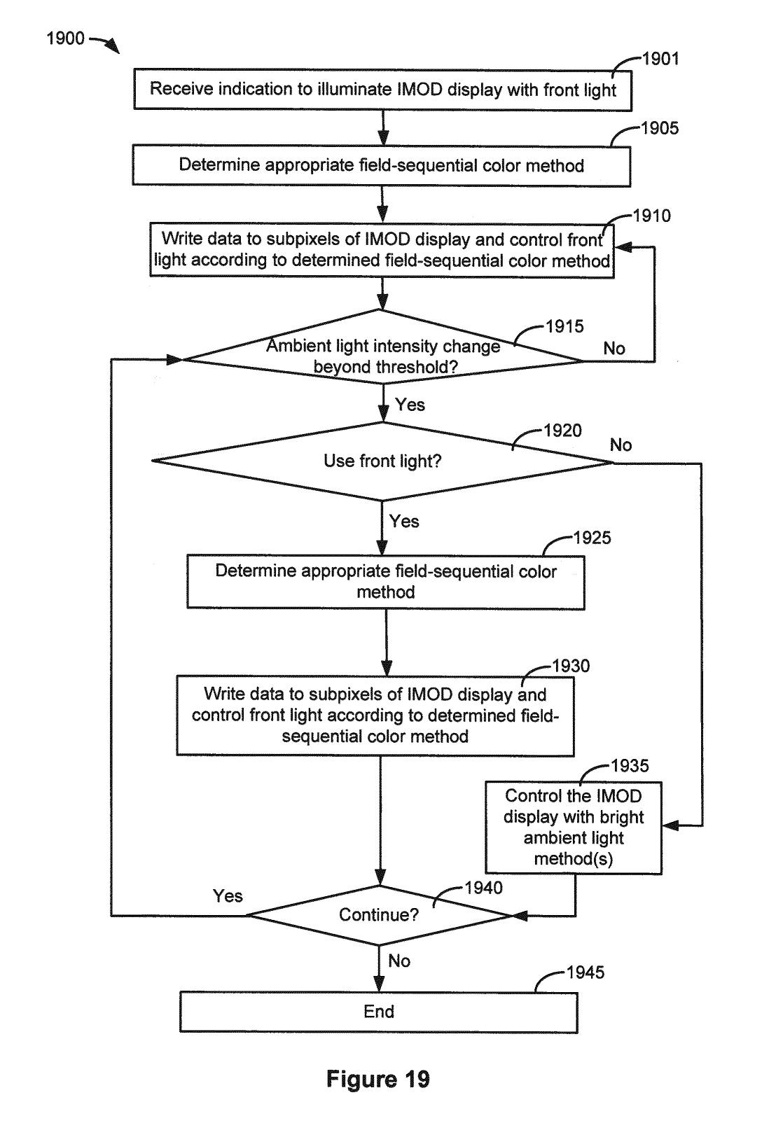

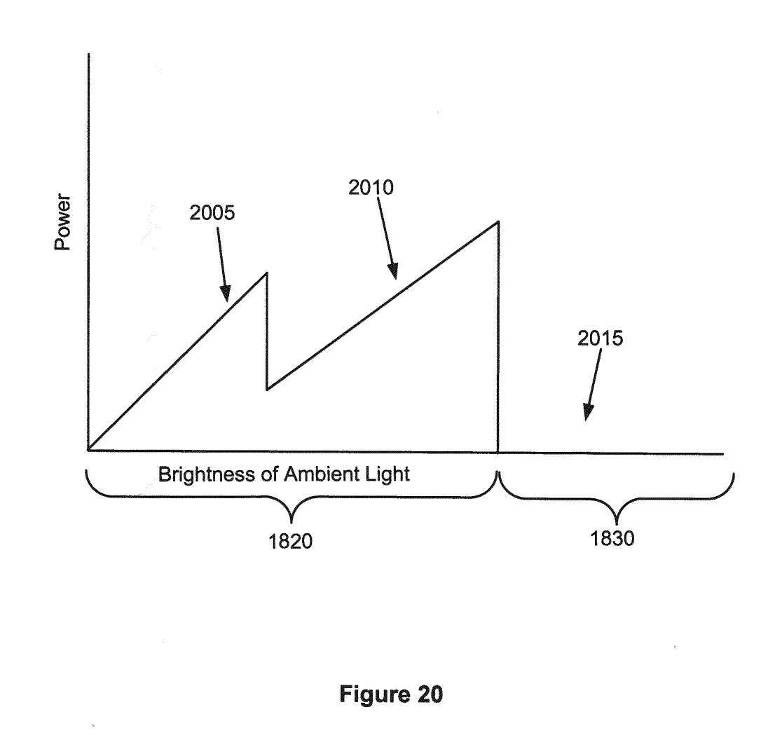

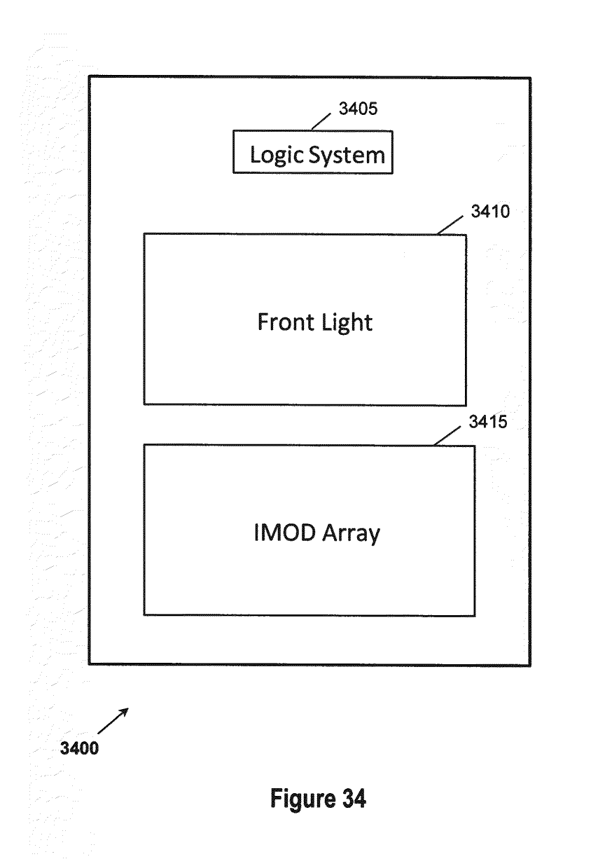

FIG. 19 shows an example of a flow diagram outlining processes for controlling a display according to the brightness of ambient light. FIG. 20 shows an example of a graph of data that may be referenced in a process such as that outlined in FIG. 19. In this example, the display is an IMOD display. In block 1901 of FIG. 19, an IMOD display device receives an indication that the display should be illuminated with a front light. In some implementations, the indication may be according to user input. However, in this example the indication is provided according to a level of ambient light brightness detected by an ambient light sensor, e.g., an ambient light sensor described below with reference to FIGS. 34A and 34B.

Some display devices may be configured to use two or more different field-sequential color methods for controlling the display. In the example shown in FIG. 20, two different field-sequential color methods may be used to control the display when a front light is in operation. A first field-sequential color method 2005 is used under the lowest ambient light conditions, whereas a second field-sequential color method 2010 is used if the ambient light is somewhat brighter. For example, in some implementations, the first field-sequential color method 2005 may be a “scroll to black” or “flash to black” method such as described above with reference to FIGS. 9 and 10. The second field-sequential color method 2010 may be another method described herein, such as method 1100 (see FIG. 11), method 1400 (see FIG. 14) or method 1600 (see FIG. 16). In this example, both of the methods 2005 and 2010 involve increasing the power level under conditions of relatively brighter ambient light.

Method 2015 may be used when the ambient light is sufficiently bright that illumination via a front light is not beneficial. In some implementations, a “taper off” method may be used to transition between method 2010 and powering off the front light. For example, the front light may be powered off over a few hundred ms, half a second or some other period of time.

Referring again to FIG. 19, an appropriate field-sequential color method is selected in block 1905. In this example, a controller (e.g., implemented by a processor) determines an appropriate field-sequential color method according to the level of ambient light brightness detected by the ambient light sensor. In block 1910, data are written to subpixels of the display and a front light is controlled according to the field-sequential color method determined in block 1905.

As the display device is being operated, the ambient light intensity may be monitored. In block 1915, for example, it is determined whether the ambient light intensity has changed beyond a predetermined threshold. Small changes in ambient light may indicate that the same field-sequential color method will be used to control the display, but with a higher or low level of power applied (see FIG. 20). Larger changes may require an evaluation of whether the front light should still be used (block 1920). If not, the display may be controlled in a manner appropriate for bright ambient light conditions (block 1935), e.g., as a conventional IMOD display is controlled. Then method 1900 may transition to block 1940.

If it is determined in block 1920 that the front light should still be used, it may be determined whether or not the same field-sequential color method will be used to control the display (block 1925). In block 1930, the display will be controlled according to the field-sequential color method determined in block 1925. In block 1940, it is determined whether to continue in the current operational mode, e.g., as described elsewhere herein. If so, the power level may be adjusted according to ambient light intensity (see FIG. 20). The ambient light intensity may continue to be monitored (block 1915).

Some implementations described herein can produce a black and white display suitable for displaying text. For example, a black and white display may be produced using a magenta light (e.g., made by adding a magenta filter to white light generated by a light source) to illuminate green interferometric subpixels, or vice versa.

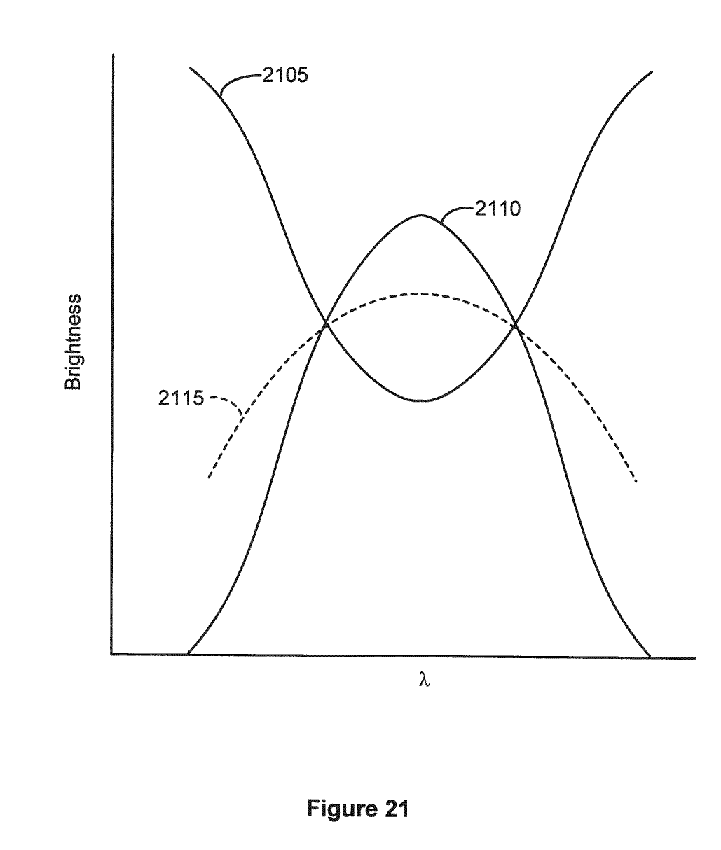

FIG. 21 shows an example of a graph of the spectral response of a green interferometric subpixel being illuminated by a magenta light. The magenta filter applied to produce the magenta light is indicated by curve 2105. The spectral response of the green interferometric subpixel is indicated by curve 2110. The resulting spectral response is indicated by curve 2115. It may be observed that curve 2115 is broader and flatter than curve 2110, indicating less light produced near the peak green wavelengths of curve 2110 and more light produced towards the red and blue ends of the visible spectrum. Accordingly, curve 2115 indicates a light produced by a green interferometric subpixel that may appear white to an observer.

In some implementations, the same display device can provide a color display in a dark environment (e.g., indoors) and a black and white (monochrome) display in a bright environment (e.g., outdoors). Alternatively, in some such implementations, all of the interferometric subpixels in the display could be configured to produce substantially the same spectral response. For example, all of the interferometric subpixels in the display could be configured as green subpixels. Such a display would not provide a multi-color display.

Applying the foregoing field-sequential color methods to reflective displays can provide a number of advantages. For example, when a reflective display is used in low ambient light conditions, the foregoing field-sequential color methods can increase the color gamut of the display. Some implementations provide increased brightness and/or color saturation.

However, providing grayscale for such displays has proven to be challenging. One might imagine that known temporal grayscale methods could be combined with the above-mentioned field-sequential color methods in a reflective display. However, it is not apparent how such methods could be combined. With temporal grayscale methods, the gray level depends on the length of time the image is displayed. For example, to have two bits of grayscale via a temporal grayscale method, a display is addressed twice during a single frame. The MSB is used to drive the display twice as long as the LSB. Such methods do not seem to be compatible with the above-described field-sequential color methods, which involve pulsing a colored light source briefly after image data for a corresponding color field are written.

Accordingly, novel grayscale methods are disclosed herein. Some such methods exploit the overlapping spectral responses of reflective subpixels. In the example described above with reference to FIG. 13, the spectral response of the green subpixels substantially overlaps with the spectral response of the blue subpixels and the spectral response of the red subpixels. However, it may be observed that there is very little overlap between curve 1305 (the spectral response for blue subpixels in this example) and curve 1315 (the spectral response for red subpixels in this example). Because of the lack of overlap between the spectral responses for red and blue subpixels, the red light will not substantially affect the blue subpixels and vice versa.

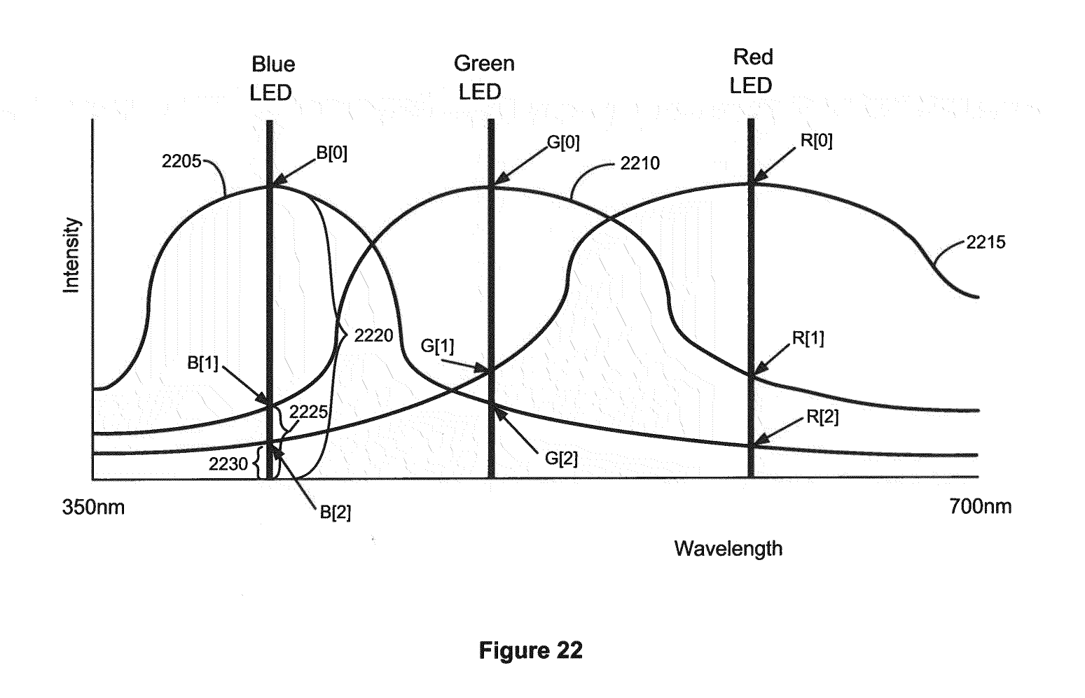

However, in some other implementations, there may be a more substantial overlap between the spectral responses for red and blue subpixels. One such implementation will now be described with reference to FIG. 22.

FIG. 22 shows an example of a graph of the spectral response of three reflective subpixels, each of which has an intensity peak that corresponds with a different color. In this example, the curve 2205 corresponds to the spectral response of blue subpixels, the curve 2210 corresponds to the spectral response of green subpixels and the curve 2015 corresponds to the spectral response of red subpixels in the subpixel array. In this implementation, the spectral response of the green subpixels substantially overlaps with the spectral response of the blue subpixels and the spectral response of the red subpixels. Moreover, the spectral response of the blue subpixels substantially overlaps not only with that of the green subpixels, but also with that of the red subpixels. Similarly, the spectral response of the red subpixels substantially overlaps not only with that of the green subpixels, but also with that of the blue subpixels.

FIG. 22 also provides examples of wavelength ranges that correspond with blue, green and red light sources (LEDs in this example) that may be used to illuminate the reflective display. In this example, the wavelength ranges of the blue, green and red LEDs correspond with intensity peaks for the spectral responses of the blue, green and red subpixels. At the wavelengths corresponding to the blue LED, the blue subpixels contribute an intensity 2220 in the blue wavelength range. In addition to the contribution of the blue subpixels, the green subpixels contribute an intensity 2225 in this wavelength range. The red subpixels contribute an intensity 2230.

If all three subpixels were configured to reflect light when the blue LED is illuminated, the combined intensity would be the sum of intensities 2220, 2225 and 2230. However, if the red subpixel were in a black state while the green and blue subpixels were configured to reflect light, the combined intensity would be the sum of intensities 2220 and 2225. Similarly, if the green subpixel were in a black state while the red and blue subpixels were configured to reflect light, the combined intensity would be the sum of intensities 2220 and 2230. Accordingly, the amount of brightness for each color may be modulated according to the state of each subpixel.

Some implementations described herein use colors other than the field color to produce grayscale. In this three-bit example, the field color may correspond to the most significant bit (MSB) and the other colors may correspond to the other two bits. For the blue field, the blue subpixel may be driven according to the MSB (B[0]), the green subpixel may be driven according to the next bit (B[1]) and the red subpixel may be driven according to the least significant bit (LSB) B[2].

Although the state of each reflective subpixel corresponds with a bit in this example, the contributions of each subpixel will not generally correspond with powers of two. Instead, the contributions of each subpixel will depend on the spectral response of each subpixel and the extent of overlap with the spectral response of the other subpixels of the display. For example, by comparing the intensity corresponding to the LSB for green (G[2]) to the intensities of the LSB for blue (B[2]) and red (R[2]), one can see that the intensity of G[2] is substantially greater than that of B[2] or R[2]. This means that in this example, when the blue subpixel is configured to reflect light it will contribute more intensity to the green field than a reflective red subpixel will contribute to the blue field.

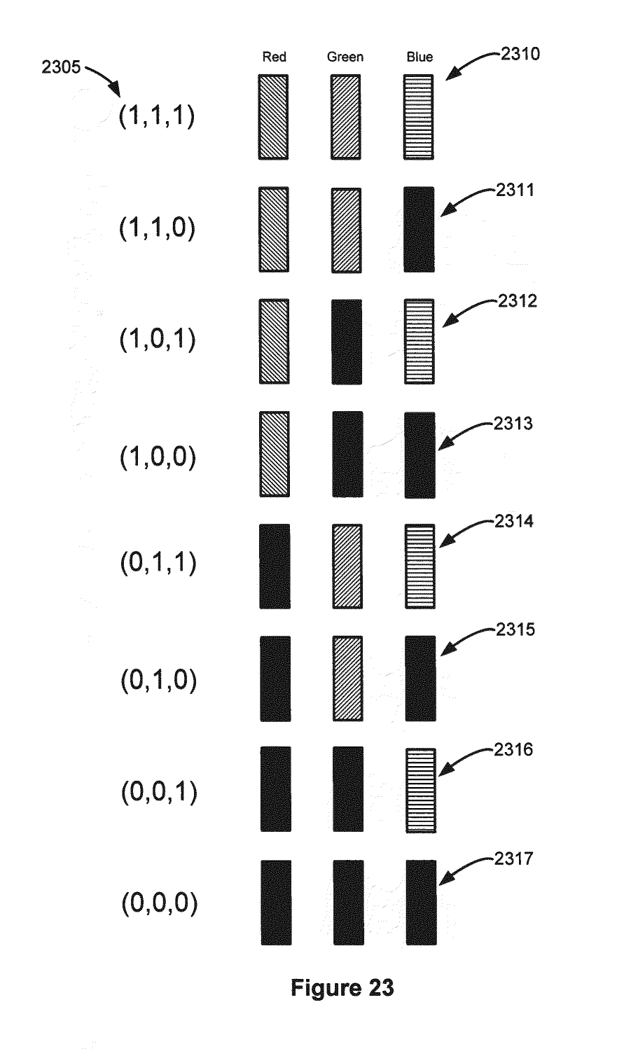

FIG. 23 shows an example of reflective subpixel configurations corresponding to three bits and eight grayscale levels. In such implementations, eight different brightness levels may be obtained for each field color. In this example, the red field will be considered. Each three-bit group 2305 corresponds with a subpixel state 2310. Because FIG. 23 involves the red field, each three-bit group 2305 indicates (R[0],R[1],R[2]), the MSB, next bit and LSB for red. In some implementations, this three-bit group 2305 may correspond with the intensity values for R[0], R[1] and R[2] that are indicated in FIG. 22.

Here, the three-bit group (1,1,1) corresponds with a subpixel state 2310 in which the red, green and blue subpixels are all configured to reflect light in the red field. Therefore, the subpixel state 2310 corresponds with maximum brightness for red color. The three-bit group (1,1,0) corresponds with a subpixel state 2311 in which only the red and green subpixels are configured to reflect light in the red field. The blue subpixel is configured to be in the black state and therefore does not make a significant intensity contribution in the red field. However, because the blue subpixel corresponds with the LSB R[2], if the intensity contribution is similar to that shown in FIG. 22 the subpixel state 2311 for the three-bit group (1,1,0) may not be substantially less bright than the subpixel state 2310 corresponding to the three-bit group (1,1,1).

The three-bit group (1,0,1) corresponds with a subpixel state 2312 in which only the red and blue subpixels are configured to reflect light in the red field. The green subpixel is configured to be in the black state and therefore does not make a significant intensity contribution in the red field. Because the green subpixel corresponds with R[1], this subpixel state 2312 may be substantially less bright than the subpixel state 2310 corresponding to the three-bit groups (1,1,1). For example, if the intensity contributions of the blue and green subpixels in the red field are similar to those shown in FIG. 22, the green subpixels may be contributing more than three times the intensity than the blue subpixels in the red field.

However, intensities corresponding to the three-bit groups (1,1,0) and (1,0,1) may vary substantially from field to field. For example, if the intensity contributions of the blue and red subpixels in the green field also are similar to those shown in FIG. 22, the difference between the intensities corresponding to G[1] and G[2] may be substantially less than the difference between the intensities corresponding to R[1] and R[2]. Therefore, one would expect less of a difference between the intensities corresponding to the three-bit groups (1,1,0) and (1,0,1) in the green field as compared to the difference between the intensities for the three-bit groups (1,1,0) and (1,0,1) in the red field.

Referring again to FIG. 23, the relative intensities of the subpixel states 2310-2317 corresponding to the three-bit groups 2305 continue to decrease in a downward direction. As noted above, the changes in brightness between the three-bit groups 2305 may vary substantially and may differ according to the field color. For each field color, however, there may be a significant decrease in intensity between the subpixel state 2313 for the three-bit group (1,0,0) and the subpixel state 2314 for the three-bit group (0,1,1): for all field colors, having the MSB set to zero means having the corresponding colored subpixel driven to black. Here, for example, having the MSB set to zero means having the red subpixel driven to black during the red field. The lowest intensity levels correspond to the subpixel state 2316 for the three-bit group (0,0,1), in which only the blue subpixel is reflecting light during the red field, and the subpixel state 2317 for the three-bit group (0,0,0), in which all subpixels are driven to black during the red field.

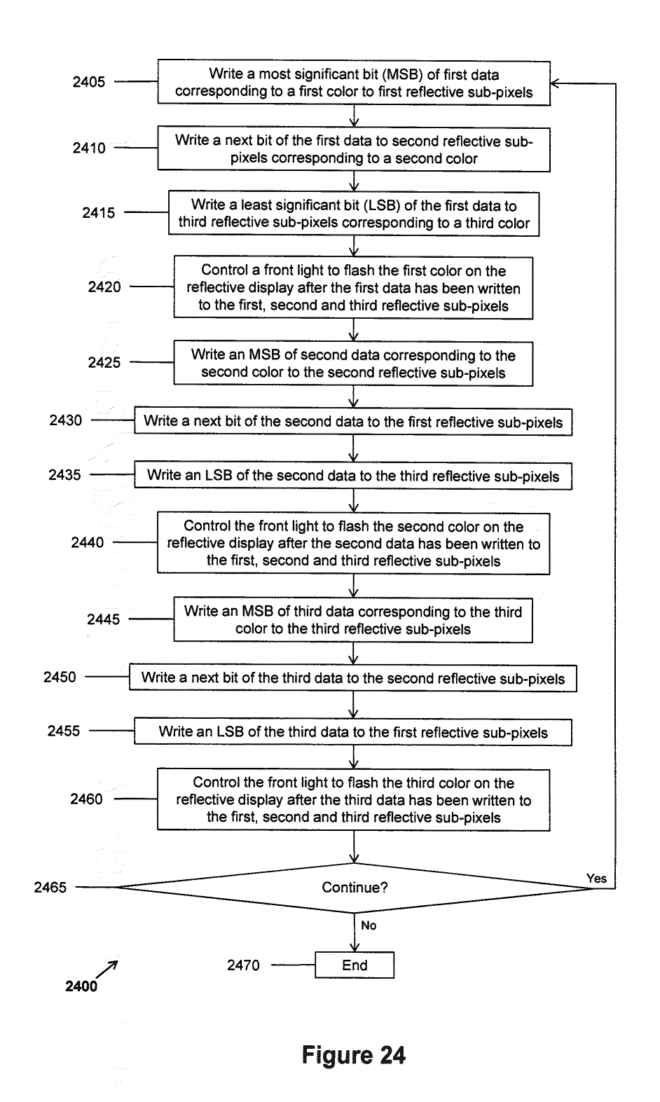

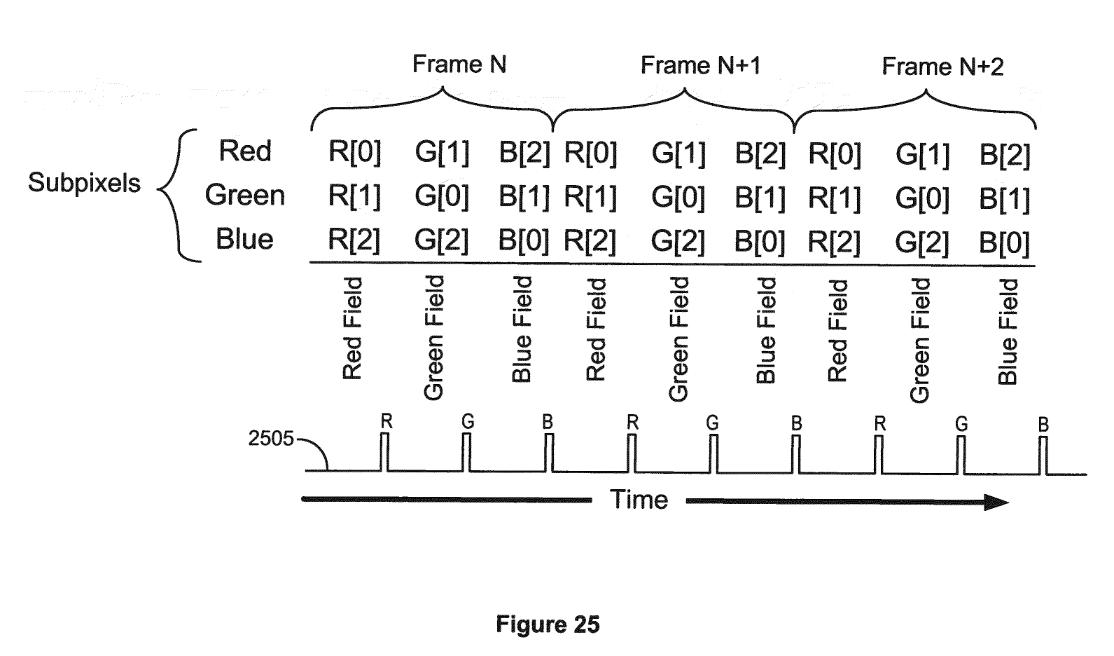

FIG. 24 shows an example of a flow diagram outlining a process for controlling a reflective display according to a grayscale method for field-sequential color. FIG. 25 shows an example of controlling subpixels of a reflective display according to the process of FIG. 24.

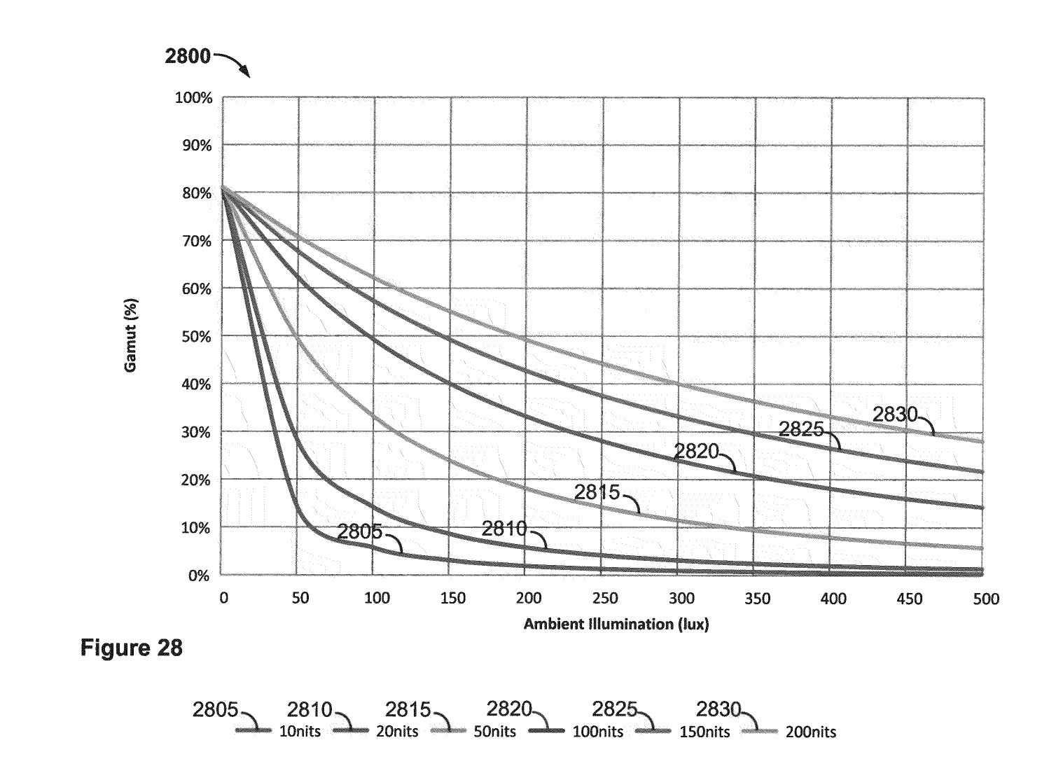

The process 2400 of FIG. 24 may, for example, be implemented in a reflective display. The reflective display may, in some implementations, be a component of a portable display device such as the display device 40 that is described below with reference to FIGS. 28A and 28B. The process 2400 may sometimes be referenced herein as “grayscale FSC.”

The reflective display may include an illumination system, reflective subpixels and a control system. The illumination system may include a front light that is configured to illuminate the reflective display with a first color, a second color and a third color. The reflective display may include a plurality of first reflective sub-pixels corresponding to the first color, a plurality of second reflective sub-pixels corresponding to the second color and a plurality of third reflective sub-pixels corresponding to the third color. The control system may, for example, include at least one of a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof.

Accordingly, in some implementations the blocks of the process 2400 may be implemented, at least in part, by such a control system. In some implementations, the process 2400 may be implemented, at least in part, by software encoded in a non-transitory medium. The software may include instructions for controlling a reflective display to perform the process 2400 or other processes described herein.

In block 2405, an MSB of first data corresponding to the first color may be written to at least some of the first reflective subpixels. A next bit of the first data may be written to the second reflective sub-pixels (block 2410) and an LSB of the first data may be written to at least some of the third reflective sub-pixels (block 2415). In some implementations, the control system may be configured to assign bit values according to grayscale levels that correspond with values of the MSB, the next bit and the LSB. The control system may be configured to receive grayscale level data and to determine the bit values according to the grayscale level data. For example, the control system may be configured to determine the bit values by referencing a data structure that has grayscale levels and corresponding values of the MSB, the next bit and the LSB stored therein.

The front light may be controlled to flash the first color on the reflective display after the first data have been written to the first, second and third reflective sub-pixels (block 2420). The blocks 2405 through 2420 correspond to a first color field of a frame of image data in this example.

Referring to FIG. 25, the red field of frame N provides one example of the blocks 2405 through 2420. MSB R[0] is written to the red subpixels of a reflective display, while next bit R[1] is written to the green subpixels and LSB R[2] is written to the blue subpixels. In this example, R[0], R[1] and R[2] are written at substantially the same time. Element 2505 indicates when the reflective display is illuminated and by what color of light. After R[0], R[1] and R[2] are written, the reflective display is illuminated with red light.

Returning to FIG. 24, in block 2425 an MSB of second data corresponding to the second color may be written to at least some of the second reflective subpixels. A next bit of the second data may be written to at least some of the first reflective sub-pixels (block 2430) and an LSB of the second data may be written to at least some of the third reflective sub-pixels (block 2435). The front light may be controlled to flash the second color on the reflective display after the second data have been written to the first, second and third reflective sub-pixels (block 2440). The blocks 2425 through 2440 correspond to a second color field in this example.

Referring again to FIG. 25, the green field of frame N provides an example of the blocks 2425 through 2440. MSB G[0] is written to the green subpixels of a reflective display, while next bit G[1] is written to the red subpixels and LSB G[2] is written to the blue subpixels. After G[0], G[1] and G[2] are written, the reflective display is illuminated with green light.

Returning to FIG. 24, in block 2445 an MSB of third data corresponding to the third color may be written to at least some of the third reflective subpixels. A next bit of the third data may be written to at least some of the second reflective sub-pixels (block 2450) and an LSB of the third data may be written to at least some of the first reflective sub-pixels (block 2455). The front light may be controlled to flash the third color on the reflective display after the third data have been written to the first, second and third reflective sub-pixels (block 2460). The blocks 2445 through 2460 correspond to a third color field in this example.

In FIG. 25, the blue field of frame N provides an example of the blocks 2445 through 2460. MSB B[0] is written to the blue subpixels of a reflective display, while next bit B[1] is written to the green subpixels and LSB B[2] is written to the red subpixels. After B[0], B[1] and B[2] are written, the reflective display is illuminated with blue light.

Returning again to FIG. 24, in block 2465 it is determined whether to continue the process 2400. For example, the process 2400 may end (block 2470) if user input is received indicating that the reflective display will be switched off, if the reflective display enters a sleep mode, or for various other reasons. However, if the process 2400 will continue, the process may revert to the block 2405 and the first field of another frame of image data may be processed. One example is provided in FIG. 25, wherein the process continues from frame N to frame N+1. Additional frames N+2, etc., may subsequently be processed.

The foregoing example involves three-bit groups and eight grayscale levels. However, other implementations may involve more or fewer bits and brightness levels. Some such implementations are described below.

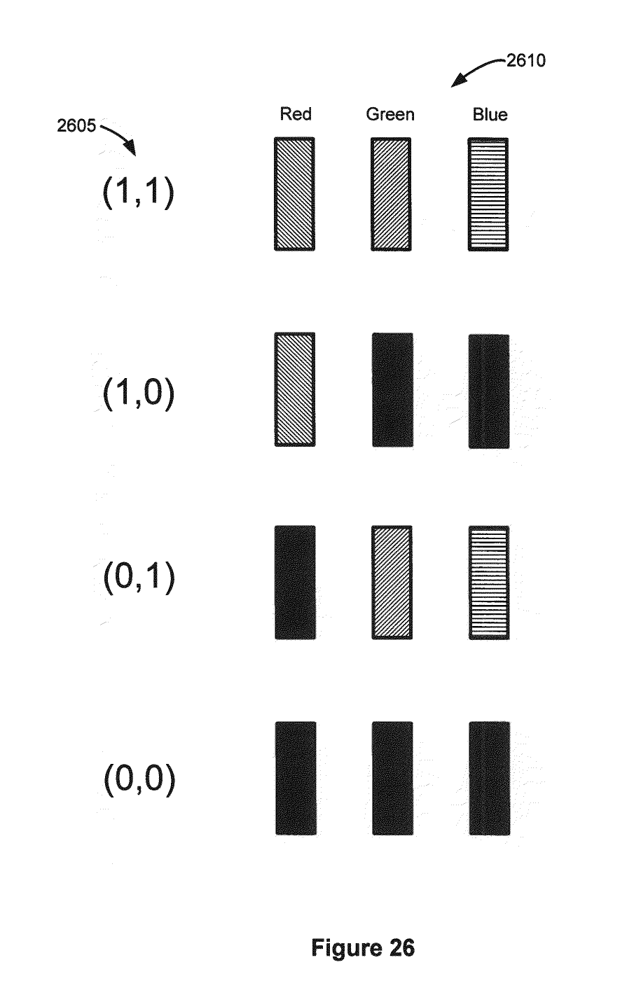

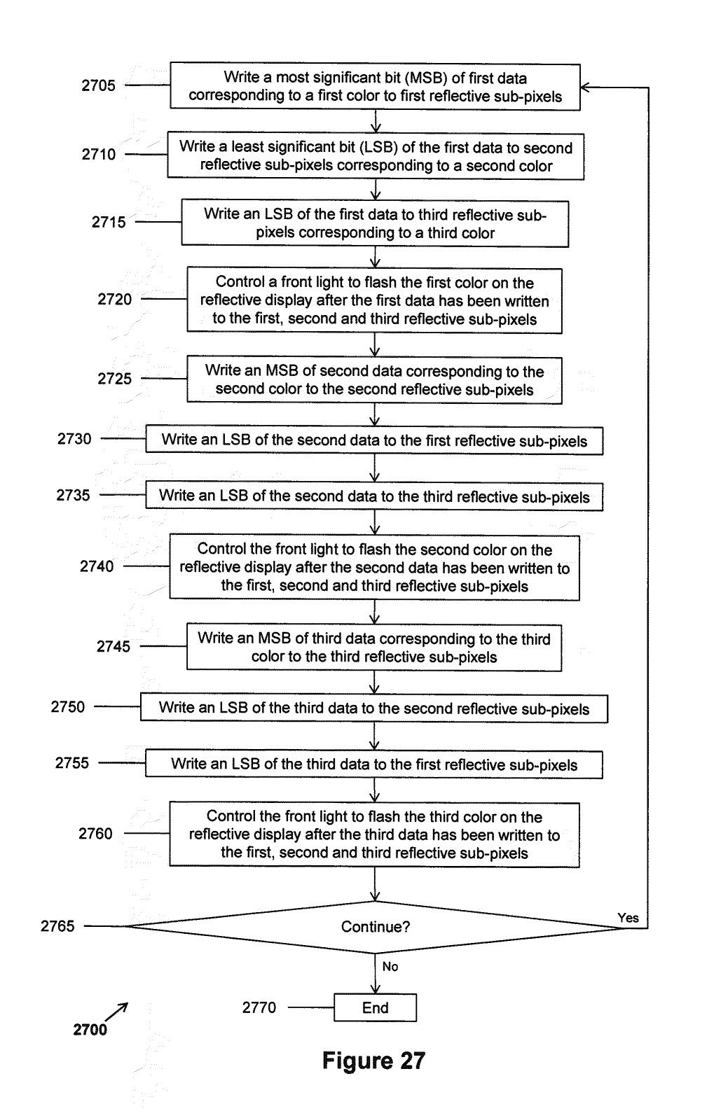

FIG. 26 shows an example of reflective subpixel configurations corresponding to two bits and four grayscale levels. FIG. 27 shows an example of a flow diagram outlining an alternative process for controlling a reflective display according to a grayscale method for field-sequential color.

Referring first to FIG. 26, each two-bit group 2605 corresponds with a subpixel state 2310. In this implementation, four different brightness levels may be obtained for each field color. Because FIG. 26 involves the red field, each two-bit group 2605 corresponds with a subpixel state 2310 of the red field.

Because only two bits are used to control three subpixel colors, subpixels having a color other than the field color are controlled according to the same bit in this example. Here, both the green subpixel and the blue subpixel are controlled according to the same bit (the LSB) when the field color is red. When the field color is green, both the red and the blue subpixels are controlled according to the LSB. When the field color is blue, the red and the green subpixels are controlled with the LSB.

Accordingly, the two-bit group (1,1) and the three-bit group (1,1,1) both correspond to the same subpixel state 2310. Similarly, the same subpixel state 2310 corresponds to the two-bit group (1,0) and the three-bit group (1,0,0). (See FIG. 23.) The subpixel state 2310 for the two-bit group (0,1) is the same as that for the three-bit group (0,1,1). Likewise, the two-bit group (0,0) and the three-bit group (0,0,0) both correspond to the same subpixel state 2310.

In alternative implementations, however, the subpixels may be grouped differently. In some such implementations, the subpixel corresponding to the field color (the red subpixel in this example) and one of the other subpixels may be controlled according to the MSB. For example, in the red field the red subpixel and the blue subpixel may both be controlled according to the MSB for red. In such implementations, the same subpixel state 2310 may correspond to the two-bit group (1,0) and the three-bit group (1,0,1). (See FIG. 23.) The subpixel state 2310 for the two-bit group (0,1) may be the same as that for the three-bit group (0,1,0).

The process 2700 of FIG. 27 may be implemented in a reflective display, e.g., by a control system of such a display. The reflective display may, for example, be a component of a portable display device such as the display device 40 that is described below with reference to FIGS. 28A and 28B. In some implementations, the process 2700 may be implemented, at least in part, by software encoded in a non-transitory medium.

In block 2705, an MSB of first data for a first color may be written to at least some first reflective sub-pixels corresponding to the first color. An LSB of the first data also may be written to at least some second reflective sub-pixels corresponding to a second color (block 2710) and to at least some third reflective sub-pixels corresponding to a third color (block 2715). An illumination system, which may include a front light, may be controlled to flash the first color on the reflective display after the first data have been written to the first, second and third reflective sub-pixels (block 2720). The blocks 2705 through 2720 correspond to a first color field for a frame of image data in this example.

An MSB of second data for the second color may then be written to at least some of the second reflective sub-pixels (block 2725). An LSB of the second data also may be written to at least some of the first reflective sub-pixels (block 2730) and to at least some of the third reflective sub-pixels (block 2735). The illumination system may be controlled to flash the second color on the reflective display after the second data have been written to the first, second and third reflective sub-pixels (block 2740). The blocks 2725 through 2740 correspond to a second color field for a frame of image data.

Subsequently, an MSB of third data for the third color may be written to at least some of the third reflective sub-pixels (block 2745). An LSB of the third data also may be written to at least some of the second reflective sub-pixels (block 2750) and to at least some of the first reflective sub-pixels (block 2755). The illumination system may be controlled to flash the third color on the reflective display after the third data have been written to the first, second and third reflective sub-pixels (block 2760). The blocks 2745 through 2760 correspond to a third color field for a frame of image data.

In block 2765 it is determined (e.g., by a control system of the display) whether to continue the process 2700. For example, the process 2700 may end (block 2770) if user input is received indicating that the reflective display will be switched off, if the reflective display enters a sleep mode, etc. However, if it is determined in the block 2765 that the process 2700 will continue, the process 2700 reverts to the block 2705 in this example. The first field of another frame of image data may be processed.

When observed under conditions of dim ambient light, black and white FSC methods, such as those described above with reference to FIGS. 11-13, can provide very saturated and relatively bright colors. Grayscale FSC methods, such as those described above with reference to FIGS. 22-27, also can provide very saturated and relatively bright colors under conditions of dim ambient light. However, as the ambient light intensity increases, the color gamut provided by black and white FSC methods rapidly decreases.

This effect may be seen in FIG. 28. FIG. 28 is a graph illustrating changes in color gamut according to ambient light intensity for various black and white FSC implementations. Each curve of graph 2800 corresponds to a black and white FSC implementation that differs from the other implementations only in terms of front light brightness. The curve 2805, for example, corresponds to a black and white FSC implementation having the least bright front light: the front light has a brightness of 10 nits. (A “nit” is a unit of illuminative brightness equal to one candle per square meter, measured perpendicular to the rays of the light source.) The curves 2810, 2815, 2820, 2825 and 2830 correspond to black and white FSC implementations having front light brightnesses of 20 nits, 50 nits, 100 nits, 150 nits and 200 nits, respectively.

In the graph 2800, color gamut is plotted on the vertical axis and ambient light intensity is plotted on the horizontal axis. In this example, the units of ambient light intensity are lux. The range of ambient light intensity shown in the graph 2800 is approximately half of the range for which a front light would normally be used for a reflective display: typically, a front light would be used when the ambient light intensity is below a threshold of approximately 1,000 lux.

As shown in FIG. 28, the color gamut of these black and white FSC implementations decreases with increased ambient light intensity. The black and white FSC implementations having the lowest levels of light source intensity show a precipitous drop in color gamut as the ambient illumination increases from zero to 100 lux: for the black and white FSC implementation having the least bright front light, corresponding to the curve 2805, the color gamut decreases from 80% to approximately 6% as the ambient light intensity increases from zero to 100 lux. For the implementations corresponding to the curves 2805 and 2810, the color gamut approaches zero percent as the ambient illumination approaches 500 lux. Even the black and white FSC implementation with the highest level of light source intensity, corresponding to the curve 2830, has a substantial decrease in color gamut as the ambient illumination increases from zero to 500 lux.

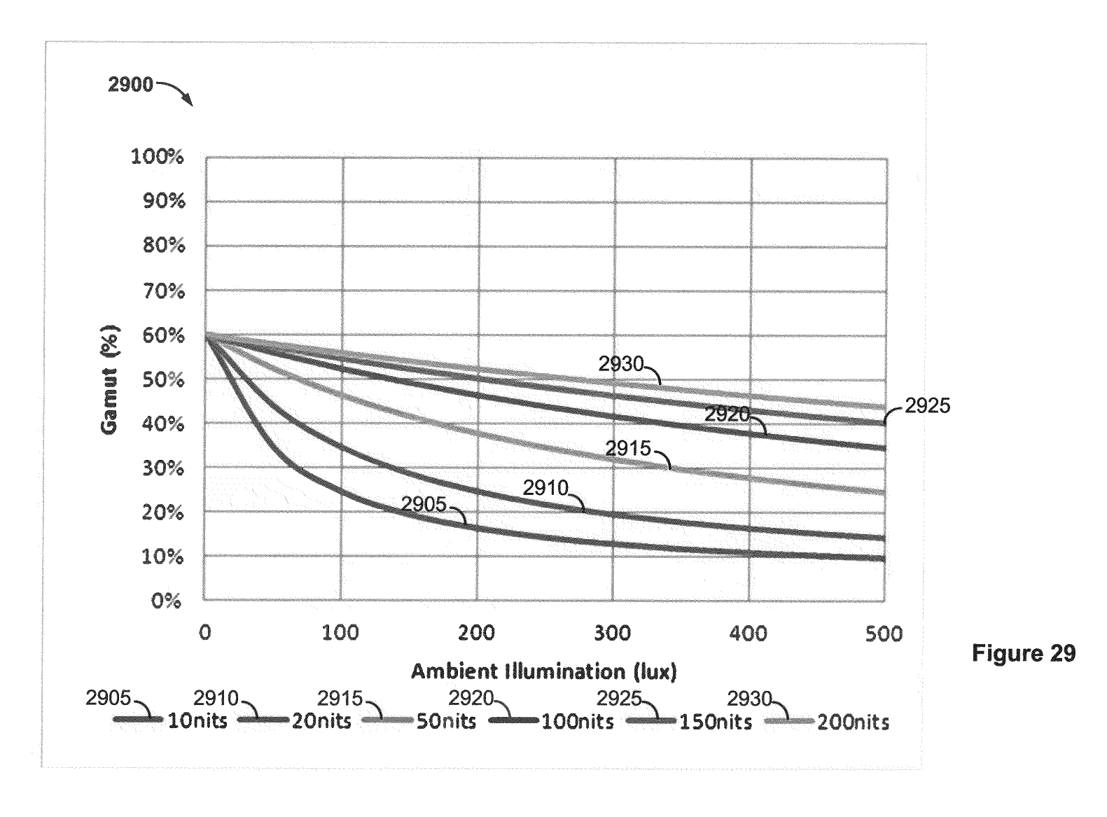

In general, lup2down FSC methods do not provide as high a color gamut as that provided by the black and white FSC methods. However, the color gamut provided by lup2down FSC methods does not decrease as rapidly as the ambient light illumination increases. This effect may be seen in FIG. 29.

FIG. 29 is a graph illustrating changes in color gamut according to ambient light intensity for various lup2down FSC implementations. Each curve of graph 2900 corresponds to a lup2down FSC implementation that differs from the other implementations only in terms of front light brightness. The curve 2905, for example, corresponds to a lup2down FSC implementation having a front light with a brightness of 10 nits. The curves 2910, 2915, 2920, 2925 and 2930 correspond to lup2down FSC implementations having front light brightnesses of 20 nits, 50 nits, 100 nits, 150 nits and 200 nits, respectively.

As compared to black and white FSC implementations having the same levels of light source intensity, the lup2down FSC implementations do not have as large a decrease in color gamut as the ambient light illumination increases. For example, as the ambient light illumination increases from zero to 100 lux, the lup2down FSC implementation having a front light with a brightness of 10 nits (see the curve 2905) has a color gamut that decreases from 60% to about 25%. The color gamut of the corresponding black and white FSC implementation decreases from 80% to approximately 6% as the ambient light intensity increases from zero to 100 lux (see the curve 2805 of FIG. 28). Even at an ambient light illumination of 500 lux, the lup2down FSC implementation having a front light with a brightness of 10 nits has a color gamut of about 10%, whereas the corresponding black and white FSC implementation has a color gamut of about 0%.

Accordingly, as compared to the black and white FSC implementations, even the lup2down FSC implementations having the lowest levels of light source intensity do not show as precipitous a drop in color gamut as the ambient light illumination increases. The lup2down FSC implementations with higher levels of light source intensity still provide a substantial color gamut percent as the ambient light illumination approaches 500 lux: the color gamuts of these implementations range from about 15% to about 44% at this level of ambient light illumination (see curves 2910-2930).

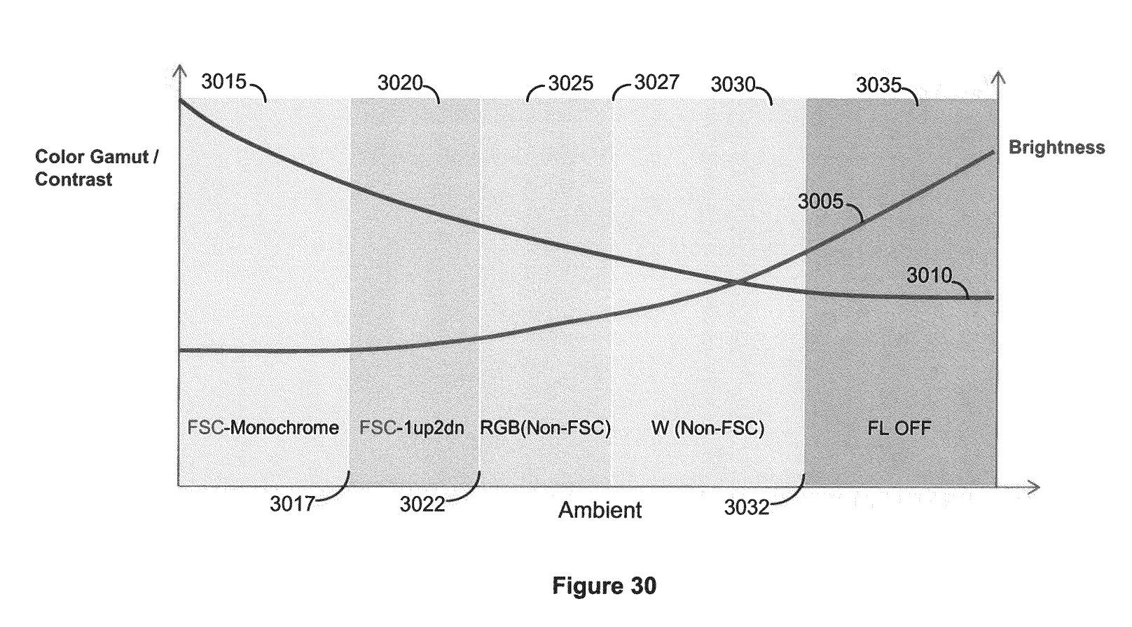

Therefore, some reflective display device implementations described herein may include a control system that is configured to change an operational mode of the front light and/or the display according to ambient light data. A conceptual basis for some such implementations is shown in FIG. 30.

FIG. 30 is a graph illustrating changes in color gamut and brightness according to ambient light intensity for various operational modes of a reflective display device. The curve 3005 indicates brightness levels for these operational modes, whereas the curve 3010 indicates color gamut levels. Each of the regions 3015-3035 corresponds both to a range of ambient light intensity levels and to an operational mode for a reflective display device. Corresponding data may, for example, be stored in a memory that is configured for communication with a control system of a reflective display device. The control system may use such data for determining what level of ambient light intensity should trigger a change from one operational mode to another.

In this example, the region 3015 corresponds to a black and white FSC operational mode for use in the lowest levels of ambient light illumination. In some implementations, for example, the region 3015 may extend from substantially zero lux to an ambient light illumination in the range of approximately 50 lux to 500 lux at the boundary 3017. In some implementations, operational modes involving grayscale FSC methods may be used for levels of ambient light illumination corresponding to the region 3015.

The region 3020 corresponds to a lup2down FSC operational mode for use in relatively higher levels of ambient light illumination. In some implementations, for example, the region 3020 may extend from an ambient light illumination in the range of 50-500 lux (at the boundary 3017) to an ambient light illumination in the range of approximately 400-600 lux (at the boundary 3022). Accordingly, FSC operational modes may be implemented if the ambient light intensity is below a first threshold. In this example, the first threshold corresponds to the boundary 3022.

The regions 3025 and 3030 correspond to non-FSC operational modes for use under relatively higher levels of ambient light illumination. The region 3035 corresponds to a relatively higher level of ambient light illumination, wherein the front light is switched off. Accordingly, when the ambient light intensity is above the first threshold (in this example, the boundary 3022) but below a second threshold (in this example, the boundary 3032), non-FSC operational modes that involve operating a front light may be implemented. In some implementations, for example, the region 3025 may extend from approximately 400-600 lux (at the boundary 3022) to approximately 800-900 lux (at the boundary 3027), whereas the region 3030 may extend from the boundary 3027 to approximately 1000 lux at the boundary 3032. In this example, the region 3025 corresponds to an operational mode wherein red, green and blue light sources of a front light are used to illuminate a reflective display, whereas the region 3030 corresponds to an operational mode wherein the front light illuminates the reflective display with one or more white light sources. In both operational modes, the light sources of the front light may be switched on in a substantially continuous manner instead of being flashed on and off. In some other implementations, only three modes (e.g., FSC-monochrome, RGB (non-FSC) and FL OFF) with two typical approximate thresholds (e.g., 600 lux and 1000 lux) may be used. In such implementations, the five modes shown in FIG. 30 may be effectively collapsed into three modes.

It will be appreciated by a person of ordinary skill in the art that other implementations described herein may involve other FSC and/or non-FSC operational modes. The ambient light intensity levels corresponding to such operational modes may differ from those shown in FIG. 30. Moreover, other implementations provided herein may involve other criteria for determining when to change from one operational mode to another. Some such implementations will be described in more detail below.

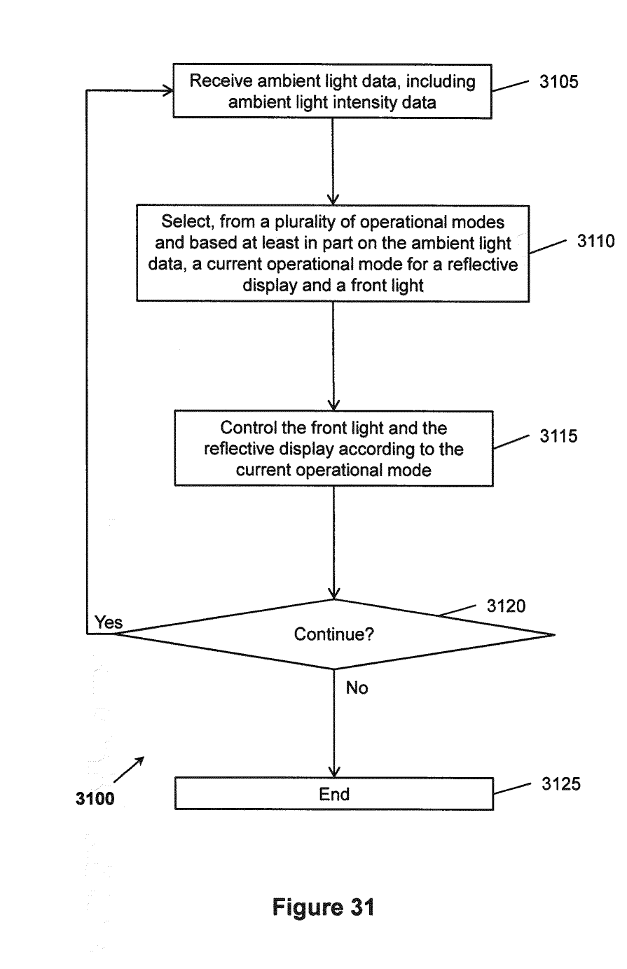

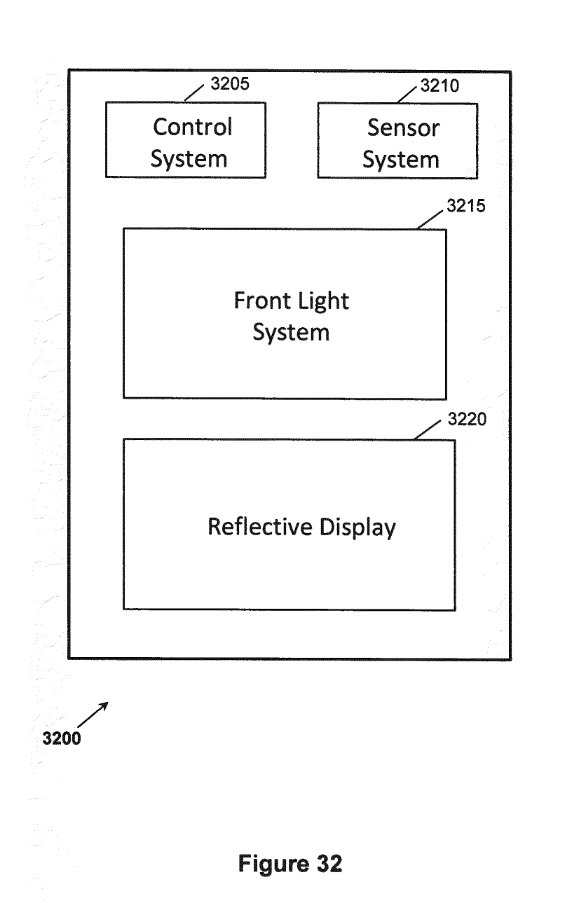

FIG. 31 is a flow diagram illustrating a method of selecting an operational mode for a reflective display device. FIG. 32 is a system block diagram illustrating components of a reflective display device. The method 3100 may be performed, at least in part, by a control system of a reflective display device, such as the control system 3205 of the reflective display device 3200 of FIG. 32, the processor 21 of the display device 40 of FIG. 34B, etc. However, the method 3100 will be described primarily with reference to FIGS. 31 and 32.

In this example, the method 3100 begins with block 3105, in which ambient light data are received. Referring to FIG. 32, in block 3105 the control system 3205 may receive ambient light data from an ambient light sensor of the sensor system 3210. Here, the ambient light data include ambient light intensity data. However, in some implementations, the ambient light data may include ambient light spectrum data, ambient light direction data and/or ambient light temporal frequency data. Examples of how such data may be used are provided below.

Block 3110 of FIG. 31 involves selecting a current operational mode, based at least in part on the ambient light data, for a reflective display and a front light. In block 3115, the front light and the reflective display are controlled according to the current operational mode selected in block 3110.

For example, block 3110 may involve selecting a current operational mode for the reflective display 3220 and the front light system 3215 of FIG. 32. Block 3110 may involve selecting the current operational mode from a plurality of operational modes that include at least one FSC operational mode. The FSC operational mode(s) may be one or more modes described elsewhere herein, such as a black and white FSC operational mode, a grayscale FSC operational mode, a lup2down FSC operational mode, etc.

Block 3110 may involve selecting the current operational mode based, at least in part, upon whether the ambient light data indicates an ambient light intensity level that is at or below a first threshold. If so, block 3110 may involve selecting an FSC operational mode. If not, block 3110 may involve selecting a non-FSC operational mode.

For example, referring to FIG. 30, block 3110 may involve selecting a non-FSC operational mode if the ambient light data indicate an ambient light intensity level that is above that of the region 3020. If the ambient light data indicate an ambient light intensity level that is in the region 3025, for example, block 3110 may involve selecting a non-FSC operational mode in which some or all colored light sources of the front light are continuously on in block 3115. The colored light sources may be red, green and blue light sources, such as red, green and blue LEDs. However, the colored light sources may be configured to produce other colors, such as yellow, cyan, magenta, etc.

If the ambient light data indicate an ambient light intensity level that is in the region 3030, block 3110 may involve selecting a non-FSC operational mode in which one or more substantially white light sources of the front light are continuously on in block 3115. If the ambient light data indicate an ambient light intensity level that is above the region 3030, block 3110 may involve selecting a non-FSC operational mode in which the front light is switched off in block 3115.

However, other FSC and non-FSC operational modes may be among the operational modes available for selection. For example, block 3110 may involve selecting a 2up1down FSC operational mode, in which only one out of three subpixel colors are driven to black at any one time. In one 2up1down FSC implementation, data may be written corresponding to a combined primary for the colors that are written. For example, if red and green were written and blue was kept off (black), then data would be written at that point calculated for a yellow primary. This would happen for other two combinations as well, e.g., for cyan and magenta. Such 2up1down FSC implementations can produce a brighter display than lup2down FSC implementations, but with relatively more limited gamut.

The operational modes may include an “interlace” operational mode, in which image data are rendered in an interlaced format. Relevant examples are disclosed in United States Patent Publication No. 2006/0066504, which is hereby incorporated by reference. Alternatively, or additionally, the operational modes may include an operational mode for producing line multiplied images, wherein the line multiplying is shifted for one of the colors of the display with respect to at least one other color of the display. Some such operational modes involve green offset line doubling. Relevant examples are disclosed in United States Patent Publication No. 2012/0098847, which is hereby incorporated by reference.

As noted above, the ambient light data may include data other than intensity data. In some implementations, the ambient light data may include ambient light temporal frequency data. For example, desk lamps with light emitting diodes (LEDs) are typically driven according to pulse width modulation methods. Accordingly, the LEDs flash on and off rapidly. The LEDs are generally flashing on and off too quickly for a person to perceive this effect. However, when a reflective display is being controlled according to some FSC operational modes at a time that the reflective display is being exposed to such flashing room lighting LEDs, a stroboscopic effect may be produced that is readily apparent to a human observer. Accordingly, if the ambient light data received in block 3105 include ambient light temporal frequency data that indicate flashing ambient light, block 3110 may involve selecting a non-FSC operational mode.

Some types of ambient light may produce a “white” light that includes a disproportionate amount of green, yellow, blue or some other color. Accordingly, in some implementations, the ambient light data received in block 3105 may include ambient light spectrum data. If the operational mode selected in block 3110 involves operating a front light, the spectrum of the front light may be adjusted to compensate for the ambient light spectrum. For example, if the ambient light spectrum data indicate that the ambient light includes a disproportionate amount of green light, the green light source(s) of the front light may be operated in block 3115 at a lower intensity level, in order to compensate for the ambient light spectrum.

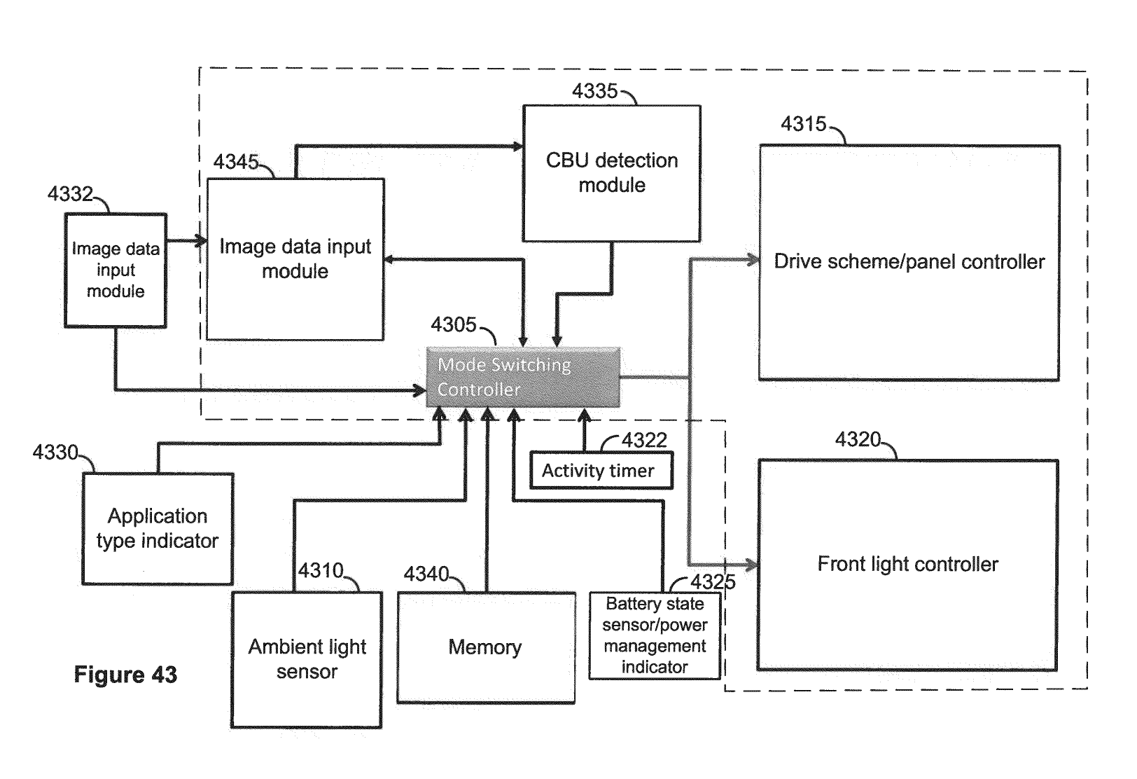

In block 3120, it is determined whether the method 3100 will continue. This determination may, for example, be made according to input from an activity timer, such as the activity timer 4322 of FIG. 43. If, for example, no user input has been received for a predetermined period of time, the method 3100 may end (block 3125). The reflective display device may, for example, enter a “sleep” mode. If it is determined in block 3120 that the method 3100 will continue, the process may revert to block 3105.

Referring again to FIG. 32, the reflective display 3220 may be one of a variety of reflective displays, including but not limited to IMOD displays. For example, the reflective display 3220 may be a cholesteric LCD display, a transflective LCD display, an electrofluidic display, an electrophoretic display or a display based on electro-wetting technology. In this example, the reflective display 3220 includes a first plurality of reflective sub-pixels having a first spectral reflectance range, a second plurality of reflective sub-pixels having a second spectral reflectance range and a third plurality of reflective sub-pixels having a third spectral reflectance range. Each of the first, second and third spectral reflectance ranges at least partially overlap the first range of spectral emissions and the second range of spectral emissions. In another example, the reflective display 3220 includes a plurality of reflective pixels or sub-pixels each having a substantially similar reflectance range.

In this implementation, the front light system 3215 includes light sources configured for producing at least the range of spectral emissions and the second range of spectral emissions. The front light system 3215 also may include light sources configured for producing other ranges of spectral emissions. For example, the front light system 3215 also may include light sources configured for producing a third range of spectral emissions, a fourth range of spectral emissions and/or additional ranges of spectral emissions. The front light system 3215 also may include one or more light sources configured for producing substantially white light.

The control system 3205 may, for example, include at least one of a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof. The control system 3205 may include one or more memory devices, such as random access memory (RAM), read-only memory (ROM), etc. Alternatively, or additionally, such memory devices (or other types of memory devices) may be included in other portions of the reflective display device 3200, in another device, etc., and may be accessible by the control system 3205 via a direct connection, a network interface, etc.

As noted above, the sensor system 3210 includes an ambient light sensor in this implementation. However, the sensor system 3210 also may include one or more other types of sensors. In some implementations, the sensor system 3210 includes a battery state sensor. The use of such other sensors will be described in more detail below.

The foregoing description has focused primarily on implementations involving bi-stable IMODs, which can be configured in only two positions, open or closed. A single image pixel will typically include three or more bi-stable IMODs, each of which corresponds to a subpixel. In a display device that includes multi-state interferometric modulators (MS-IMODs) or analog IMODs (A-IMODs), a pixel's reflective color may be determined by the gap spacing or “gap height” between an absorber stack and a mirror stack of a single IMOD. Some A-IMODs may be positioned in a substantially continuous manner between a large number of gap heights, whereas MS-IMODs generally may be positioned in a smaller number of gap heights. Because each mirror may correspond to a pixel in both types of devices, A-IMODs and MS-IMODs are treated herein as examples of the broader category of single-mirror IMODs (SM-IMODs). SM-IMODs can produce vivid, saturated colors under bright ambient light conditions.

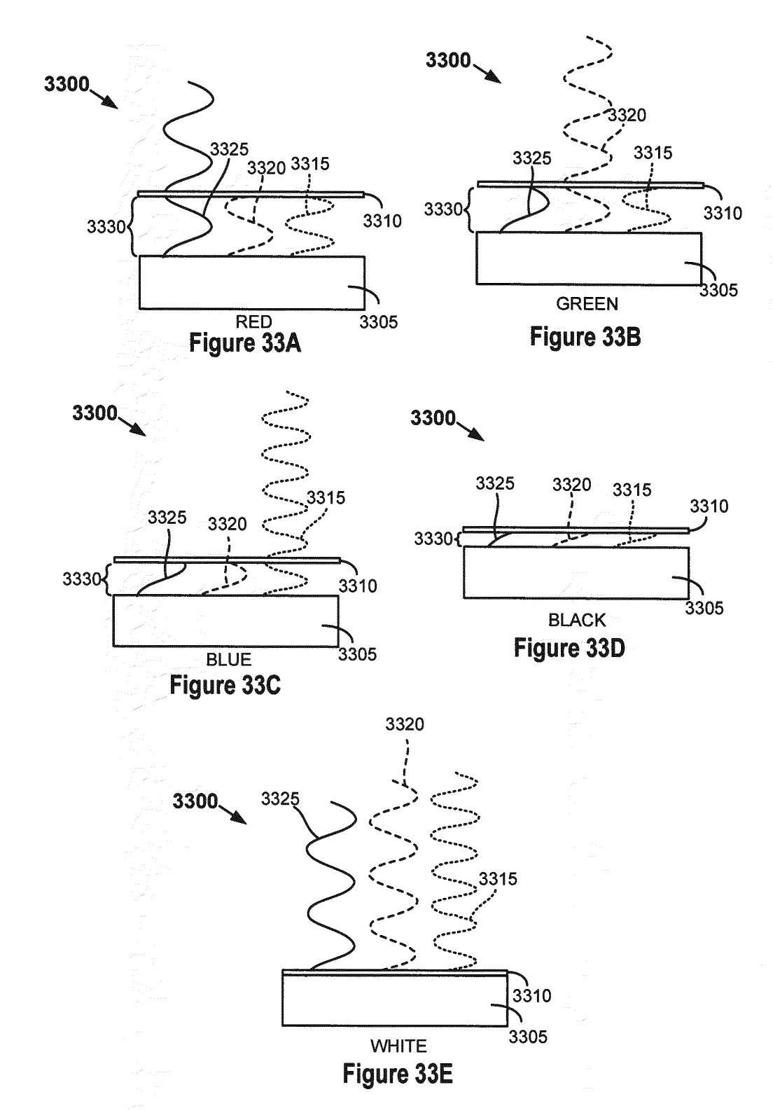

FIGS. 33A-33E show examples of how a single-mirror IMOD (SM-IMOD) may be configured to produce different colors. As noted above, multistate IMODs (MS-IMODs) and analog IMODs (A-IMODs) are both considered to be examples of the broader class of SM-IMODs.

In an SM-IMOD, a pixel's reflective color may be varied by changing the gap height between an absorber stack and a mirror stack. In FIGS. 33A-33E, the SM-IMOD 3300 includes the mirror stack 3305 and the absorber stack 3310. In this implementation, the absorber stack 3310 is partially reflective and partially absorptive. Here, the mirror stack 3305 includes at least one metallic reflective layer, which also may be referred to herein as a mirrored surface.

In some implementations, the absorber layer may be formed of a partially absorptive and partially reflective layer. The absorber layer may be part of an absorber stack that includes other layers, such as one or more dielectric layers, an electrode layer, etc. According to some such implementations, the absorber stack may include a dielectric layer, a metal layer and a passivation layer. In some implementations, the dielectric layer may be formed of silicon dioxide (SiO₂), silicon oxynitride (SiON), magnesium fluoride (MgF₂), aluminum oxide (Al₂O₃) and/or other dielectric materials. In some implementations, the metal layer may be formed of chromium (Cr), tungsten (W), nickel (Ni), vanadium (V), titanium (Ti), rhodium (Rh), platinum (Pt), germanium (Ge), cobalt (Co) and/or molychrome (MoCr, a molybdenum-chromium alloy). In some implementations, the passivation layer may include Al₂O₃ or another dielectric material.

The mirrored surface may, for example, be formed of a reflective metal such as aluminum (Al), silver (Ag), etc. The mirrored surface may be part of a reflector stack that includes other layers, such as one or more dielectric layers. Such dielectric layers may be formed of titanium oxide (TiO₂), silicon nitride (Si₃N₄), zirconium oxide (ZrO₂), tantalum pentoxide (Ta₂O₅), antimony trioxide (Sb₂O₃), hafnium(IV) oxide (HfO₂), scandium(III) oxide (Sc₂O₃), indium(III) oxide (In₂O₃), tin-doped indium(III) oxide (Sn:In₂O₃), SiO₂, SiON, MgF₂, Al₂O₃, hafnium fluoride (HfF₄), ytterbium(III) fluoride (YbF₃), cryolite (Na₃AlF₆) and/or other dielectric materials.

In FIGS. 33A-33E, the mirror stack 3305 is shown at five positions relative to the absorber stack 3310. However, an SM-IMOD 3300 may be movable between substantially more than 5 positions relative to the mirror stack 3305. For example, some MS-IMODs may be positioned in 8 or more gap heights 3330, 10 or more gap heights 3330, 16 or more gap heights 3330, 20 or more gap heights 3330, 32 or more gap heights 3330, etc. Some SM-IMODs also may be configured in gap heights 3330 that correspond to other colors, such as yellow, orange, violet, cyan and/or magenta. In some A-IMOD implementations, the gap height 3330 between the mirror stack 3305 and the absorber stack 3310 may be varied in a substantially continuous manner. In some such SM-IMODs 3300, the gap height 3330 may be controlled with a high level of precision, e.g., with an error of 10 nm or less. Although the absorber stack 3310 includes a single absorber layer in this example, alternative implementations of the absorber stack 3310 may include multiple absorber layers. Moreover, in alternative implementations, the absorber stack 3310 may not be partially reflective.

An incident wave having a wavelength λ will interfere with its own reflection from the mirror stack 3305 to create a standing wave with local peaks and nulls. The first null is λ/2 from the mirror and subsequent nulls are located at λ/2 intervals. For that wavelength, a thin absorber layer placed at one of the null positions will absorb very little energy.

Referring first to FIG. 33A, when the gap height 3330 is substantially equal to the half wavelength of a red color 3325, the absorber stack 3310 is positioned at the null of the red standing wave interference pattern. The absorption to the red wavelength is near zero because there is almost no red light at the absorber. At this configuration, constructive interference appears between red light reflected from the absorber stack 3310 and red light reflected from the mirror stack 3305. Therefore, light having a wavelength substantially corresponding to the red color 3325 is reflected efficiently. Light of other colors, including the blue color 3315 and the green color 3320, has a high intensity field at the absorber and is not reinforced by constructive interference. Instead, such light is substantially absorbed by the absorber stack 3310.

FIG. 33B depicts the SM-IMOD 3300 in a configuration wherein the mirror stack 3305 is moved closer to the absorber stack 3310 (or vice versa). In this example, the gap height 3330 is substantially equal to the half wavelength of the green color 3320. The absorber stack 3310 is positioned at the null of the green standing wave interference pattern. The absorption to the green wavelength is near zero because there is almost no green light at the absorber. At this configuration, constructive interference appears between green light reflected from the absorber stack 3310 and green light reflected from the mirror stack 3305. Light having a wavelength substantially corresponding to the green color 3320 is reflected efficiently. Light of other colors, including the red color 3325 and the blue color 3315, is substantially absorbed by the absorber stack 3310.

In FIG. 33C, the mirror stack 3305 is moved closer to the absorber stack 3310 (or vice versa), so that the gap height 3330 is substantially equal to the half wavelength of the blue color 3315. Light having a wavelength substantially corresponding to the blue color 3315 is reflected efficiently. Light of other colors, including the red color 3325 and the green color 3320, is substantially absorbed by the absorber stack 3310.

In FIG. 33D, however, the SM-IMOD 3300 is in a configuration wherein the gap height 3330 is substantially equal to ¼ of the wavelength of the average color in the visible range. In such arrangement, the absorber is located near the intensity peak of the interference standing wave; the strong absorption due to high field intensity together with destructive interference between the absorber stack 3310 and the mirror stack 3305 causes relatively little visible light to be reflected from the SM-IMOD 3300. This configuration may be referred to herein as a “black state.” In some such implementations, the gap height 3330 may be made larger or smaller than shown in FIG. 33D, in order to reinforce other wavelengths that are outside the visible range. Accordingly, the configuration of the SM-IMOD 3300 shown in FIG. 33D provides merely one example of a black state configuration of the SM-IMOD 3300.

FIG. 33E depicts the SM-IMOD 3300 in a configuration wherein the absorber stack 3310 is substantially adjacent to the mirror stack 3305. In this example, the gap height 3330 is negligible. Light having a broad range of wavelengths is reflected efficiently from the mirror stack 3305 without being absorbed to a significant degree by the absorber stack 3310. This configuration may be referred to herein as a “white state.” However, the absorber stack 3310 and the mirror stack 3305 should be separated to reduce stiction caused by charging via the strong electric field that may be produced when the two layers are brought close to one another. In some implementations, one or more dielectric layers with a total thickness of about λ/2 may be disposed on the surface of the absorber stack 3310 and/or the mirror stack 3305. As such, the white state is when the absorber is placed at the first null of the standing wave away from a reflective metal layer in the mirror stack 3305.

Some examples of applying FSC techniques to SM-IMODs will now be described with reference to FIGS. 34-37. FIG. 34 is a system block diagram illustrating a display device including an IMOD array, a front light and a logic system. In this example, the display device 3400 includes a logic system 3405, a front light 3410 and an IMOD array 3415.

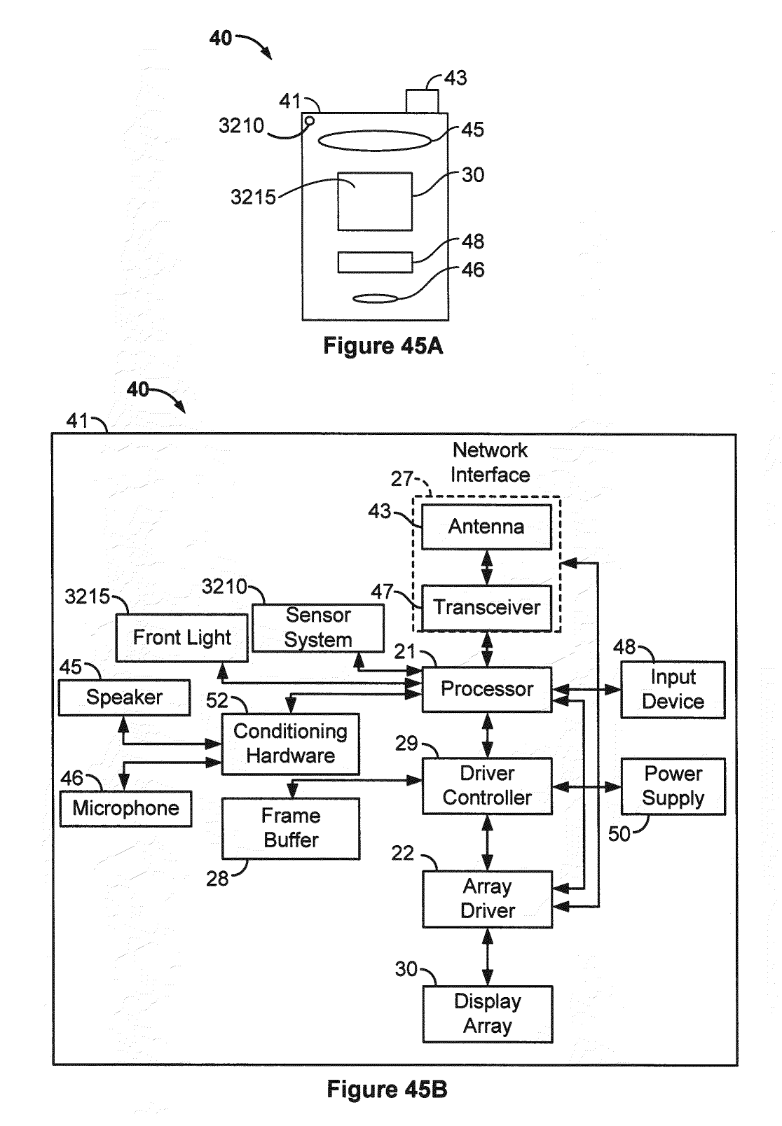

The logic system 3405 may, for example, include at least one of a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof. According to some implementations, the logic system 3405 may include the processor 21, the driver controller 29, the array driver and/or other elements that are shown in FIG. 45B and are described below. The logic system 3405 may be configured to control the front light 3410 and the IMOD array 3415 to operate in at least one FSC mode. The logic system 3405 may be configured to control the front light 3410 and the IMOD array 3415 to transition between operation in an FSC mode and operation in a non-FSC mode.

For example, in some implementations the logic system 3405 may be configured to control the front light 3410 and the IMOD array 3415 to make such transitions according to input from an ambient light sensor, a user input system, etc., such as shown in FIG. 11B and described below. According to some such implementations, the logic system 3405 may be configured to determine an operational mode for the display device 3400 based, at least in part, on ambient light data from the ambient light sensor. The logic system 3405 may be configured to control the front light 3410 and the IMOD array 3415 to transition smoothly from operation in an FSC mode to operation in a non-FSC mode when the ambient light sensor indicates that the ambient light intensity level has increased beyond a predetermined threshold. As compared to some previously developed FSC implementations for bi-stable IMODs, the transition from an FSC mode to operation in a non-FSC mode (or vice versa) may be performed relatively more smoothly. In a bi-stable IMOD display, red, green and blue stripes may be configured to run parallel to scan lines of the display. One issue that may prevent a smooth transition is that in some FSC modes for bi-stable IMOD implementations, when red data are written to the display, green and blue are driven dark. Accordingly, green and blue channels are not written with any content data in such implementations, but such content data would be written when the bi-stable IMOD display is used under bright ambient light. At least one non-FSC mode may, for example, involve leaving one or more light sources of the front light 3410 continuously on. Another non-FSC mode may involve switching off the front light 3410.

In some implementations, the front light 3410 may at least partially overlie the IMOD array 3415. The front light 3410 may include a substantially transparent wave guide and light-extracting elements such as prisms, dots, etc., that are configured to illuminate the IMOD array 3415 with light sources of various colors. For example, the front light 3410 may include light sources corresponding to at least a first color and a second color. The front light 3410 also may include light sources corresponding to a third color, a fourth color and/or other colors. In some implementations, the front light 3410 may include light sources for blue, green and red colors. Alternatively, or additionally, the front light 3410 may include light sources for other colors, such as yellow, yellow-orange, yellow-green, violet, cyan, white and/or magenta.

The IMOD array 3415 may include a plurality of SM-IMODs. As used herein, analog IMODs are considered to be one type of SM-IMODs. Accordingly, the IMOD array 3415 may include a plurality of analog IMODs. Each of the IMODs may have an absorber layer and a mirrored surface. The IMODs may be configured to define a gap height in between the absorber layer and a mirrored surface. As described above with reference to FIGS. 33A-33E, a gap height may correspond to a wavelength range of light that emerges from the IMOD after being reflected by the mirrored surface and partially absorbed by the absorber layer.

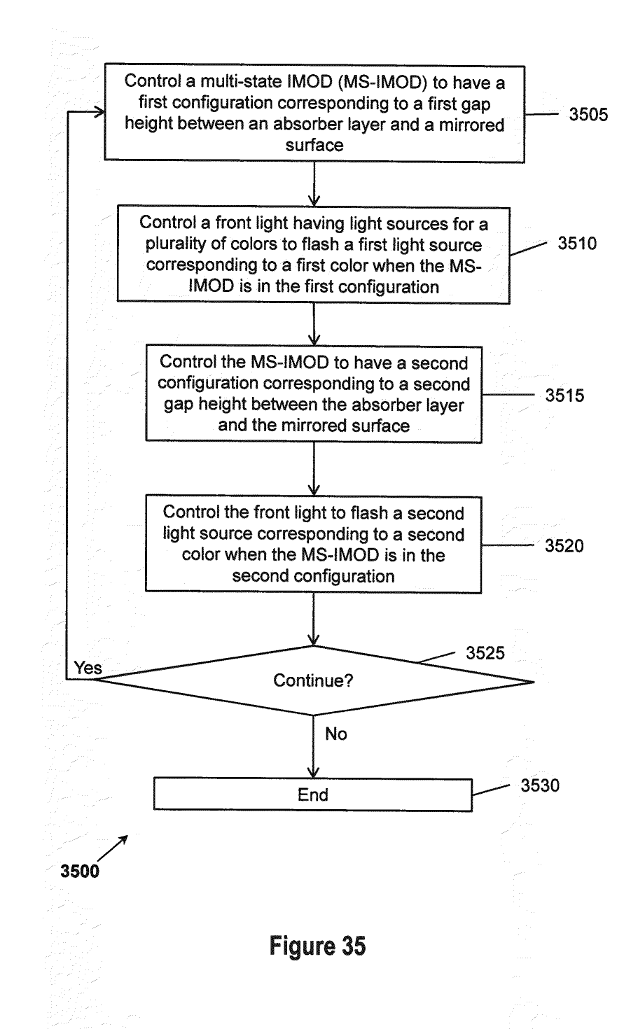

FIG. 35 is a flow diagram illustrating a process for operating an IMOD display element and a front light. For example, the method 3500 may be performed by the logic system 3405 of FIG. 34, for controlling the front light 3410 and an IMOD element of the IMOD array 3415. In some implementations, the method 3500 may involve controlling the front light and the SM-IMOD to operate in an FSC mode. The FSC mode may, in some implementations, be a grayscale FSC mode.

In this example, the method 3500 begins by controlling an SM-IMOD to have a first configuration corresponding to a first gap height between an absorber layer and a mirrored surface (block 3505). As noted elsewhere herein, in some implementations the SM-IMOD may be an analog IMOD. The gap height may correspond to a reflectivity of the IMOD for a particular wavelength of incident light.

In this implementation, block 3510 involves controlling a front light to flash a first light source corresponding to a first color when the SM-IMOD is in the first configuration. In this example, the front light has light sources for a plurality of colors, like the front light 3410.

In this example, block 3515 involves controlling the SM-IMOD to have a second configuration corresponding to a second gap height between the absorber layer and the mirrored surface. While the SM-IMOD is in the second configuration, the front light may be controlled to flash a second light source corresponding to a second color (block 3520).

In the example shown in FIG. 35, it is determined in block 3525 whether the method 3500 will continue. If so, the method 3500 may revert to block 3505. If the method 3500 will not continue, the process may end (block 3530).

In some implementations, the block 3525 may involve determining whether to continue operating the display device, e.g., according to input from a user. Alternatively, or additionally, the block 3525 may involve determining whether to change the operational mode of the display device, e.g., according to input from an ambient light sensor as describe above.

Alternatively, or additionally, the block 3525 may involve determining whether an image data frame is complete. In this example, the image data frame is complete after two light source colors have been flashed during times when the SM-IMOD was in two configurations.

However, in alternative implementations, a data frame will not be complete until three or more light source colors have been flashed during times when the SM-IMOD was in three or more configurations. For example, alternative methods may involve controlling the SM-IMOD to have a third configuration corresponding to a third gap height between the absorber layer and the mirrored surface and controlling the front light to flash a third light source corresponding to a third color when the SM-IMOD is in the third configuration. The block 3525 may involve determining whether an image data frame is complete. For example, the image data frame may be complete after three light source colors have been flashed during times when the SM-IMOD was in three configurations.

However, alternative implementations may involve controlling the SM-IMOD to have a fourth configuration corresponding to a fourth gap height between the absorber layer and the mirrored surface and controlling the front light to flash a fourth light source corresponding to a fourth color when the SM-IMOD is in the fourth configuration. It may be determined in block 3525 that the image data frame may be complete after four light source colors have been flashed during times when the SM-IMOD was in four configurations.

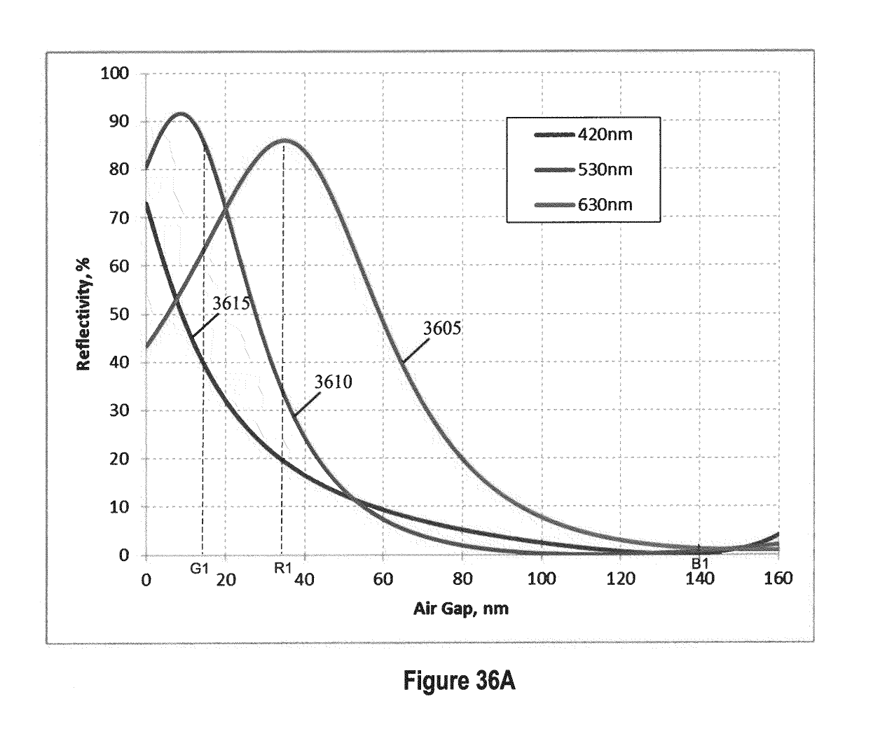

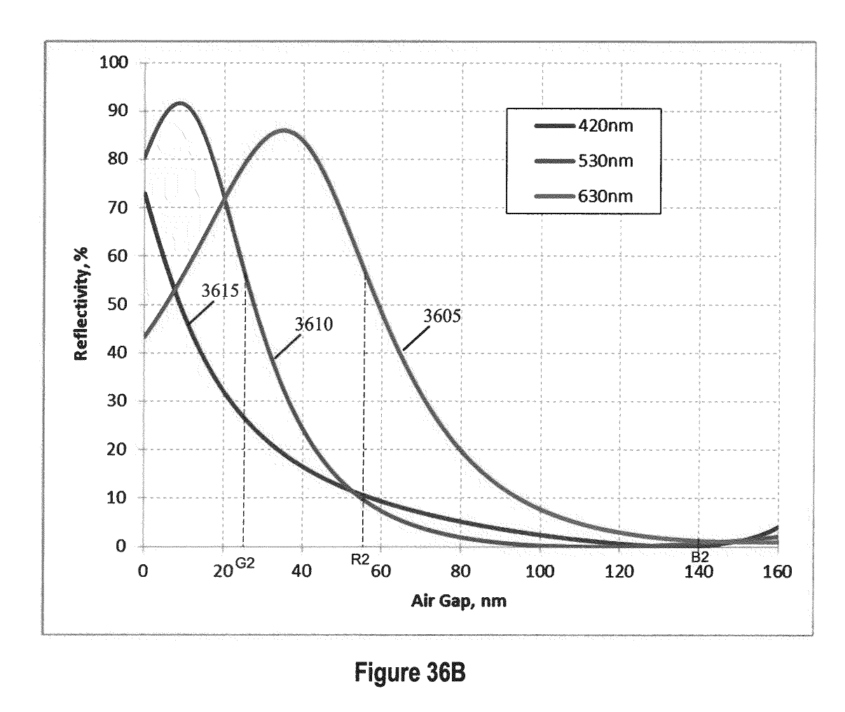

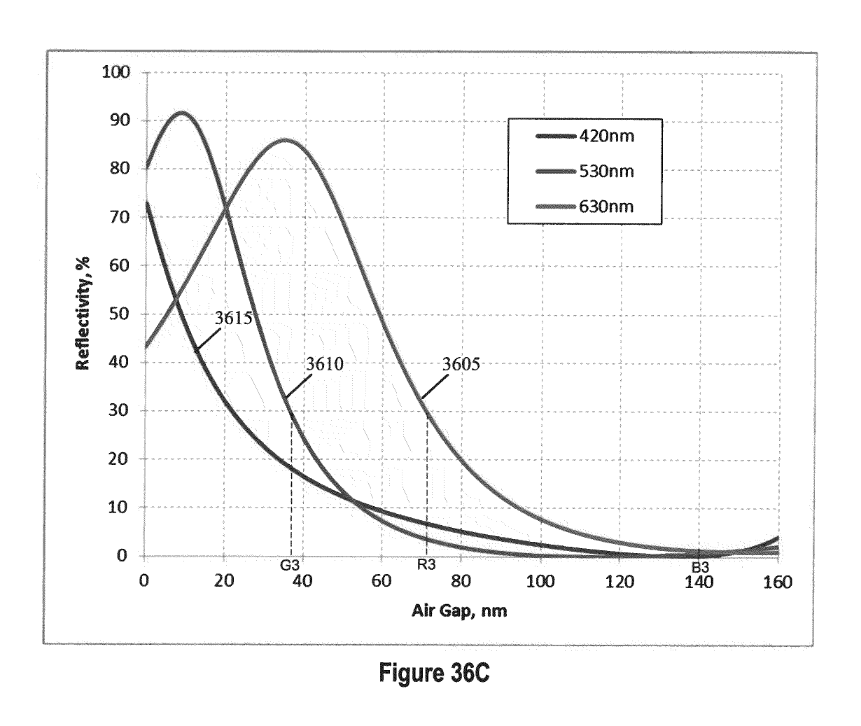

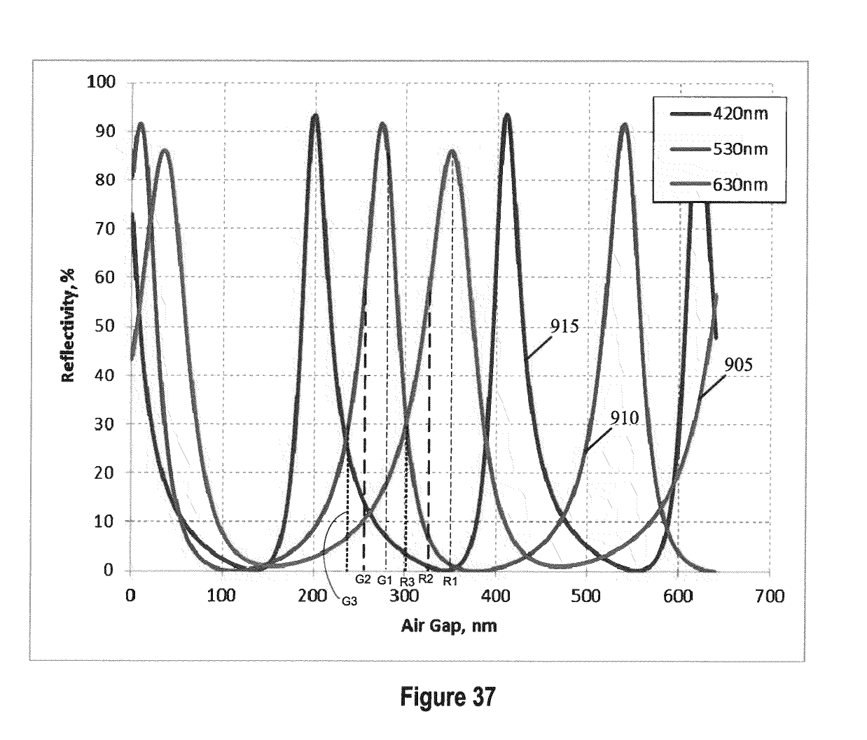

The gap heights may also vary according to the implementation. For example, in some implementations, the gap heights may be less than or equal to a gap height that corresponds with a black state of the SM-IMOD. Some such implementations, including some grayscale FSC implementations, are described below with reference to FIGS. 36A-36C. Alternatively, or additionally, in some implementations the gap heights may be greater than or equal to a gap height that corresponds with the black state of the SM-IMOD. Some such implementations are described below with reference to FIG. 37.

Some implementations for controlling SM-IMODs according to FSC techniques will now be described with reference to FIGS. 36A-36C. In FIGS. 36A-37, the standing wave interference pattern for 630 nm (red) is represented by the curve 3605, the standing wave interference pattern for 530 nm (green) is represented by the curve 3610 and the standing wave interference pattern for 420 nm (blue) is represented by the curve 3615.

FIGS. 36A-36C show an example of a spectral response of an SM-IMOD with mirror/absorber gaps in the range of zero to about 160 nm. For example, FIG. 36A shows a range of gaps that include a white state (corresponding to a gap height of approximately 8-10 nm) similar to that shown in FIG. 33E and a black state (corresponding to a gap height of approximately 140 nm) similar to that shown in FIG. 33D. In this example, the white state is not a pure white. The whitest state is produced near the green peak, at gaps near 10 nm, so the white state will have a greenish hue. The first-order red peak shown at approximately 34 nm in FIG. 36A corresponds with the red state shown in FIG. 6A, whereas the first-order green peak shown at approximately 9 nm in FIG. 36A corresponds with the green state shown in FIG. 6B.

FIG. 36A shows an example of how an SM-IMOD could be controlled to produce a particular shade of yellow when operated in an FSC mode. A wide range of colors may be produced in a similar manner.

Here, the yellow color has substantially equal amounts of red and green. The brightest yellow will be produced by configuring the SM-IMOD with a gap height G1 when the SM-IMOD is being illuminated with a green light and by configuring the SM-IMOD with a gap height R1 when the SM-IMOD is being illuminated with a red light. In this example, no blue component is desired, so the SM-IMOD is configured with a gap height B1 when the SM-IMOD is being illuminated with a blue light. B1 corresponds to a gap height at which the SM-IMOD will reflect little or no blue light.

In some implementations, a color may not be flashed if that color will not contribute significantly to the combined color. For example, in the situation depicted in FIG. 36A, the blue light may not be flashed. Instead, the SM-IMOD may be configured with the gap height G1 for half a data frame, during which time the green light may be illuminated. The SM-IMOD may be configured with the gap height R1 for the other half of the data frame, during which time the red light may be illuminated.

Using similar principles, some FSC operational modes also may produce a more pure (less green) white state. According to some such implementations, the SM-IMOD may be configured with a gap height of less than 5 nm (e.g., 2 or 3 nm) when the blue light is flashed, yielding a blue reflectivity of approximately 70%. In order to substantially match this reflectivity, the gap height may be slightly less than 20 nm when the red light is flashed and slightly greater than 20 nm when the green light is flashed.

Some grayscale FSC examples will now be discussed with reference to FIGS. 36B and 36C. FIG. 36B shows examples of SM-IMOD gaps for producing substantially the same shade of yellow as described above with reference to FIG. 36A, but with reduced brightness. A yellow that is approximately ⅔ as bright can be produced by configuring the SM-IMOD with a gap height G2 when the SM-IMOD is being illuminated with a green light and by configuring the SM-IMOD with a gap height R2 when the SM-IMOD is being illuminated with a red light. In this example, the SM-IMOD is configured with a gap height B2 when the SM-IMOD is being illuminated with a blue light. B2 is substantially the same as B1.

FIG. 36C shows examples of SM-IMOD gaps for producing substantially the same shade of yellow as described with reference to FIG. 36A, but a yellow that is about ⅓ as bright. Here, the SM-IMOD is configured with a gap height G3 when the SM-IMOD is being illuminated with a green light and with a gap height R3 when the SM-IMOD is being illuminated with a red light. In this example, the SM-IMOD is configured with a gap height B3, which is substantially the same as B1, when the SM-IMOD is being illuminated with a blue light.

In some grayscale FSC implementations, grayscale levels may be obtained by varying the gap height between the black state and second-order color peaks. FIG. 37 shows an example of a spectral response of an SM-IMOD with mirror/absorber gaps in the range of zero to about 700 nm.

Here, as above, a yellow color that has substantially equal amounts of red and green is being produced by the SM-IMOD. The brightest yellow will be produced by configuring the SM-IMOD with a gap height G1 when the SM-IMOD is being illuminated with a green light, by configuring the SM-IMOD with a gap height R1 when the SM-IMOD is being illuminated with a red light and by configuring the SM-IMOD with a gap height B1 when the SM-IMOD is being illuminated with a blue light.

A yellow that is substantially the same shade but about ⅔ as bright can be produced by configuring the SM-IMOD with a gap height G2 when the SM-IMOD is being illuminated with a green light and with a gap height R2 when the SM-IMOD is being illuminated with a red light. In this example, the SM-IMOD is configured with a gap height B2 when the SM-IMOD is being illuminated with a blue light. B2 is substantially the same as B1.

In order to produce substantially the same shade of yellow, but about ⅓ as bright, the SM-IMOD may be configured with a gap height G3 when the SM-IMOD is being illuminated with a green light and with a gap height R3 when the SM-IMOD is being illuminated with a red light. In this example, the SM-IMOD is configured with a gap height B3, which is substantially the same as B1, when the SM-IMOD is being illuminated with a blue light.

In the foregoing examples, three different grayscale levels were produced. However, in alternative examples, more or fewer grayscale levels may be produced.

As noted above, in some alternative implementations a color may not be flashed if that color will not contribute significantly to the combined color. For example, in the situations depicted in FIGS. 36B, 36C and 37, the blue light may not be flashed. According to some such implementations, the SM-IMOD may be configured with the gap height G1, G2 or G3 for half a data frame, during which time the green light may be illuminated, and the SM-IMOD may be configured with the gap height R1, R2 or R3 for the other half of the data frame, during which time the red light may be illuminated.

Color breakup (which may be referred to herein as “CBU”) is a perceptual phenomenon that is associated with FSC methods. CBU may be caused by relative motion between a viewer's eye and a display that is being operated according to an FSC method. CBU may occur when the different color components of image data frames do not coincide in space. This may happen, for example, the display is in a first location relative to the eye when a red light source flashes, a second location relative to the eye when a green light source flashes, etc. Due to CBU, a viewer may see colored fringes around a displayed object.

Including white light (e.g., from a white LED) with the colors flashed during an FSC operational mode can alleviate CBU. Including white light has the effect of bringing colors closer together in color space, even though the colors may be spatially dispersed on the retina.

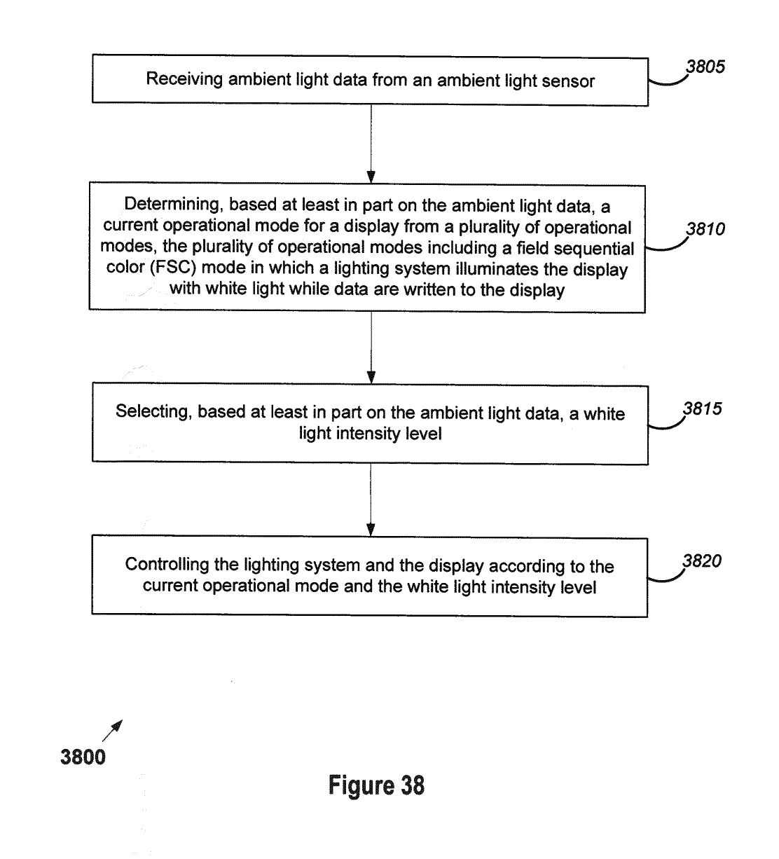

FIG. 38 is a flow diagram that outlines one example of a method for alleviating color breakup. Method 3800 may be performed, at least in part, by a control system of a display device, such as the control system 3205 of the reflective display device 3200 illustrated in FIG. 32.

In block 3805, ambient light data are received from an ambient light sensor. The ambient light sensor may, for example, be part of the sensor system 3210 of the reflective display device 3200. The ambient light data may include ambient light intensity data.

Block 3810 involves determining, based at least in part on the ambient light data, a current operational mode for a display. The display may, for example, be a reflective display such as the reflective display 3220 illustrated in FIG. 32. Accordingly, the determining process of block 3810 may be performed by a control system such as the control system 3205. In this implementation, block 3810 involves selecting the current operational mode from a plurality of operational modes, at least one of which is an FSC mode in which a lighting system illuminates the display with white light while data are written to the display. In some implementations, block 3810 may involve selecting an FSC operational mode if the ambient light data indicates an ambient light intensity level that is below a first threshold. Block 3810 may involve selecting a non-FSC operational mode if the ambient light data indicates a second ambient light intensity level that is at or above the first threshold. Examples of some such thresholds and FSC operational modes are described above, and additional examples are provided below.

Block 3815 involves selecting, based at least in part on the ambient light data, a white light intensity level. For example, block 3815 may involve selecting a white light intensity level for a lighting system of a display device. The lighting system may be configured for producing light of three or more colors and may include a source of substantially white light. The lighting system may, for example, be a front light system such as the front light system 3215 of the reflective display device 3200. For example, block 3815 may involve selecting, by the control system 3205, a white light intensity level for the front light system 3215 that will be used to illuminate the reflective display 3220.

In some implementations, the control system 3205 may be configured to determine a ratio of white light intensity to an overall display illumination intensity. The overall display illumination intensity may include front light illumination intensity and ambient light illumination intensity. For example, based on the ambient light intensity data received in block 3805, block 3815 may involve selecting the white light intensity level to maintain the ratio of white light intensity to an overall display illumination intensity.

In some implementations, block 3815 may involve selecting a white light intensity in order to maintain a substantially constant brightness from the front light system. For example, based on the ambient light intensity data received in block 3805, a ratio of white light intensity to front light illumination intensity may be determined. Block 3815 may involve varying the white light intensity level in order to maintain the ratio of white light intensity to front light illumination intensity. Block 3820 involves controlling the lighting system and the display according to the current operational mode and the white light intensity level. Some examples are provided below.

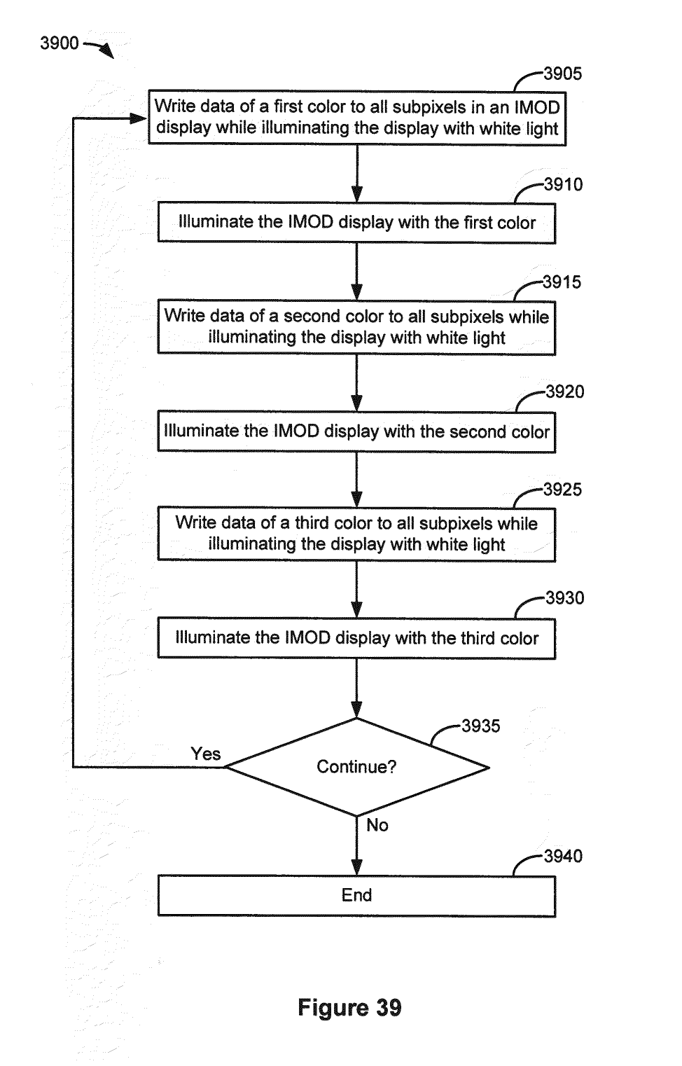

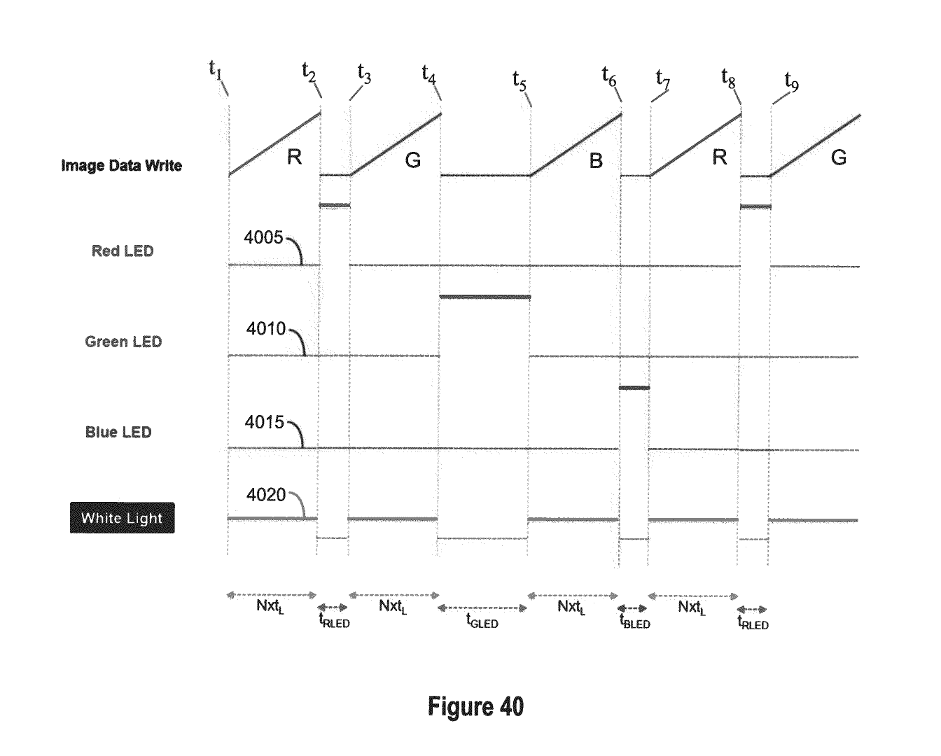

FIG. 39 is a flow diagram that shows an example of an FSC operational mode in which a lighting system illuminates a display with white light while data are written to the display. FIG. 39 will be described with reference to FIG. 40 and the reflective display device 3200 illustrated in FIG. 32.

FIG. 40 is a diagram that indicates how data may be written to a display and how a front light may be controlled according to one example of the FSC operational mode outlined in FIG. 39. The details of FIG. 40, including but not limited to the illumination color sequence and the illumination times, are merely examples. Other implementations may involve other pixel or subpixel colors, other illumination color sequences, other illumination times, etc. Similarly, whereas in this example the reflective display 3220 includes bi-stable IMODs and the FSC operational mode is a black and white FSC operational mode, the principles underlying this example may be applied in other FSC contexts, such as the FSC methods for SM-IMODs discussed above. For example, a black and white FSC operational mode may be implemented in SM-IMODs by configuring the SM-IMODs in either a black state or a white state when the front light system 3215 illuminates the display with colored light. The SM-IMODs could be illuminated with white light while data are being written to the SM-IMODs, e.g., during blocks 3205 and 3535 of FIG. 35.

The method 3900 begins with block 3905, in which data of a first color is written to all subpixels in an IMOD display while illuminating the display with white light. Here, the front light system 3215 may be configured for producing light of three or more colors. In this example, the front light system 3215 includes red, green and blue LEDs, and a source of substantially white light. In some implementations, the source of substantially white light may be white LEDs, whereas in other implementations the source of substantially white light may be red, green and blue LEDs operated simultaneously. Other colors and/or types of light sources may be used in other implementations. In some implementations, block 3905 may involve writing data of the first color to substantially all, but not all, subpixels in an IMOD display. For example, in some implementations, data may not be written to “dummy” subpixels in a border area of a display in block 3905, block 3915 or block 3925.

Accordingly, in the example shown in FIG. 40, beginning at time t₁, the control system 3205 causes red data of a frame of image data to be written to red subpixels, to green subpixels and to blue subpixels in the reflective display 3220. The time for addressing the subpixel rows, from time t₁ until time t₂, may be on the order of a few milliseconds (ms), e.g., between 1 and 10 ms. During this time, the control system 3205 controls the front light system 3215 to illuminate the reflective display 3220 with white light 4020.

In block 3910 of FIG. 39, the IMOD display is illuminated with light of the first color. In the example shown in FIG. 40, the array of red, green and blue subpixels is illuminated with red light 4005 after all subpixels in the array have been addressed and written with red data of the frame of image data, from time t₂ until time t₃. The red illumination time may, for example, be on the order of 1 or more ms.

In block 3915 of FIG. 39, data of a second color is written to all subpixels in the IMOD display while illuminating the display with white light. In the example shown in FIG. 40, green data are written to the red subpixels, to the green subpixels and to the blue subpixels from time t₃ to time t₄. During this time, the display is illuminated with white light 4020. In block 3920 of FIG. 39, the IMOD display is illuminated with light of the second color. In the example shown in FIG. 40, the array of subpixels is illuminated with green light 4010 from time t₄ to time t₅.

In block 3925 of FIG. 39, data of a third color is written to all subpixels in the IMOD display while illuminating the display with white light. In the example shown in FIG. 40, blue data are written to all subpixels in the array, including the red and green subpixels, from time t₅ to time t₆. During this time, the display is illuminated with white light 4020. In block 3930 of FIG. 39, the IMOD display is illuminated with light of the third color. In the example shown in FIG. 40, the array of subpixels is illuminated with blue light 4015 from time t₆ to time t₇.

At this time, a frame of image data has been written to the subpixel array. In block 3935, it may then be determined (e.g., by the control system 3205 of FIG. 32) whether to change the operational mode of the display or whether to continue controlling the display in accordance with the black and white FSC method. The determination of whether to change the operational mode of the display may be made, for example, in response to a change in ambient light conditions, in response to user input and/or in response to other data or indications. In the example shown in FIG. 40, if another frame of data will be written in this black and white FSC operational mode, red data may be written to the display from time t₇ to time t₈, during which time the display may be illuminated with white light 4020. The array of subpixels may be illuminated with red light 4005 from time t₈ to time t₉.

By using an FSC operational mode such as that described above, one can mitigate the effects of color breakup. However, illuminating a display with white light has potential drawbacks. For example, illuminating a display with white light tends to de-saturate the colors produced by a display.

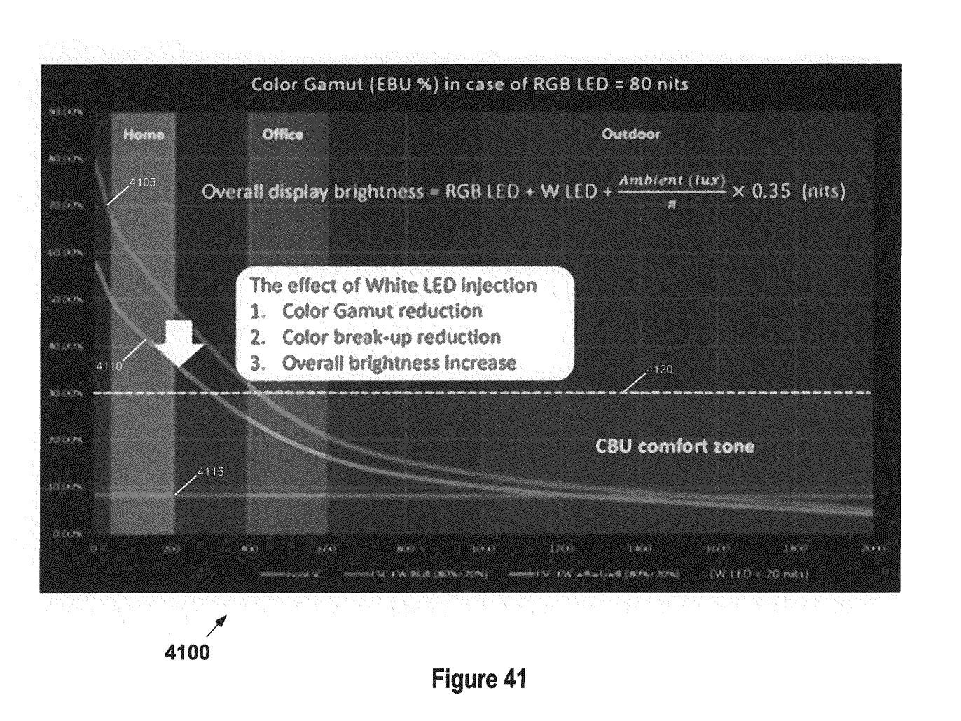

FIG. 41 is a graph that provides an example of the effects of illuminating a display with white light. In FIG. 41, the vertical axis represents color gamut and the horizontal axis represents ambient light intensity. The curve 4105 represents the color gamut provided by a display that is being controlled according to a black and white FSC operational mode under varying levels of ambient light intensity. In this FSC operational mode, no white light from the front light system is used for illumination.

The curve 4110 represents the color gamut provided by a display that is being controlled according to an FSC operational mode such as that described above with reference to FIGS. 38-40 under varying levels of ambient light intensity. In this example, the white light is provided by a white LED. Here, 80% of the light intensity of the front light is provided by the red, green and blue light sources (which are red, green and blue LEDs in this example) and 20% of the light intensity of the front light is provided by the white LED. The line 4115 represents the color gamut provided by a non-FSC operational mode under varying levels of ambient light intensity.

The “CBU comfort zone” was derived by performing human perception tests, comparing observers' subjective perceptions of CBU with a computed CBU score and mapping the results to color gamut space. Some examples of computing a CBU score are provided below. The threshold 4120 bounding the CBU comfort zone represents a transition between an annoying level of CBU (above the threshold 4120) and a perceptible, but not annoying level of CBU (below the threshold 4120). The position of the threshold 4120 may vary from person to person, according to subjective perceptions of CBU. In a lower portion of the CBU comfort zone (e.g., the bottom ⅓), CBU may be imperceptible to most observers. However, the extent to which CBU is perceptible to a particular person will vary according to that person's subjective perception.

As shown in FIG. 41, FSC methods can provide high color gamut when observed under conditions of dim ambient light, such as ambient light intensity levels typical for a home or office environment. However, the curves 4105 and 4110 show that as the ambient light intensity increases, the color gamut provided by these FSC methods decreases.

FIG. 41 also indicates the effects on color breakup and color gamut of including white light illumination during an FSC operational mode. By comparing the curve 4105 with the curve 4110, it may be seen that adding white light during the FSC operational mode mitigates the effects of CBU, but decreases color gamut. In this example, adding white light during the FSC operational mode increases overall display brightness by adding 20 nits provided by the white LED to the 80 nits provided by the red, green and blue LEDs.

Some implementations take into account the effects of white light on color gamut. Some such implementations take into account not only CBU effects, but also color gamut effects.

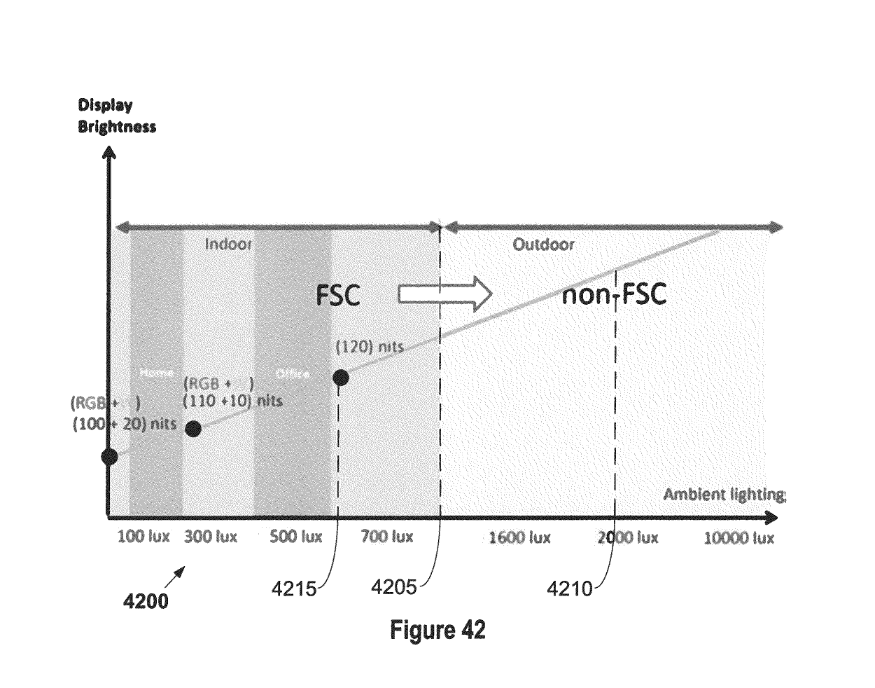

FIG. 42 is a graph that provides examples of switching between operational modes according to ambient light intensity. In this example, the graph 4200 indicates the ambient light thresholds 4205, 4210 and 4215. The graph 4200 also provides examples of light control values which will be described below. The ambient light intensity values associated with the ambient light thresholds 4205, 4210 and 4215, as well as the light control values, are merely examples.

The ambient light thresholds 4205, 4210 and 4215 and/or the light control values may, for example, be stored in a memory that is accessible by a control system of a display device. In some such implementations, the control system may be configured to select an FSC operational mode if the ambient light data received from an ambient light sensor indicates an ambient light intensity level that is below the threshold 4205. The control system may be configured to select a non-FSC operational mode if the ambient light data indicates an ambient light intensity level that is at or above the threshold 4205. In this example, an ambient light intensity that is at or above the threshold 4205 corresponds to typical outdoor lighting conditions. Here, the threshold 4205 is approximately 1000 lux, but in other examples the threshold 4205 may be at a higher or lower ambient light intensity level.

In this implementation, if the ambient light intensity level is at or above the threshold 4205 but below the threshold 4210, the control system may select a non-FSC operational mode involving substantially continuous front light operation. However, if the ambient light intensity level is at or above the threshold 4210, the control system may select a non-FSC operational mode in which the front light is turned off. In this example, the threshold 4210 is approximately 2000 lux, but in other examples the threshold 4210 may be at a higher or lower ambient light intensity level.

The range of ambient light intensities below the threshold 4205 may correspond with a range of FSC operational modes. As described above, such FSC operational modes may include black and white or “monochrome” FSC operational modes as well as lup2down FSC operational modes.

FIG. 42 provides examples of alternative FSC operational modes. In this example, the FSC operational modes corresponding to ambient light intensities that are at or above the threshold 4215 are implemented without illuminating the display with white light. In this example, the threshold 4215 is approximately 600 lux, but in other examples the threshold 4215 may be at a higher or lower ambient light intensity level.

At least some of the FSC operational modes corresponding to ambient light intensities that are below the threshold 4215 may involve illuminating the display with white light. In this example, the white light is provided by a white LED. Here, the front light also includes red, green and blue light sources, which are red, green and blue LEDs in this example.

In this implementation, the control system may be configured to vary the white light intensity level while maintaining a substantially constant brightness from the front light system when the ambient light intensity levels are below the threshold 4215. In the example shown in FIG. 42, the total front light intensity is 120 nits for FSC operational modes corresponding to ambient light intensities that are below the threshold 4215. This front light intensity level is merely an example. In other implementations, a higher or lower front light intensity level may be used. In this implementation, if the ambient light intensity is zero lux, the control system is configured to control the front light system such that the red, green and blue LEDs provide 100 nits and the white LED provides 20 nits.

The control system may decrease the white LED intensity and/or duration for higher ambient light intensity levels. In some implementations, the control system may decrease the white LED intensity in a substantially continuous manner as the ambient light intensity increases, whereas in other implementations the control system may decrease the white LED intensity in a stepwise manner as the ambient light intensity increases. In the example shown in FIG. 42, if the ambient light intensity is 300 lux, the control system is configured to control the front light system such that the red, green and blue LEDs provide 110 nits and the white LED provides 10 nits.

In some implementations the selection of a current operational mode for a display device may be based, at least in part, on criteria other than ambient light data. Examples of some such implementations will now be described with reference to FIG. 43.

FIG. 43 is a system block diagram illustrating additional components of a reflective display device. In this implementation, additional detailed examples are provided with respect to the control system 3205 of the reflective display device 3200. In this example, the control system 3205 includes a mode switching controller 4305. The mode switching controller 4305 may be configured to select an operational mode for the reflective display device 3200 and to provide input to the drive scheme/panel controller 4315 and the front light controller 4320.

In some implementations, the mode switching controller 4305 may be configured to select an operational mode according to one or more of the methods described above. For example, the mode switching controller 4305 may be configured to select an operational mode according to ambient light data from the ambient light sensor 4310. In some implementations, the mode switching controller 4305 may be configured to select an operational mode from among the operational modes provided by way of example in block 4315 of FIG. 43, according to ambient light data from the ambient light sensor 4310. Alternatively, or additionally, the mode switching controller 4305 may be configured to select an operational mode according to one or more of the implementations described above with reference to FIGS. 38-42. The mode switching controller 4305 may be configured to provide corresponding instructions to the drive scheme/panel controller 4315 and the front light controller 4320.

Some implementations may involve determining a desired color gamut and selecting the current operational mode based, at least in part, on the desired color gamut. For example, the color gamut of a display device being operated according to an FSC mode may extend outside of the sRGB color gamut. In such implementations, it may be desirable to shape the color gamut of the display device by increasing the white light illumination during FSC mode. In alternative implementations, it may be desirable to enlarge the color gamut of the display device by decreasing the white light illumination during FSC mode. In some implementations, the mode switching controller 4305 may be configured to select an operational mode according to display luminance and/or color gamut data corresponding to various display devices and/or operational modes. Such data (and/or other data) may be stored in memory 4340 and provided to the mode switching controller 4305 as needed.

In some implementations, the image data input module 4332 and/or the image processing module 4345 may be configured to analyze the color gamut of input images and to provide image color gamut input to the mode switching controller 4305. The mode switching controller 4305 may be configured to select an operational mode based, at least in part, on the image color gamut input. For example, if the image color gamut input indicates that the color gamut of an image is small, the mode switching controller 4305 may be configured to increase the intensity of white light used to illuminate the display during an FSC mode.

However, some implementations, may involve selecting an operational mode based on other criteria. For example, some implementations may include a battery state sensor. The control system may be configured to receive battery state data from the battery state sensor and to select the current operational mode (and/or the white light intensity level) based, at least in part, on the battery state data. In the implementation shown in FIG. 43, for example, the mode switching controller 4305 may be configured to select an operational mode based, at least in part, on input from the battery state sensor/power management indicator 4325. If the battery state sensor/power management indicator 4325 indicates that the battery is low (and/or that a conservative power management scheme is being implemented), lower-power options may be selected even if such options would not provide optimal image quality. For example, the mode switching controller 4305 may determine that an FSC operational mode would not be invoked even under low ambient light conditions.

The mode switching controller 4305 may be configured to select an operational mode based, at least in part, on input from other modules. For example, if the application type indicator 4330 provides input to the mode switching controller 4305 indicating that a text-based application will be executed on the reflective display device 3200, the mode switching controller 4305 may determine that the extra power and computational overhead of FSC operational modes are not warranted. Alternatively, if the application type indicator 4330 provides input to the mode switching controller 4305 indicating that a graphics-intensive application will be executed on the reflective display device 3200 (such as a photo album application, a video-based application, etc.), the mode switching controller 4305 may determine that an FSC operational mode would be appropriate for certain ambient light conditions and/or battery states.

The mode switching controller may change modes according to other energy-saving criteria. For example, the activity timer 4322 may provide input indicating when the current operational mode should be evaluated or when the reflective display device 3200 should enter a sleep mode, as described above.

Some implementations may involve determining an image content type and selecting the current operational mode based, at least in part, on the image content type. For example, if the image data input module 4332 or the image processing module 4345 provide input to the mode switching controller 4305 indicating that video data will be provided on the reflective display device 3200, the mode switching controller 4305 may determine that an FSC operational mode would be appropriate under certain ambient lighting (and/or other) conditions. For example, the mode switching controller 4305 may determine that a black and white FSC operational mode or a grayscale FSC operational mode would be appropriate under predetermined ambient light conditions and/or battery states. However, if the mode switching controller 4305 receives input indicating that text will be displayed on the display device, the mode switching controller 4305 may select a different operational mode, e.g., a less power-intensive operational mode.

In this implementation, the control system 3205 also includes a CBU detection module 4335. In some implementations, the CBU detection module 4335 may be configured to compute an objective measure of CBU, also referred to herein as a CBU score, and to provide the CBU score to the mode switching controller 4305. Based at least in part on the CBU score, the mode switching controller 4305 may be configured to provide corresponding instructions to the front light controller 4320 and/or the drive scheme/panel controller 4315.

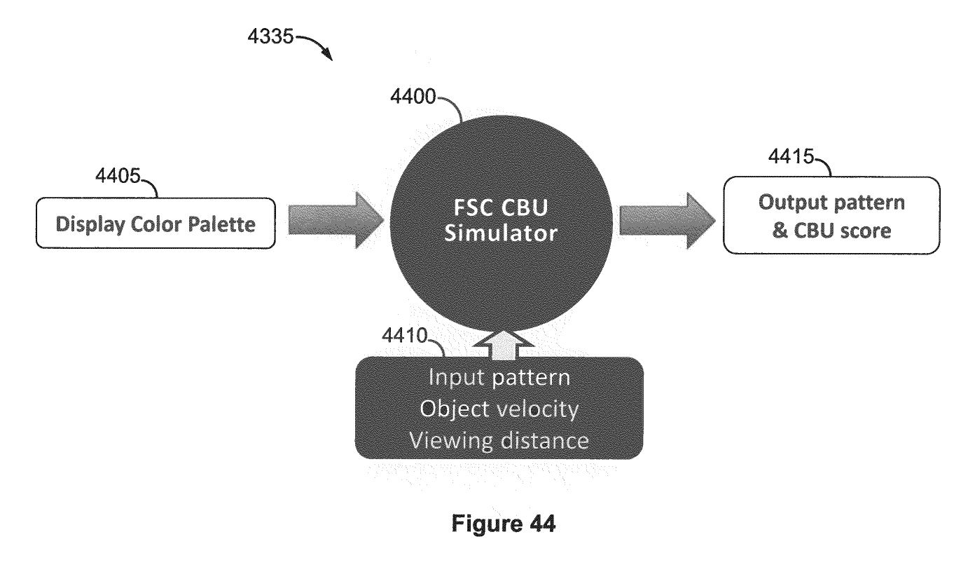

FIG. 44 is a system block diagram illustrating components of a color break-up detection module. In this example, the CBU detection module 4335 includes a CBU simulator 4400. The CBU simulator 4400 may be configured to calculate a CBU score. In some implementations, the CBU detection module 4335 may be used for system design and/or set-up. For example, the CBU detection module 4335 may be used for optimizing system parameters and specifications of a particular display device for visual performance under various conditions. Relevant CBU data may be provided to individual display devices and may be stored, e.g., in a memory such as the memory 4340 shown in FIG. 43. However, in alternative implementations, the CBU detection module 4335 may be used during normal operation of a display device. For example, the CBU detection module 4335 may be used to provide input to a mode-switching controller 4305, as described above.

The CBU score may be based on input display color palette data 4405 and input CBU criteria 4410. The CBU criteria 4410 may include one or more of input pattern data, image object velocity data, viewing distance data, etc. The CBU simulator 4400 also may be configured for outputting an output pattern 4415, which may indicate the degree of CBU of the input pattern.

In some implementations wherein the CBU detection module 4335 is used for system design and/or set-up, the CBU simulator 4400 may determine an objective measure of CBU by using a black-to-white step edge as image content for an input pattern, where eye saccades or eye tracking is assumed corresponding to whether the input pattern is stationary or moving. Due to field sequential color driving, the white input pattern may be decomposed, at least in part, by one or more of the causes of CBU. Accordingly, the white input pattern may be spatially displaced, at least in part, into its individual color components. The degree of spatial displacement of the color components may depend on various criteria, such as the relative motion between the eyes and the display or the tracked object, the speed of eye saccades, etc. The levels of the color components may depend on the display color palette. The CBU score may be a function of the difference between the input pattern and the displayed pattern containing color breakup. The CBU score may be directly related to the relative displacement and levels of the color components into which the white pattern decomposes. In some implementations, the CBU score may be based on a CIELAB metric or an S-CIELAB metric, which is a spatial adaptation of CIELAB known as perceptual color fidelity. Some implementations may involve some degree of smoothing and/or motion blurring of a reference image when computing a CBU score.

The CBU simulator 4400 may be configured to calculate an objective measure of CBU in various ways, e.g., as described in one or more of the following references: A. Yoshida, M. Kobayashi and Y. Yoshida, “Subjective and Objective Assessments of Color Breakup on Field Sequential Color Display Devices,” 2011 SID Digest, pp. 313-316, 2011; X. Zhang and J. E. Farrell, “Spatial Color Breakup Measured with Induced Saccades,” in Proc. SPIE 2003, vol. 5007, pp. 210-217; and K. Sekiya, T. Miyashita and T. Uchida, “A Simple and Practical Way to Cope with Color Breakup on Field Sequential Color LCDs,” 2006 SID Digest, pp. 1661-1664.

As noted in these references, saccadic eye movements, relative motion between the head and the display, and eye tracking of moving objects in a scene can cause color breakup perception. The strength of perceived color breakup in general depends on the amount of relative motion between the eyes/head and the displayed content, the extent and range of colors in the displayed content, the viewing distance, the display brightness and contrast, ambient lighting level, and the colors that the display is capable of generating (the display color palette). Peak retinal velocity, background luminance level, sub-frame frequency and target size may all have significant effects on perceived color break-up.

In some implementations, the CBU detection module 4335 may be configured to provide a CBU score to the mode switching controller 4305 (see FIG. 43). Based at least in part on the CBU score, the mode switching controller 4305 may be configured to determine how to control a reflective display according to an FSC operational mode. For example, if the CBU score is at or above a predetermined threshold, the mode switching controller 4305 may be configured to provide instructions to the front light controller 4320 and the drive scheme/panel controller 4315 indicating that a white light source and/or a yellow light source should be flashed during an FSC operational mode. According to some such implementations, the mode switching controller 4305 may be configured to provide instructions to the front light controller 4320 and the drive scheme/panel controller 4315 to function in an FSC operational mode wherein the color sequence is YBGR, YBRG, WRGB or RGBKKK, wherein W corresponds to a field during which a white light source is flashing and K corresponds to a field in which the front light is switched off. Alternatively, or additionally, if the CBU score is at or above a predetermined threshold, the mode switching controller 4305 may be configured to control the reflective display according to a non-FSC operational mode.

FIGS. 45A and 45B are system block diagrams illustrating a display device that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48, a sensor system 3210 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, such as a flat-panel display, such as plasma, EL, OLED, STN LCD, or TFT LCD, or a non-flat-panel display, such as a CRT or other tube device. In addition, the display 30 can include an IMOD-based display, such as a bi-stable IMOD or SM-IMOD display as described herein.

In this example, the display device 40 includes a front light system 3215. The front light system 3215 may provide light to the interferometric modulator display when there is insufficient ambient light. The front light system 3215 may include one or more light sources and light-turning features configured to direct light from the light source(s) to the interferometric modulator display. The front light system 3215 may also include a wave guide and/or reflective surfaces, e.g., to direct light from the light source(s) into the wave guide. In some implementations, the front light system 3215 may be configured to provide red, green, blue, yellow, cyan, magenta and/or other colors of light, e.g., as described herein. Alternatively, or additionally, in some implementations the front light system 3215 may be configured to provide substantially white light.

The components of the display device 40 are schematically illustrated in FIG. 45A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 45A, can be configured to function as a memory device and be configured to communicate with the processor 21. In some implementations, a power supply 50 can provide power to substantially all components in the particular display device 40 design.

In this example, the processor 21 is configured to control the front light system 3215. According to some implementations, the processor 21 may be configured to control the front light system 3215 in accordance with one or more of the operational modes, including but not limited to FSC operational modes, described herein. In some such implementations, the processor 21 may be configured to control the front light system 3215 according to data from the sensor system 3210. For example, the processor 21 may be configured to select one of the operational modes described herein and to control the front light system 3215 and the display array 30 based, at least in part, on the ambient light data from the sensor system 3210. Alternatively, or additionally, the processor 21 may be configured to select one of the operational modes described herein for controlling the front light system 3215 and the display array 30 based on user input or other types of input described above. The processor 21, the array driver 22, the driver controller 29 and/or other devices also may control the display array 30 in accordance with one or more of the operational modes described herein. Accordingly, the processor 21, the array driver 22 and/or the driver controller 29 may be elements of a control system such as the control system 3205 of FIG. 32.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a non-transitory computer-readable medium. The steps of a method or algorithm disclosed herein may be implemented in a processor-executable software module which may reside on a non-transitory computer-readable medium. Computer-readable media include both computer storage media and communication media including any medium that can be enabled to transfer a computer program from one place to another. A storage medium may be any available medium that may be accessed by a computer. By way of example, and not limitation, non-transitory computer-readable media may include RAM, ROM, EEPROM, CD-ROM or other optical disk storage, magnetic disk storage or other magnetic storage devices, or any other non-transitory medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a non-transitory machine readable medium and/or computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, although various implementations are described primarily in terms of reflective displays having red, blue and green subpixels, many implementations described herein could be used in reflective displays having other colors of subpixels, e.g., having violet, yellow-orange and yellow-green subpixels. Moreover, many implementations described herein could be used in reflective displays having more colors of subpixels, e.g., having subpixels corresponding to 4, 5 or more colors. Some such implementations may include subpixels corresponding to red, blue, green and yellow. Alternative implementations may include subpixels corresponding to red, blue, green, yellow and cyan. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A reflective display device, comprising:
a front light system configured for producing light of a first color, light of a second color, light of a third color and substantially white light;
a reflective display including a plurality of reflective pixels;
a sensor system that includes an ambient light sensor; and
a control system configured to:
receive ambient light data from the ambient light sensor;
determine, based at least in part on the ambient light data, a current operational mode from a plurality of operational modes, the plurality of operational modes including a field sequential color (FSC) mode in which the front light system illuminates the reflective display with white light while data are written to the plurality of reflective pixels;
select, based at least in part on the ambient light data, a white light intensity level; and
control the front light system and the reflective display according to the current operational mode and the white light intensity level.

2. The reflective display device of claim 1, wherein the control system is further configured to determine a ratio of white light intensity to overall display illumination intensity.

3. The reflective display device of claim 2, wherein the overall display illumination intensity includes front light illumination intensity and ambient light illumination intensity.

4. The reflective display device of claim 1, wherein the ambient light data include ambient light intensity data and wherein the control system is configured to select the FSC operational mode if the ambient light data indicates a first ambient light intensity level that is below a first threshold.

5. The reflective display device of claim 4, wherein the control system is configured to select a non-FSC operational mode if the ambient light data indicates a second ambient light intensity level that is at or above the first threshold.

6. The reflective display device of claim 5, wherein the control system is configured to select an operational mode of substantially continuous front light operation if the second ambient light intensity level is below a second threshold.

7. The reflective display device of claim 5, wherein the control system is configured to select an operational mode in which the front light is off if the second ambient light intensity level is at or above the second threshold.

8. The reflective display device of claim 1, wherein the control system is configured to determine an image content type and to select the current operational mode based, at least in part, on the image content type.

9. The reflective display device of claim 1, wherein the control system is configured to select the white light intensity level based at least in part on a desired color gamut.

10. The reflective display device of claim 1, wherein the control system is further configured to compute an objective measure of color breakup and to select the current operational mode based, at least in part, on the objective measure.

11. The reflective display device of claim 1, wherein the sensor system includes a battery state sensor, wherein the control system is configured to receive battery state data from the battery state sensor and to select the current operational mode or the white light intensity level based, at least in part, on the battery state data.

12. The reflective display device of claim 1, wherein the control system is configured to vary the white light intensity level while maintaining a substantially constant brightness from the front light system.

13. The reflective display device of claim 1, wherein the control system is configured to process image data.

14. The reflective display device of claim 13, wherein the control system further includes:
a driver circuit configured to send at least one signal to the reflective display; and
a controller configured to send at least a portion of the image data to the driver circuit.

15. The reflective display device of claim 13, wherein the control system further includes:
an image source module configured to send the image data to the processor, wherein the image source module includes at least one of a receiver, transceiver, and transmitter.

16. The reflective display device of claim 13, further comprising:
an input device configured to receive input data and to communicate the input data to the control system.

17. A display device, comprising:
lighting means for producing light of a first color, light of a second color, light of a third color and substantially white light;
display means including a plurality of pixels;
ambient light sensor means; and
control means for:
receiving ambient light data from the ambient light sensor means;
determining, based at least in part on the ambient light data, a current operational mode from a plurality of operational modes, the plurality of operational modes including a field sequential color (FSC) mode in which the lighting means illuminates the display means with white light while data are written to the plurality of pixels;
selecting, based at least in part on the ambient light data, a white light intensity level; and
controlling the lighting means and the display means according to the current operational mode and the white light intensity level.

18. The display device of claim 17, wherein the control means includes means for determining a ratio of white light intensity to overall display illumination intensity.

19. The display device of claim 17, wherein the ambient light data include ambient light intensity data and wherein the control means includes means for selecting the FSC operational mode if the ambient light data indicates a first ambient light intensity level that is below a first threshold.

20. The display device of claim 19, wherein the control means includes means for selecting a non-FSC operational mode if the ambient light data indicates a second ambient light intensity level that is at or above the first threshold.

21. The display device of claim 17, wherein the control means includes means for varying the white light intensity level while maintaining a substantially constant brightness from the lighting means.

22. A method, comprising:
receiving ambient light data from an ambient light sensor;
determining, based at least in part on the ambient light data, a current operational mode for a display from a plurality of operational modes, the plurality of operational modes including a field sequential color (FSC) mode in which a lighting system illuminates the display with white light while data are written to the display;
selecting, based at least in part on the ambient light data, a white light intensity level; and
controlling the lighting system and the display according to the current operational mode and the white light intensity level.

23. The method of claim 22, further comprising:
selecting the FSC operational mode if the ambient light data indicates a first ambient light intensity level that is below a first threshold.

24. The method of claim 23, further comprising:
selecting a non-FSC operational mode if the ambient light data indicates a second ambient light intensity level that is at or above the first threshold.

25. The method of claim 22, further comprising:
determining an image content type; and
selecting the current operational mode based, at least in part, on the image content type.

26. The method of claim 22, further comprising:
selecting the white light intensity level based at least in part on a desired color gamut.

27. The method of claim 22, further comprising:
computing an objective measure of color breakup; and
selecting the current operational mode based, at least in part, on the objective measure.

28. The method of claim 22, further comprising:
varying the white light intensity level while maintaining a substantially constant brightness from the lighting system.

29. A non-transitory medium having software stored thereon, the software including instructions for controlling an apparatus to:
receive ambient light data from an ambient light sensor;
determine, based at least in part on the ambient light data, a current operational mode for a display from a plurality of operational modes, the plurality of operational modes including a field sequential color (FSC) mode in which a lighting system illuminates the display with white light while data are written to the display;
select, based at least in part on the ambient light data, a white light intensity level; and
control the lighting system and the display according to the current operational mode and the white light intensity level.

30. The non-transitory medium of claim 29, wherein the software further includes instructions for controlling the apparatus to:
select the FSC operational mode if the ambient light data indicates a first ambient light intensity level that is below a first threshold.

31. The method of claim 30, wherein the software further includes instructions for controlling the apparatus to:
select a non-FSC operational mode if the ambient light data indicates a second ambient light intensity level that is at or above the first threshold.

32. The non-transitory medium of claim 29, wherein the software further includes instructions for controlling the apparatus to:
determine an image content type; and
select the current operational mode based, at least in part, on the image content type.

33. The non-transitory medium of claim 29, wherein the software further includes instructions for controlling the apparatus to:
select the white light intensity level based at least in part on a desired color gamut.

34. The non-transitory medium of claim 29, wherein the software further includes instructions for controlling the apparatus to:
compute an objective measure of color breakup; and
select the current operational mode based, at least in part, on the objective measure.

35. The non-transitory medium of claim 29, wherein the software further includes instructions for controlling the apparatus to:
vary the white light intensity level while maintaining a substantially constant brightness from the lighting system.
